(19) United States
(12) Patent Application Publication
(10) Pub. No.: US 2010/0114739 A1
(43) Pub. Date: May 6, 2010

(54) SYSTEMS AND METHODS FOR A COMPREHENSIVE INTEGRATED AND UNIVERSAL CONTENT SELLING AND BUYING PLATFORM

(76) Inventor: David JOHNSTON, Glenageary (IE)

Correspondence Address: CHOATE, HALL & STEWART LLP, TWO INTERNATIONAL PLACE, BOSTON, MA, 02110, US

(21) Appl. No.: 12/552,888

(22) Filed: Sep. 2, 2009

Related U.S. Application Data
(60) Provisional application No. 61/093,917, filed on Sep. 3, 2008.

(51) Int. Cl. G06Q 30/00

(52) U.S. Cl. 705/27

(57) ABSTRACT

A method of self-service by a seller to establish at a hosted service a store front that is distributable across a plurality of third party hosts includes receiving, by a hosted service operating on one or more servers, specification of one or more items to be displayed for sale in a store front for a seller. Responsive to the specification, the hosted service generates a portable widget for the store front identifying the one or more items for sale. The hosted service may receive from the seller identification of one or more third party hosts to which to publish the portable widget of the store front. The hosted service may initiate publishing of the portable widget of the store front to the one or more third party hosts.

### RELATED APPLICATIONS

The present application claims priority to U.S. Provisional Patent Application Ser. No. 61/093,917, filed on Sep. 3, 2008, entitled “SYSTEMS AND METHODS FOR A COMPREHENSIVE INTEGRATED AND UNIVERSAL CONTENT SELLING AND BUYING PLATFORM”, which is incorporated herein in its entirety by reference.

### FIELD OF THE DISCLOSURE

The present application is generally directed to systems and methods for providing a platform for the delivery, management and payment of content between sellers and buyers. In particular, the present application relates to systems and methods of self-service by a seller to establish a store front at one or more hosted services.

### BACKGROUND

With the growth of Web 2.0 media sharing sites such as Flickr and YouTube there has been an explosive growth in digital content creation by individuals. The latter is sometimes referred to as user generated content. The popularity and accessibility of powerful computers now means it is possible for individuals to create compelling and creative content at low cost.

If an artist wants to generate income from their creative content they would have to 1) create a website that has full ecommerce facilities and 2) promote their site by advertising and posting teasers or previews on media sharing sites such as YouTube or Flickr with the hope of encouraging visitors to their website to purchase content. This is a significant investment and would deter most content creators.

Artists are severely restricted in the amount of money they can sell their content for because the current payment systems are not designed for micropayments. A micropayment is a payment that is too small to be affordably processed by credit card or other electronic processing mechanisms. Sellers of products and/or services may also face some of the same challenges discussed herein. The products and/or services may be related to or independent of creative content that a content creator is selling. Products may be physical products or be in some intangible form. Content, products and services are hereafter sometimes generally referred to as “content”.

In order to maximize sales artists may need to know the following. What type of content is selling well? How good is their content compared to other similar content creators? What content do people like? Which geographic regions prefer certain content? How do the people who purchase a specific content rate it? Which content format is most popular? What devices (iPhone, desktop PC, mobiles (Symbian/Java MIDP2) do people play content on or operate the content with? This information may need to be timely in order for them to react to changes in their audience. This information is not readily available to artists today.

Currently, artists may not receive accurate feedback from their customers in the form of comments and rating for their content unless they are distributing the content themselves from their own website and have built in that additional functionality.

If an artist wants to generate an income from their creative content they can locate a content aggregator who can market their content to mobile operators and large media organizations. The income they may receive is significantly less than what the end consumers will pay for that content.

If an artist wants to generate an income from localized or hard-to-find content there is no real method available to them. It is generally accepted that “the biggest money is in the smallest sales” ¹. There is few, if any, viable routes to market for content providers with unique, localized content, non-mainstream type content. Also known as “The Long Tail” ² type content. These content creators may not have a platform that can monetize their unique, localized content. ¹Quote from music industry consultant and venture capitalist, Kevin Law ²Anderson, Chris (2006). The Long Tail: Why the Future of Business is Selling Less of More. Hyperion. ISBN 1-4013-0237-8.

If an individual artist wants to promote their content they may have a limited number of avenues available to them. All of these avenues can be expensive. They can advertise using services such as Google and pay for search engine optimization services, blogging, etc.

Investors in Web 2.0 entities such as Flickr, YouTube, Facebook, MySpace, Bebo etc are all interested in determining how to make returns from their investments. Currently, the easiest path is to provide advertising revenue share to the artists. This is usually a very small percentage of advertising revenue.

User Generated Content (UGC) is become more and more popular as mainstream entertainment. There are many people who will spend evenings watching YouTube videos. However, with the nature of UGC there is a large amount of unsuitable, inappropriate and undesirable content. Many hours can be wasted in trolling through undesirable content on sites such as Flickr, YouTube and social networking sites.

Artists are also concerned about people making copies of their content and distributing it without the artist benefitting. A number of content protection schemes exist such as OMA DRM, MagicGate, Windows Media DRM and FairPlay. These schemes are not available on every mobile phone/iPhone or desktop PC. If an artist wants to use a protection scheme they may have to 1) decide which schemes to support and 2) protect their content for each scheme.

Many content consumers own devices such as Apple iPhone/iTouch/iPod, desktop computers and mobile devices such as Symbian, Brew and Java MIDP2. With the arrival of online storage and high speed wireless/radio networks content consumers expect to have instant access to content they have purchased on any device at any time. They may not want to be concerned about what version is available on which device or worse still may have to transcode (convert from one format to another) the content themselves.

Many musicians have launched themselves on social networking sites such as MySpace or YouTube. However, there is no facility on these sites to be able to sell their music.

In order for an artist to benefit from the effect of “The Long Tail” they may need an extensive catalogue of content. For example some photographers have terabytes of images that they would be happy to sell. However, this requires large amounts of online storage which is expensive.

Artists with content that they produce on a regular basis have a number of technical challenges and commercial challenges in order to make money from their content. Take for an example an artist who produces a weekly video of interviews with principles of investment firms. The artist may need to be familiar with Podcasting RSS formats, able to convert video to .mp4, .mpv or .mov formats and host the content on a website. To monetize the vodcast the artist may have to create a website and 1) obtain a commercial sponsor or 2) request donations on the website or 3) place advertisements on the website. However, it is most likely that a successful podcast/vodcast may be added to iTunes. Therefore any possibility of monetizing from an artist's own website may be eliminated.

### SUMMARY

The present application is directed towards systems and methods for providing a comprehensive platform for a fully integrated package providing one or more of the following functionalities: content distribution, sales monitoring, micro-payments, Content Rating, Digital Rights Management, Royalty payments, Digital Storage, provision of “Top Picks”, Hosting & Billing services, no requirement of Merchant Accounts for Sellers, and Content Rating for Buyers to ensure Quality. The combined use of a dashboard, storefront (for selling) and website (for search, upload, digital rights management and rating) of the present solution provides a comprehensive, easy to use and commercially viable platform for monetizing content, including unique, localized content.

The following is a brief summary of some of the features of this comprehensive platform:

Artists can sell all types of media and digital content, such as music, video, images, podcasts, vodcasts and documents—Visiting the website of the present solution, such as via http://www.owjo.com, an artist can create a storefront and populate it with digital content, such as music, video and images, specify the cost they wish to sell the content for and publish it to a website or to their social networking profile. An artist can also create subscriptions such as podcasts and vodcasts by indicating how often an episode will be added and the cost for the subscription over a specific period (e.g., 1 week—7 days, 1 month—30 days, 3 months—90 days, 6 months—180 days and 1 year—365 days).

Sell on any website (e.g., social networking site)—The Storefront is a widget or component, such as a Macromedia Flash component, that can be embedded on any website or on the artist's own social networking profile. Visitors to the artist's profile can preview content and purchase or subscribe using various forms of payment, such as PayPal or credit card.

Support subscriptions—podcasts and vodcasts—Artists can easily create a podcast or vodcast, using tools and/or applications described herein, and for example, available via http://www.owjo.com. Artists can indicate the cost of purchasing a subscription.

Digital Rights Management—When content or a subscription is purchased, the platform of the present solution can create digital rights and assign those rights to the buyer. The platform may track and maintain a record of the buyer's digital rights.

Artists retain exclusive rights—The artist can retain all rights to their creative content and the platform of the present solution can own the data the platform collects. The platform of the present solution may not require any exclusivity of distribution.

Generous Royalty payments (e.g. >80%)—In some cases, artists may receive up to 80% of the amount of money the buyer pays for the content in the form of a royalty payment.

Content rating by buyers—In some cases, the platform restricts buyers as the only ones who can rate content. The platform may maintain an average rating and/or all the feedback comments for the seller (artist).

User Generated Content Search—The platform of the present solution may provide search functionality. Content of the platform can be tagged with keywords. Using the search functionality, the platform may be used to find good/high quality (rated) UGC content.

Promote artists content using RSS/Atom feeds—The platform may provide access in the form of Atom/RSS feeds that can be syndicated to content aggregators and mobile operators. Rated UGC content can be of interest to many different groups.

Available to artists worldwide—No restrictions may be imposed on the type and form of sellers/artists and their geographical locations to access and use the platform.

Real-time Sales Tracking using a Google Gadget—Artists can use the Dashboard to track their global sales. They can track their sales locally via a client device and do not have to be on the website of the platform.

Support for iTunes—Buyers can drag RSS (iTunes version) links from the Dashboard directly into their iTunes or MP3 players. The content can then be played on their MP3 devices (e.g., iPod, iPhone or iTouch devices). The MP3 player or iTunes can then query the platform for updated episodes.

Comprehensive Billing System—In order to purchase content or subscriptions a buyer can use credits supported by the platform. These credits can be purchased using PayPal, mobile phone credit/payment services, or credit cards in predetermined currency amounts, e.g., bundles of £5, £10, etc.

No merchant accounts or hosting required—Artists do not need to manage domains, pay for hosting accounts or have merchant accounts for credit card processing.

Universal content and device support—The platform may support any type and form of media and content, such as videos, music, documents, presentations, podcasts, and vodcasts. Furthermore, the platform can support the myriad of different network connected media devices owned by content consumers and creators (buyers and sellers) such as mobile phones based on Symbian, Brew and Java MIDP2 systems, and Apple iPhone/iTouch; content consumers may expect to be able to play their purchased content on all their connected media devices. The solution of the present application allows artists to provide content in an appropriate format for each media device or rely on the platform to transcode to the various formats of consumer devices.

Simple, Direct Channel Model For Sellers and Buyers—Using the platform of the present solution, a content seller can create a Storefront via a user interface of the platform, populate the Storefront with digital content (music, video and images), specify the price the seller wishes to sell the content for and publish the content to a website or to the seller's social networking profile. The seller can also create subscriptions such as podcasts and vodcasts by indicating how often an episode will be added and the cost for the subscription over a specific period (e.g., 1 week—7 days, 1 month—30 days, 3 months—90 days, 6 months—180 days and 1 year—365 days). The steps for creating a Storefront, populating it and publishing via the platform may be easier for less technically-inclined content owners. The seller can be selling their content on Facebook, Bebo, and MySpace in a short time via self-service Storefront setup using the OWJO platform. The platform provides a direct channel for sellers to potential content consumers.

Sellers are free to set the price point of the content they are selling. The platform may provide sales analysis using the Dashboard to help the sellers determine the optimum price point.

The platform can provide a very simple, intuitive user interface to help potential content consumers become buyers. Using the Storefront, a potential content consumer can preview content, view rating information and purchase content in a familiar way.

The platform provides a micro-payment system, which enables artists to sell their content for amounts appropriate for their market. This means that at the appropriate price, consumers are more likely to purchase content and artists are more likely to sell content.

Copyrighted content protection—The platform supports any type and form of digital rights, copyright or content protection schemes such as OMA DRM, MagicGate, Windows Media DRM and FairPlay. The platform supports future protection schemes by using a pluggable architecture to enable a new protection scheme to be easily added. An artist can choose to protect their content. The platform can determine what protection scheme to use by querying the supplied user agent. Sellers can provide copyright notices that can be displayed on a Storefront.

Sales and Marketing Support—A Dashboard can provide access to the user's account. The Dashboard lists the content or subscriptions that consumers have purchased and the royalties generated from the sales of the content or subscriptions. The Dashboard can also provide real-time sales analysis and advice on the strength of sales for each content/subscription in each market segment.

Integration with Social Networking Sites—Using the website of the platform, an artist can upload content and define subscriptions that the artist wishes to sell. The Storefront can then be placed on social networking sites such as Facebook, MySpace, Bebo and can also be placed on the artist's website if the artist so wishes.

The Storefront may comprise any one or more widgets, which may be portable across any one or more web-sites, services or servers. A widget may comprise any one or more elements of a user interface that displays an information arrangement, which may be changeable by the user. A storefront widget may comprise an arrangement of elements for a user interface for the display, selling and buying of any content, products and/or services as may be described herein. The widget may comprise any type and form of executable instructions that may be executable in one or more environments. The widget may be designed and constructed to execute or operate within a web-page displayed by a browser.

A portable widget may comprise any widget that is designed and constructed to be publishable, hosted or provided to one or more web-sites, services or hosts. In some embodiments, a portable widget may be designed and constructed with variants to support or be compatible with any one or more of these web-sites, services or hosts. In some embodiments, the portable widget is designed and constructed to be displayed, executed and/or hosted by another web-site, service or host. The portable widget may be designed and constructed to be easily or conveniently transported or communicated to another host, service or web-site, such as between the OWJO platform and a third party web-site. The portable widget may be designed and constructed to be transported or communicated from the environment of the OWJO platform to the environment of another host, service or web-site.

In one aspect, the present application is related to a method of self-service by a seller to establish at a hosted service a store front that is distributable across a plurality of third party hosts. The method includes receiving, by a hosted service operating on one or more servers, specification of one or more items to be displayed for sale in a store front for a seller. Responsive to the specification, the hosted service generates a portable widget for the store front identifying the one or more items for sale. The hosted service may receive from the seller identification of one or more third party hosts to which to publish the portable widget of the store front. The hosted service may initiate publishing of the portable widget of the store front to the one or more third party hosts.

In one embodiment, the hosted service receives from the portable widget of the store front published on a third party host information from a buyer to complete a purchase of one or more items selected from the storefront. The portable widget, in communication with the hosted service, may complete the purchase of the selected one or more items without the buyer traversing away from the store front displayed on the third party host. The hosted service can determine a share of revenue from sales of the one or more items from the storefront between the hosted service, the seller and the one or more third party hosts.

The hosted service may receive the specification by the seller of digital content for the one or more items to be displayed for sale in the storefront. The hosted service may receive the specification by the seller of physical items for the one or more items to be displayed for sale in the storefront. The hosted service may also receive the specification by the seller of one of different prices or different currencies for the one or more items. The hosted service may automatically generate and/or automatically update the store front responsive to a feed from a third party system. The hosted service may also communicate the portable widget of the store front to a third party host of the one or more third party hosts. Further, the hosted service may notify the seller and a buyer of a status of fulfillment of physical items purchased by the buyer from the store front.

In another aspect, the present application is related to a system of providing self-service to a seller to establish at a hosted service a store front that is distributable across a plurality of third party hosts. The system includes a user interface of a hosted service operating on one or more servers receiving specification one or more items to be displayed for sale in a store front for a seller. A portable widget for the store front may be generated by the hosted service responsive to the specification. The portable widget for the store front identifies the one or more items for sale. A publishing user interface of the hosted service may receive from the seller identification of one or more third party hosts to which to publish the portable widget of the store front. The hosted service can initiate publishing of the portable widget of the store front to the one or more third party hosts.

In one embodiment, the hosted service receives from the portable widget of the store front published on a third party host information from a buyer to complete a purchase of one or more items selected from the storefront. The hosted service, in communication with the portable widget, may complete the purchase of the selected one or more items without the buyer traversing away from the store front displayed on the third party host. The hosted service can determine a share of revenue from sales of the one or more items from the storefront between the hosted service, the seller and the one or more third party hosts. The hosted service may receive the specification by the seller of digital content for the one or more items to be displayed for sale in the storefront. The hosted service may also receive the specification by the seller of physical items for the one or more items to be displayed for sale in the storefront. Further, the hosted service may receive specification by the seller of one of different prices or different currencies for the one or more items.

In some embodiments, the hosted service automatically generates and/or automatically updates the store front responsive to a feed from a third party system. The hosted service may communicate the portable widget of the store front to a third party host of the one or more third party hosts. The hosted service may also notify the seller and a buyer of a status of fulfillment of physical items purchased by the buyer from the store front.

### BRIEF DESCRIPTION OF DRAWINGS

The foregoing and other objects, aspects, features, and advantages of the present invention will become more apparent and better understood by referring to the following description taken in conjunction with the accompanying drawings, in which:

FIG. 1A is a block diagram that depicts an embodiment of a platform for providing the systems and methods described herein;

FIG. 1B is a block diagram that depicts an embodiment of the business model provided by the platform in accordance with the systems and methods described herein;

FIG. 1C is a block diagram that depicts an embodiment of server-side components of the platform;

FIG. 1D is a block diagram that depicts an embodiment of additional server-side components of the platform;

FIG. 2A is a block diagram providing a depiction of an embodiment of universal content consumption and digital rights management;

FIG. 2B is a flow diagram of an embodiment of a method for universal content consumption and digital rights management;

FIG. 2C is a block diagram providing a depiction of an embodiment of universal content distribution and digital rights management;

FIG. 2D is a flow diagram of an embodiment of a method of universal content distribution and digital rights management;

FIG. 3A is an embodiment of an user interface for creating a Storefront by a seller;

FIG. 3B is an embodiment of an user interface for adding a music track to the Storefront by a seller;

FIG. 3C is an embodiment of an user interface for adding a video to the Storefront by a seller;

FIG. 3D is an embodiment of an user interface for adding an image to the Storefront by a seller;

FIG. 3E is an embodiment of an user interface for adding a podcast to the Storefront by a seller;

FIG. 3F is an embodiment of an user interface for adding a vodcast to the Storefront by a seller;

FIG. 3G is an embodiment of an user interface for publishing the Storefront by a seller;

FIG. 3H is a flow diagram of an embodiment of a method of using the Storefront by a seller;

FIG. 4A is an embodiment of the user interface of a Storefront running in Facebook;

FIG. 4B is an embodiment of the user interface of a Storefront to preview content;

FIG. 4C is an embodiment of the user interface of a Storefront to add content to a shopping cart;

FIG. 4D is an embodiment of the user interface of a web site to purchase content;

FIG. 4E is an embodiment of the user interface of a web site to purchase content using PayPal and Mobile payment methods;

FIG. 4F is a flow diagram of an embodiment of a method of using the Storefront by a buyer;

FIG. 5A is a block diagram of an embodiment of a Dashboard executing on iPhone;

FIG. 5B is a block diagram of an embodiment of a Dashboard executing on iGoogle;

FIG. 6A is a block diagram of an embodiment of a web site to view sales of music tracks by a seller;

FIG. 6B is a block diagram of an embodiment of a web site to edit a music track by a seller;

FIG. 6C is a block diagram of an embodiment of a web site to view sales of videos by a seller;

FIG. 6D is a block diagram of an embodiment of a web site to view sales of images by a seller;

FIG. 6E is a block diagram of an embodiment of a web site to view sales of podcasts by a seller;

FIG. 6F is a block diagram of an embodiment of a web site to upload a new episode of a podcast by a seller;

FIG. 6G is a block diagram of an embodiment of a web site to view sales of vodcasts by a seller;

FIG. 6H is a block diagram of an embodiment of a web site to view royalty receipts by a seller;

FIG. 6I is a block diagram of an embodiment of a web site to update payout details for a seller;

FIG. 7A is a block diagram of an embodiment of a web site to view purchases of music tracks by a buyer;

FIG. 7B is a block diagram of an embodiment of a web site to add a review of a music track by a buyer;

FIG. 7C is a block diagram of an embodiment of a web site to add credits to a buyer's account;

FIG. 7D is a block diagram of an embodiment of a web site to modify a buyer's account.

FIG. 8A is a block diagram that depicts an embodiment of integration with feed aggregators;

FIG. 8B is a block diagram that depicts an embodiment of integration with Facebook and MySpace web sites;

FIG. 8C is a block diagram that depicts an embodiment of integration with platform content searching;

FIG. 8D is a block diagram that depicts an embodiment of an example embodiment of a tag cloud; and

FIG. 8E is a block diagram of an embodiment of a web site showing search results from a content search.

FIG. 9A is an embodiment of an user interface for previewing physical and digital items to purchase while a user navigates within a Storefront.

FIG. 9B is an embodiment of an user interface for reviewing items accumulated in a user's shopping cart.

FIG. 9C is an embodiment of an user interface for purchasing items using either a credit card or OWJO Credits while staying within a Storefront on the hosted site.

FIG. 10A is an embodiment of the user interface for showing the existence of a cookie identifying the customer's account;

FIG. 11A is a block diagram that depicts an embodiment of a chart of accounts of OWJO billing module 158;

FIG. 11B is a flow diagram of an embodiment of a method for content purchasing depicting how the chart of accounts are affected; and

FIG. 12A is a block diagram that depicts an embodiment of the OWJO platform 110 including features for physical fulfillment.

In the drawings, like reference numbers generally indicate identical, functionally similar, and/or structurally similar elements.

### DETAILED DESCRIPTION

For purposes of reading the description of the various embodiments of the present invention below, the following descriptions of the sections of the specification and their respective contents may be helpful:
Section A—Describes an end-to-end platform and business model for content management and distribution between content sellers and buyers;
Section B—Describes the universal content consumption, distribution and digital rights management features of an embodiment of the platform;
Section C—Describes embodiments of the user interface for using the Storefront by a seller;
Section D—Describes embodiments of the user interface for using the Storefront by a buyer;
Section E—Describes embodiments of the user interface for using the Dashboard by both buyers and sellers;
Section F—Describes embodiments of the user interface for using the web site by a seller;
Section G—Describes embodiments of the user interface for using the web site by a buyer;
Section H—Describes embodiments of sales and marketing integration with other web-sites;
Section I—Describes embodiments of the user interface for previewing digital and physical items and purchasing the items while staying within the Storefront.
Section J—Describes the persistent shopping cart and OWJO account across artist Storefronts;
Section K—Describes revenue sharing with portals, social networking services and other web distributors; and
Section L—Describes the features available to sellers to facilitate physical fulfillment.

### Section A—End-to-End Platform and Business Model for Content Management and Distribution Between Content Sellers and Buyers.

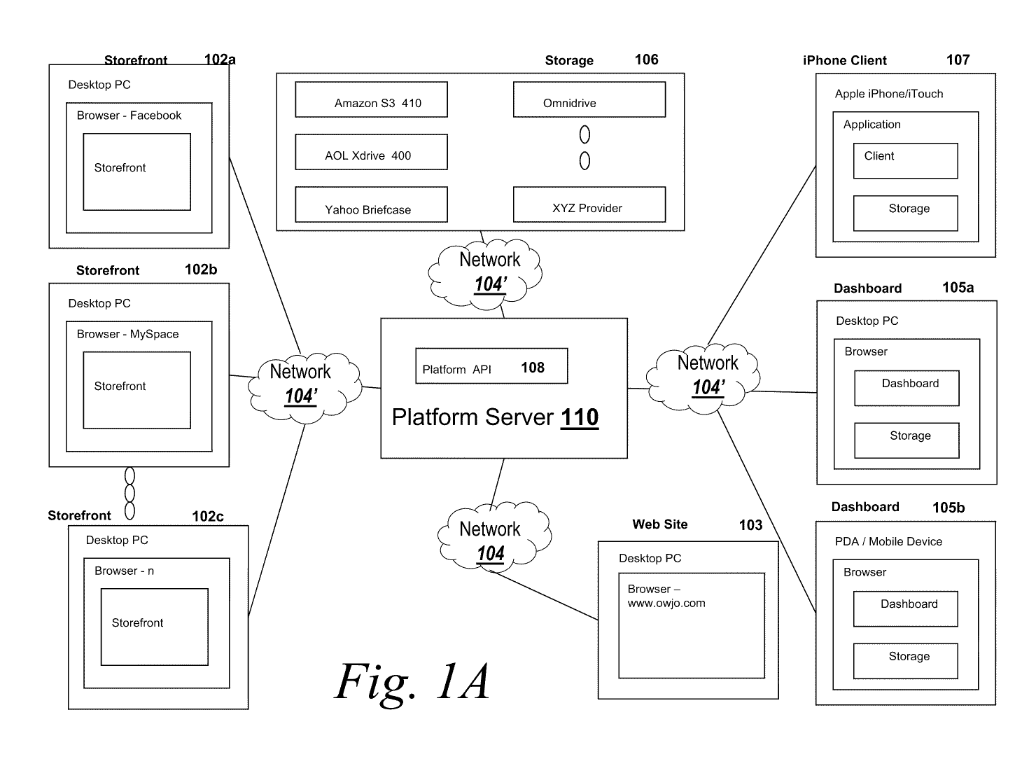

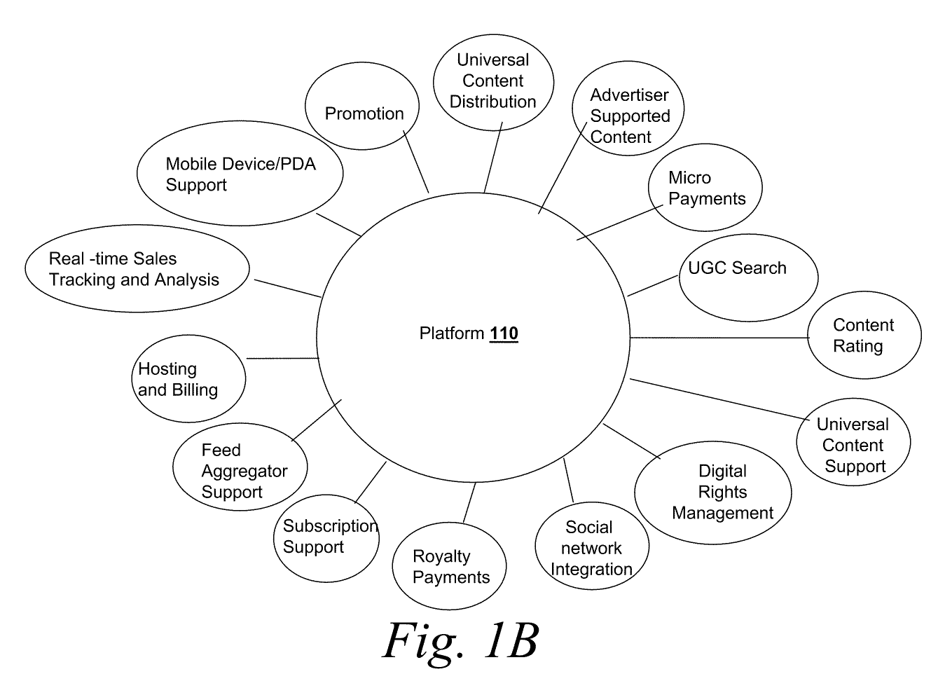

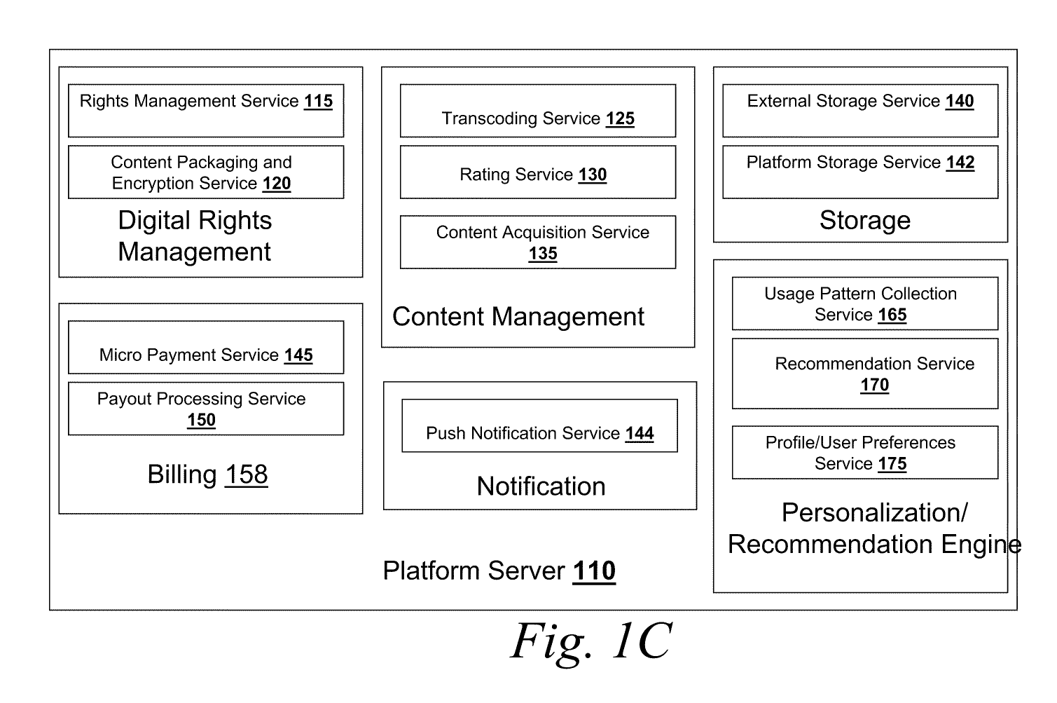

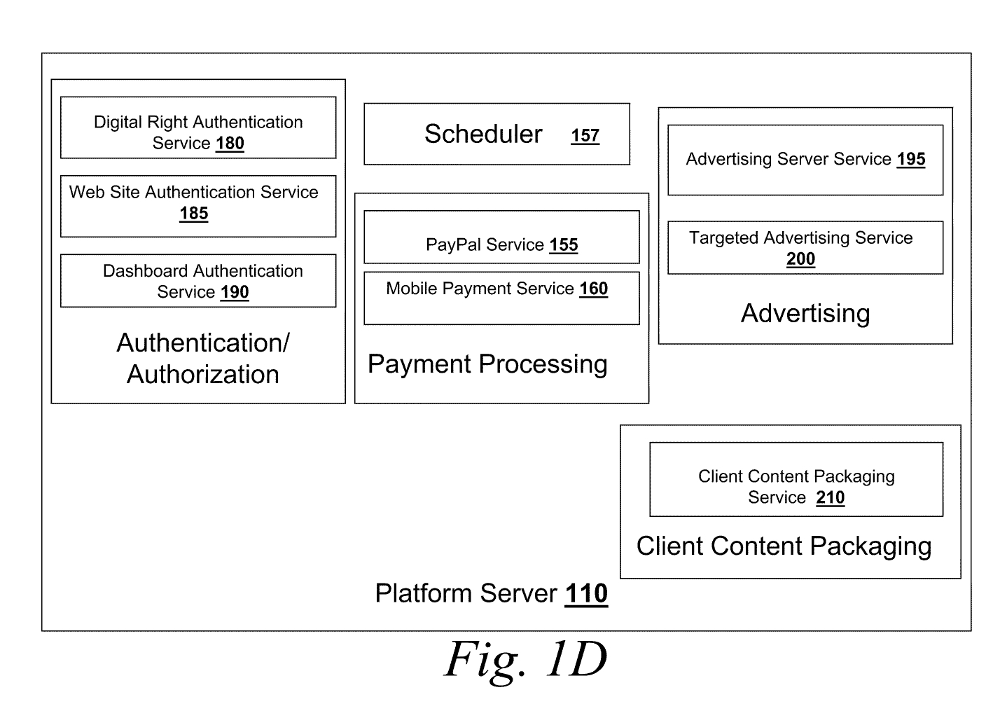

Referring now to FIG. 1A, an environment of a platform providing systems and methods for monetizing content, products and services, and for handling buyer-side and sell-side functionality is depicted. Content may include any type or form of digital content or content recordable on media, such as music, digital books, application tools or software, and video clips. Products may include any physical item, including media incorporating content. Services may include any type or form of subscription or pay-per-use services, such as news updates, music reviews or price-comparison or product monitoring services. Any combination of content, products and services may be provided via a Storefront. The combinations of content, products and services may related to, or independent of, each other. For example and in one embodiment, products bearing the likeness of an artist may be sol alongside the artist's music in a Storefront. In brief overview, the platform 110 includes a server 110, and may include or communicate with one or more of: Storage Services 106, Dashboard 105, Storefront 102, clients or client agents 107, web-site 103 and API 108. Each of these subsystems may be connected to and communicate over one or more networks 104, such as over the Internet.

The Server 110, sometimes also referred to as the platform server 110 (or an OWJO server in one embodiment) may comprise a single server, a server farm or a cluster of one or more application servers or nodes. Any of the applications, programs, libraries, services, processes or tasks executing on the server 110 and providing any of the functionality, logic or operations described herein may be designed, developed and/or implemented using any type and form of programming language, scripts, software development tools, compilers, etc. In one embodiment, any portion of the platform server 110 may be developed and implemented using a Java Platform, such as Enterprise Edition (J2EE). In some embodiments, the server, server farm or cluster 100 is architected and designed to be extensible and scalable in order to support very large numbers of users.

The Storefront 102, sometimes referred to as the OWJO Storefront in some embodiments, is an embeddable chunk of code, such as an application, program, script, control or component, providing seller side functionality and/or for interfacing to one or more buyers. In some embodiments, the Storefront can be installed and executed within any separate HTML or web page without requiring additional compilation. The Storefront may be any web-based component or widget. In some embodiments, the Storefront may also be a virtual or graphical representation of web-based components or widgets transmitted to any web document for presentation. In one embodiment, the Storefront is developed using Adobe Flash. The Storefront may communicate via any type and form of protocol, such as HTTP/HTTPS, with the Server 110, such as to obtain previews of the content and subscriptions that an artist is selling. Storefront 102a is an example of the OWJO Storefront running within the Facebook profile of a contributing artist. Storefront 102b is an example of the OWJO Storefront running within the MySpace profile of a contributing artist. Storefront 102c represents the OWJO Storefront running within any website or social networking profile of a contributing artist. Amazon, Ebay, Google Product Search, Bizrate, Dealnews, Lulu, Twitter, Linkedln and web-blogs are further examples of websites that can support a Storefront. A storefront may also be embedded in an advertisement banner or widget presented in a website.

By way of illustration and in one embodiment, a visitor to an artist's social networking profile can use the OWJO Storefront to preview the artist's content and purchase any selected content by adding the selected content to a shopping cart. The visitor may purchase the content from the shopping cart by completing purchases using any type and form of payment, such as PayPal, credit cards, gift cards and pre-purchased credits. A visitor to the artist's social networking profile can use the OWJO Storefront to search for related or similar content. The OWJO Storefront provides a convenient way for visitors to create their own OWJO shopping account by clicking on a link within the OWJO Storefront.

The Storage 106, sometimes also referred to as the OWJO Storage in some embodiments, is a set of one or more storage services or locations to store and retrieve content by the platform 110. In one embodiment, the Storage is a highly scalable, reliable, secure and fast storage that is used by one or more of the OWJO Server, OWJO Dashboard and OWJO Storefront to store and retrieve content for buyers and sellers. In some embodiments, the storage 106 includes any type and form of storage drives, mediums and units. An artist or seller may provide and/or maintain his/her own storage 106. In other embodiments, the storage 106 provides an interface to and communicates with any one or more external or third party storage services, providers or locations. For example, in some embodiments, the Storage is architected to use any type and form of Internet based or accessible storage solutions available on the market today. In some embodiments, OWJO Storage interfaces to, communicates with or otherwise uses any of the following storage services or solutions: Amazon S3, AOL Xdrive, Microsoft SkyDrive, Google Documents, Yahoo Briefcase and Omnidrive. The OWJO Storage can access any storage service using a pluggable architecture and exposes this functionality via the OWJO Storage and the OWJO Storage API.

API 108 also referred to as the OWJO API in some cases, comprises application programming interfaces or services for accessing any functionality and data provided via the platform 110. In some embodiments, the API 108 is a RESTful data APIs that a software developer can use to access functionality of the platform 110. REST is an acronym standing for Representational State Transfer. External systems, programs, web-sites or other software products can interface to, communicate with and access and leverage the functionality and services provided by the platform. For example, software developers can leverage the functionality of the OWJO Platform from within their own software products. The OWJO API may include any set of APIs or services to access any of the functionality described herein, and by way of example, may include:
1. User Service API to create/edit users
2. Dashboard Service API to create Dashboards
3. Storefront Service API to create Storefronts
4. Storage Service API to store and retrieve content from Storage for a specific user
5. Pricing Service API to set the price of content and subscriptions for an user
6. Content Rating Service API to rate content and provide feedback.
7. Search Engine API to search for content, products and services.
8. Sales Account API to track and maintain sales records.

The Dashboard 105, sometimes referred to as the OWJO Dashboard, comprises embeddable program code that provides the user with information on their account, content and sales and marketing analysis. The Dashboard may be any type and form of executable code, such as an application, program, library, component, control or script. In some embodiments, the Dashboard can be installed and executed within any separate web page or HTML without requiring additional compilation. In other embodiments, the OWJO Dashboard executes within a Google Gadget environment on iGoogle, Google Desktop or devices with WebKit based web browsers installed such as the Symbian S60 3^{rd} Edition Feature Pack 2 (Web Widgets for S60) as well as the WidSets mobile widget environment. In other embodiments, the Dashboard can execute on a WebKit based Safari browser on Apple iPhone. Dashboard 105a depicts OWJO Dashboard running on a desktop PC, for example on iGoogle. Dashboard 105b depicts OWJO Dashboard running on a PDA/Mobile Device within the WidSets mobile widget environment.

As will be described in further detail later in this document, the Dashboard has a number of sections, including but not limited to:
Inbox of user's content. The Dashboard displays content that the user has purchased or subscribed to, but not played.
My Content section: This shows the content that the user has rights to.
My Subscriptions section: This displays the subscriptions that the user has subscribed to. By way of illustration, the user can drag subscription icons to an iTunes desktop PC application to play content on iTunes and synchronize to an iPod device.
Account section: This shows the user's current credit balance. If the user is also selling content, then their accumulated royalty balance is shown
Sales Analysis section: In one embodiment, this section is only shown if the user is also selling content. This section may display sales analysis tips as generated by the Sales Analysis systems in the OWJO platform.

Still referring to FIG. 1A, the iPhone Client 107 (sometimes referred to as the OWJO iPhone client in some embodiments) is an iPhone/iTouch application or client agent executing in a native environment on Apple iPhone/iTouch. In some embodiments, the client 107 is written in Objective C. The OWJO Client may include any portion of or all of the functionality of the OWJO Dashboard. The client 107 may include functionality, logic or operations to search for best rated user generated content, upload new content that can be stored on the iPhone/iTouch and/or set pricing.

In some embodiments, the iPhone client has further functionalities, including but not limited functionalities to search for artists, view digital and physical items for sale, and purchase items. The iPhone client may include functionalities and elements substantially similar to those provided by a Storefront widget. In one embodiment, the iPhone client enables a user to view (e.g., from a website), download, install and/or operate a Storefront widget, for example to peruse and purchase items for sale.

Although FIG. 1A depicts a client agent 107 designed and constructed for the iPhone or iTouch. The OWJO platform may include a plurality of client agents, each designed and constructed to operate or execute on any type and form of device and for or within the operating system and environment of such a device, including any type and form of mobile device, cell phone, personal digital assistant, etc.

The web site 103 (sometimes referred to as the OWJO web site in some embodiments) is the web presentation layer to the platform Server 110. The website provides access to and presentation of the functionality and services of the platform 110 via any type and form of user interface, such as a web-based interface. For example, using any type and form of web browser such as Internet Explorer, Mozilla Firefox or Apache Safari, a user can create a user account on the platform 110 and generate an OWJO Storefront. The user can populate their OWJO Storefront from digital content stored on the machine they are using or by accessing their existing Internet storage account. The web-site 103 may provide access to or a user interface to any of the functionality, operations or logic described in connection with the Storefront, Dashboard, Storage, Client Agent, Web-site or otherwise as described herein.

Any of the Storefront, Dashboard, Storage, Client Agent or Web-site may communicate, be interfaced or integrated with another component using any type and form of interfaces, inter or intra process communications, messaging, etc. In some embodiments, the OWJO Storefront 102 communicates with the OWJO Server 110 using JavaScript Object Notation, (JSON) format as specified in RFC 4627. The Hypertext Transfer Protocol (HTTP) may be used as the communications protocol. In some embodiments, the OWJO Storefront 102 flash application has a number of initialization parameters that are passed into the flash application from the HTML page when it initializes. One of those parameters may be the user identifiers (referred to as an OWJO ID) of the user that owns the OWJO Storefront 102. In one embodiment, the OWJO Storefront 102 obtains the content metadata and previews from the OWJO Server 110 using JSON format over HTTP. The OWJO Storefront 102 may also communicate with the OWJO Server 110 when a person is requesting preview content and adding items to a shopping cart.

By way of example, in some embodiments, the client 107, such as an OWJO iPhone Client 107 communicates using JSON/HTTP as well as XML/HTTP with the OWJO Server 110. The OWJO iPhone Client 107 may use any type or form of telecommunication or wireless protocol, such as the Wi-Fi (802.11b/g), Universal Mobile Telecommunications System (UMTS) or High-Speed Downlink Packet Access (HSDPA) mobile telephony communication protocols when communicating with the Server 110. In some embodiments, the Client 107 may silently be updated using the OWJO Push Notification Service 144. In addition, the Client 107 can be configured to poll the OWJO Server 110 for updates.

By way of example, in some embodiments, the OWJO Dashboard 105 communicates using JSON/HTTP as well as XML/HTTP with the OWJO Server 110. In other embodiments, any third party applications can communicate with the OWJO API 108 using XML/HTTP/HTTPS.

The OWJO web-site 103 may be accessible by any type and form of web browsers such as Mozilla Firefox, Safari, Konqueror, Opera, Flock, Internet Explorer, Epiphany, K-Meleon and AOL Explorer. In some embodiments, the Secure Sockets Layer (SSL) cryptographic protocol or Transport Layer Security (TLS) protocol is used by the platform or the web-site to provide secure communications with web browsers. Any type and form of security mechanisms and/or protocols may be used to provide a secure session or connection with the platform 110.

Although FIG. 1A shows a network 104 and network 104′ between the client devices and the servers, the client devices and the servers may be on the same network 104. The networks 104 and 104′ can be the same type of network or different types of networks. The network 104 can be a local-area network (LAN), such as a company Intranet, a metropolitan area network (MAN), or a wide area network (WAN), such as the Internet or the World Wide Web. In one embodiment, network 104 may be a private network and network 104′ may be a public network. In some embodiments, network 104′ may be a private network and network 104 a public network. In another embodiment, networks 104 and 104′ may both be private networks.

The network 104 and/or 104′ be any type and/or form of network and may include any of the following: a point to point network, a broadcast network, a wide area network, a local area network, a telecommunications network, a data communication network, a computer network, an ATM (Asynchronous Transfer Mode) network, a SONET (Synchronous Optical Network) network, a SDH (Synchronous Digital Hierarchy) network, a wireless network and a wireline network. In some embodiments, the network 104 may comprise a wireless link, such as an infrared channel or satellite band. The topology of the network 104 and/or 104′ may be a bus, star, or ring network topology. The network 104 and/or 104′ and network topology may be of any such network or network topology as known to those ordinarily skilled in the art capable of supporting the operations described herein.

Referring now to FIG. 1B, a logical illustration of the business model and the features supported by the platform are depicted. In brief overview, the platform 110 supports a business model that can provide a comprehensive suite of services to content owners and content consumers (content sellers and buyers). The platform may include all of the following components, features, capabilities, functionality or services: mobile device/PDA support, promotion of content, products and services, universal content distribution, advertiser supported content, micro payments, UGC search, content rating, universal content support, digital rights management, social network integration, royalty payments, subscription support, feed/aggregator support, hosting and billing services and real-time sales and marketing analysis. In other embodiments, the platform may include any portions of the above-identified capabilities or functionalities.

A brief overview of the comprehensive suite of services of the OWJO Platform (hereafter sometimes generally referred to as “OWJO” or the platform) is described below.

Mobile Device/PDA Support: Using the OWJO Dashboard 105b, buyers can view a listing or representation of the content they have purchased on their mobile phones or Personal Digital Assistants. An OWJO iPhone Client is also available for processing the listing or representation of content for presentation to a display.

Promotion: Using the OWJO platform a seller can create an OWJO Storefront and publish it on their social networking site, blog or other website. From a social networking site, a seller can promote the OWJO Storefront to all of the seller's connected friends. The OWJO platform can promote an artist and the artist's content by providing web syndication feeds and promoting the artist and the artist's content to feed aggregators.

Universal Content Distribution: An artist's content can be stored either internally on OWJO Storage or externally with third party online storage providers such as Amazon S3, AOL Xdrive, Omnidrive, Yahoo Briefcase and Windows Live SkyDrive.

Advertiser Supported Content: Sellers have the option of monetizing their content by asking OWJO to insert targeted, relevant ads for the content consumers who purchase their content. Multimedia ads may be inserted into, or pre-pended/appended to the seller's audio and video content.

Micro Payments: A micro payment is generally defined as a payment that is too small to be affordably processed by credit card or other electronic transaction processing mechanism. The OWJO platform can provide a mechanism for sellers to sell their content for these small amounts.

UGC Search: The OWJO Platform provides a web user-interface to search for content that is registered with or provided via OWJO. A search feature is also available from the OWJO Storefront. Visitors can search by content using a visual representation of user-generated tags, commonly called a tag cloud. Visitors can also enter a search term or choose from any of the web syndication feeds.

Content Rating: Buyers can rate content that they have purchased by choosing from 1 to 5 stars. A buyer can also write a comment. By only allowing buyers who have purchased content to provide comments and/or ratings, artists may receive more relevant feedback from their customers. Sellers are rated by the average rating of each content, each category of content, or all the content each seller is selling. These ratings and/or comments provide additional feedback to potential content buyers.

Universal Content Support: The OWJO platform can support any current digital media format and is designed to support future media formats.

Digital Rights Management: When content or a subscription is purchased, the OWJO platform will create digital rights and assign those rights to the buyer. OWJO can maintain a record of the buyer's digital rights. A buyer can always access content that they have purchased even if they lose the device they were using to use, download, or otherwise consume the content. A seller can make a commercial decision to protect the seller's content using one of OMA DRM, MagicGate, Windows Media DRM and FairPlay. The OWJO Platform supports future protection schemes by using a pluggable architecture.

Social Network Integration: The OWJO Storefront is, for example, an Adobe Flash component that can be embedded on any HTML website such as on the seller's own social networking profile webpage. A seller can promote the seller's OWJO Storefront by sharing the Storefront with the seller's social networking contacts. Some social networking sites make it very easy for a seller to create a profile webpage. The OWJO Platform can makes it very easy for a seller to sell content via that profile webpage.

Royalty Payments: The OWJO Platform can collect royalties on content that is purchased. Each sellers then receive a royalty payment check that is posted to the seller's address. Royalty payments are only made when the buyer is 100% satisfied with their purchased content and the seller's payment has cleared by the OWJO Billing 158 system.

Subscription Support: The OWJO Platform supports the creation of subscriptions. A seller can create a podcast or vodcast that can be purchased over a time period, such as 1 week—7 days, 1 month—30 days, 3 months—90 days, 6 months—180 days and 1 year—365 days. The OWJO Platform will send reminders to the seller to upload new releases or episodes of the podcast or vodcast. The buyer may receive such content automatically.

Feed Aggregator Support: The OWJO Platform generates web feeds that can be promoted (syndicated) to the top feed aggregators such as FeedBurner and submitted to search engines and RSS directories. These syndicated web feeds can then be consumed by potential buyers using feed readers like iTunes, BlogLines, and Google Reader. The embedded content can be preview content that is made available by the sellers. Embedded links can direct the feed consumer to the OWJO Storefront of the seller. Sellers can also promote their own content themselves to the same aggregators. A benefit to the seller is that the seller's content is more likely to be previewed and purchased.

Hosting and Billing: Sellers do not need to manage their own Internet domain name or web site. Sellers do not need to have a merchant account to process credit card payments.

Real-time Sales Tracking and Analysis: The OWJO Platform may collect statistics on sales activity across some or all the OWJO sellers, the type of content and where that content has been sold. Individual sellers can receive reports that benchmark their content against similar content creators. Sellers can receive information on what devices have been commonly used to consume content. Sellers can receive information on which geographic location prefers what type of content.

Mobile Device/PDA Support: Buyers can view the content they have purchased on their mobile phones (Symbian, Java MIDP2 or Apple iPhones) or Personal Digital Assistants. The OWJO platform can transcode the original content supplied by an artist into the required format for each supported device. A content buyer may be able to view purchased content on any device they own.

Promotion: After the OWJO Storefront has been published on their social networking site, an artist can distribute or publish the OWJO Storefront to the artist's connected friends. The OWJO platform can provide artists with generated RSS feeds of previews of their music, images, videos, podcasts and vodcasts. Artists can promote these feeds themselves by using feed aggregators such as FeedBurner. The OWJO platform can provide and promote syndicated web feeds to mobile operators, FeedBurner, BlogLines, Live.com etc. These feeds may promote the most highly rated type(s) of content for each genre or tag recorded. One benefit is that there is a greater chance of the individual artists selling their content.

Universal Content Distribution: Artists with a sizable content base will may store content with online storage providers such as Amazon S3. If artists want to monetize their content, they can indicate to the OWJO platform where to find that content in connection with the online storage provider. There is no need to retrieve the content and upload it to the OWJO platform. The artist's online storage provider can serve the content directly to a content buyer. In some embodiments, this greatly increases the scalability of the platform and reduces latency for content consumers.

Advertiser Supported Content: Sellers have the option of monetizing the sellers' content by asking OWJO to insert targeted, relevant ads for the content consumers who purchase their content. Multimedia ads can be inserted into, or pre-pended/appended to the seller's audio and video content.

Micro Payments: An artist can choose to sell their content for any amount of money, as little as one cent. Artists may have an opportunity to sell more content at optimal price points. Buyers may be more likely to purchase content if the cost is set at the right level. The buyer may preload the buyer's account with OWJO credits using PayPal, credit card, giftcard or mobile phone payment methods. The buyer reduces the buyer's OWJO credit balance when the buyer purchases content.

UGC Search: The OWJO Platform may provide a web user-interface to search for content that is registered with, or provided via OWJO. A search feature is also available from the OWJO Storefront. Visitors can search specific content or search by content type using a visual representation of user-generated tags, commonly called a tag cloud. Visitors can also enter a search term or choose from any of the web syndication feeds.

Content Rating: Buyers can rate content that they have purchased by choosing from 1 to 5 stars. Other rating scales can be supported. A buyer can also write a comment. By only allowing buyers who have purchased content to add comments and/or ratings, artists can receive more relevant feedback from their customers. Sellers are rated by the average rating of all or some of the content they are selling. The comments and/or ratings provide additional feedback to potential content buyers.

Universal Content Support: The OWJO platform can support any current digital media format and is designed to support future media formats. Sellers are not restricted to using specific digital media formats.

Digital Rights Management: When content or a subscription is purchased, the OWJO platform can create digital rights and assign those rights to the buyer. The OWJO platform can maintain a record of the buyer's digital rights. A buyer can always access content that they have purchased even if they lose the device they were using to consume the content. A seller can make a commercial decision to protect their content using one of OMA DRM, MagicGate, Windows Media DRM and FairPlay. The OWJO Platform supports future protection schemes by using a pluggable architecture.

Social Network Integration: The OWJO Storefront may be a component or widget that can be embedded on any HTML website, such as the seller's own social networking profile webpage. A seller can promote the seller's OWJO Storefront by sharing it with all their social networking contacts. Some social networking sites make it very easy for a seller to create a profile and a profile webpage. The OWJO Platform and the methods described herein can makes it very easy for a seller to sell content on that profile webpage.

Royalty Payments: The OWJO Platform can collect royalties on content that is purchased. Sellers then receive a royalty payment check that is posted to their address. Royalty payments are only made when the buyer is 100% satisfied with their purchased content and the seller's payment has cleared the OWJO Billing 158 system.

Subscription Support: The OWJO Platform can support the creation of subscriptions. A seller can create a podcast or vodcast that can be purchased over a time period, such as 1 week—7 days, 1 month—30 days, 3 months—90 days, 6 months—180 days and 1 year—365 days. The OWJO Platform can send reminders to the seller to upload episodes. The buyer may receive the subscribed content automatically.

Feed Aggregator Support: The OWJO Platform can generate web feeds that can be promoted (syndicated) to the top feed aggregators such as FeedBurner and submitted to search engines and RSS directories. These syndicated web feeds can then be consumed by potential buyers using feed readers like iTunes, BlogLines, and Google Reader. The embedded content can be preview content (e.g., trailers and teasers) that is made available by the sellers. Embedded links may direct the feed consumer to the OWJO Storefront of the seller. Sellers can also promote their own content themselves to the same aggregators. One benefit to the seller is that their content may be more likely to be previewed and purchased.

Hosting and Billing: Sellers do not need to manage their own Internet domain name or web site. Sellers do not need to have a merchant account to process credit card payments.

Real-time Sales Tracking and Analysis: The OWJO Platform can collect statistics on sales activity across some or all of the OWJO sellers, the type of content and where that content was sold. Individual sellers can receive reports that benchmark their content against similar content creators. Sellers can receive information on what devices have been commonly used to use, download, or otherwise consume content. Sellers can receive information on geographic and/or demographic preferences to types of content.

Referring now to FIG. 1C, some of the modules used by or combined to form the platform are depicted. In brief overview, the platform server 110 may include any one or more of the following modules: storage, billing, digital rights management, content management, notification and personalization/recommendation service. Although described and depicted as modules, the storage, billing, digital rights management, content management, notification and personalization/recommendation service may be formed in any combination of one or more modules, which may include one or more of an application, program, library, service, process, task or any set of executable instructions (or any combination thereof) executing on one or more servers 110.

The storage module provides and/or manages content storage, such as the storage of any type and form of media, such as documents, video, audio, etc. The storage module may manage any type and form of storage and may include storage internal to the platform 110 or external to the platform 110. For example, content can be stored internally using OWJO Storage or externally with third party online storage providers such as Amazon S3, AOL Xdrive, Omnidrive, Yahoo Briefcase and Windows Live SkyDrive. The storage module may include an external storage service 140 and a platform or OWJO storage service 142.

The External Storage Service 140 can provide any type and form of mechanism to interface to online storage providers such as AOL Xdrive, Amazon S3, Omnidrive, Yahoo Briefcase, Windows Live SkyDrive and future online storage providers through the use of pluggable online storage adaptors. An artist can elect to use their own online storage provider to serve their content or provide their own storage servers. A buyer can elect to store purchased content on their online provider's, or artist's storage servers' storage systems.

Third-party online storage service providers such as AOL Xdrive, Amazon S3, Omnidrive, Yahoo Briefcase and Windows Live SkyDrive, can provide public application program interfaces (APIs) that allow their customers to store, retrieve, delete and share files. The External Storage Service 140 may provide an adaptor for any and/or each of these online storage providers. In some embodiments, one adaptor supports multiple online storage providers. In other embodiments, each adaptor supports a specific online storage service provider. The storage adaptor may be configurable. Any type and form of parameters or settings may be used to configure any operational or performance characteristic of the storage adaptor. Using a configured storage adaptor the platform's Storage Service 140 can store, retrieve, delete and share content at a storage provider, such as AOL Xdrive, Amazon S3 or OWJO Storage.

Each platform account user, buyer or seller has at least one associated OWJO Storage account. A buyer or seller may store any form or type of information and digital content in the OWJO Storage according to the at least one OWJO Storage accounts. For example and in one embodiment, stored digital content in each OWJO Storage account may include content for sale by a seller, and content purchased and stored for later download or streaming to the buyer. There may be a charge or service free for access to OWJO Storage and or each OWJO Storage accounts. The amount of the charge or fee may be based on network bandwidth access and/or storage capacity used.

In some embodiments, a user, buyer or seller may be provided a predetermined amount of storage and/or network bandwidth either at no charge or included in any other charges or service fees. In some embodiments, a user, buyer or seller may pay to upgrade, enhance or increase the amount of bandwidth and/or storage used. A seller's OWJO Storefront may use either OWJO Storage and/or any existing online storage provider's account. In some embodiments, content can be copied to OWJO Storage from an online storage provider, such as AOL Xdrive or Amazon S3, when content is purchased. In another embodiment, the platform may provide to the purchaser's OWJO account read-only shared access to the seller's content/storage.

The platform or OWJO Storage Service 142 may comprise an internal distributed storage system for storing any type and form of content, such as content for both buyers and sellers. In some embodiments, the storage service stores the content internally in a secure manner. For example, in one embodiment, the content may be stored encrypted and/or compressed. Content and subscription rights are also stored securely.

The Billing 158 module handles, processes, manages and/or facilitates any of the financial related functions of the platform, including but not limited to micro payment transactions, royalty management, refund processing and payout processing. The billing module 158 may record any and all transactions in a transaction repository or database. The billing module 158 includes a micro payment service 145 and a payout processing service 150.

The Micro Payment Service 145 may include any functions, logic and/or operations to manage content and subscription purchasing using micro payments. The Micro Payment Service provides a means for sellers and buyers to pay for products at low values or for small amounts of monies without incurring credit card or other third-party transaction fees. For example, by processing a transaction via the OWJO platform and controlling the transaction independent of a third party payment processor, third party fees and limitations can be avoided.

In some embodiments, this is possible because through the use of OWJO Credits. A buyer can elect to purchase or otherwise accumulate OWJO Credits. The buyer can use the buyer's accumulated OWJO credits to purchase content, bypassing any third-party payment method in particular transactions. In some embodiments, transacting with OWJO Credits can avoid incurring all transaction fees. In other embodiments, transacting with OWJO Credits may incur a one-time fee or periodic fees (e.g., indirectly through OWJO membership fees), a low fee or indirect service charges (e.g., via OWJO revenue-sharing on each transaction.

The Payout Processing Service 150 includes functions, logic or operations to generate, produce or provide payout and/or royalty information in any form or format. For example, the payout processing service 150 may generate a payout file that is used to make royalty payments to artists.

The Personalisation/Recommendation Engine may comprise any functions, logic or operations for creating, editing or managing user profiles, creating, maintaining and tracking any type and form of usage statistics and for making any type and form of recommendations or suggestions regarding content to one or more users. The engine may include a Usage Pattern Collection Service 165, which may receive statistics from OWJO Client agent on user activity. The engine may also include a Recommendation Service 170. This service 170 utilizes collected usage pattern and purchased content and digital rights to generate appropriate content recommendations for buyers. The Profile/User Preferences Service 175 may comprise logic, function or operations to create, edit and maintain a profile of each buyer. This service 175 may store and manage the profile in any internal or external storage location via the OWJO Storage. Functions, logic and operations as described herein may be provided by any combination of hardware and software.

Referring now to FIG. 1D, another embodiment of modules that are used by or combined to form the OWJO Platform are depicted. The platform 110 may include one or more modules for authentication/authorization, scheduling, advertising and client content packaging.

The Authentication/Authorization module may include a Digital Right Authentication Service 180, a web site authentication service and a dashboard authentication service. Each of these services may be combined into any one or more services and may provide any type and form of authentication and authorization to access any portion of the platform and content/media provided via the platform. The Digital Right Authentication Service authenticates and authorizes access to digital rights for any content under digital rights management. The web site authentication service authenticates and authorizes access to the OWJO web site. Dashboard authentication service authenticates and authorizes access to the OWJO Dashboard.

The scheduler 157 provides scheduling functionality for the platform 110, including providing scheduling functionality for any other OWJO module. The scheduler 157 may provide any type of event, trigger or notification based on level or granularity of temporal information or identified event. The scheduler may have a predetermined set of one or more scheduled events. The scheduler may be configured by a user or administrator. A user may configure the scheduler for any customized or personalized scheduled triggers or events. In some embodiments, the scheduler triggers notification or update events based on any changes to the media content. Examples of schedules events, include without limitation, subscription content delivery and Podcast and vodcast episode upload reminder messages. In other embodiments, the scheduler triggers or schedules any personalization or recommendation notifications, messages or updates. In another embodiment, the scheduler interfaces with the digital right management system to schedule any checks for any temporal restrictions on purchased content of a buyer.

The advertising module provides access to, interface or communication with any type and form of external advertising servers. In some embodiments, rich media advertisements may be spliced or provisioned digitally into multimedia content (e.g., video, image and audio) and targeted to specific profiles of user. In some embodiments, the advertising service may only be used when buyers have agreed (opted-in) to receive content that is advertiser supported. The advertising module may include one or more components or services, such as the advertising server service 195 and the targeted advertising service 200.

The advertising server service 195 provides a mechanism to interface to any one or more of a plurality of multimedia advertising servers, such as XOpen or a provider such as Google AdSense. In some embodiments, the advertising server service 195 obtains from external advertising servers or services an inventory of digital or media advertisement for ingestion into the platform 110 and/or delivery to users of the platform 200.

The targeted advertising service 200 may slice or provision media advertisement into content for a specific user, in association with the delivery of content or otherwise in association with or during the use of any portion of the platform. In one embodiment, the targeted advertising service embeds, encoded or otherwise integrates the media ads in the content. In another embodiment, the targeted advertising service delivers media ads in conjunction with or in combination with any delivered content, such as via an overlay, media player skin or other user interface elements. In some embodiments, this service 200 provisions appropriate rich media advertisements into the content for a specific user. In other embodiments, In order to determine the advertisements to include in a targeted advertising campaign or delivery, the targeted advertising service may look at 1) the user's Profile/User Preferences and 2) any geolocation data provided by the OWJO Client. In other embodiments, the targeted advertising service may use any metadata from the advertising media and any information about a seller and/or a buyer, including type, form and format of content, and history of transactions to determine one or more media ads for delivery. The determination and timing of ad delivery may also be based on any temporal information.

The Payment Processing module provides a mechanism to interface to any type and form of third party or external payment processors such as PayPal, Google Checkout and the Trusted Mobile Payment Framework. The payment processing module may interface to any processor to use any type and form of payment. The payment processing module may interface to any micro-payment processing system or otherwise may be designed and constructed to handle any type and form of micro-payment processing. The payment processing module may include a PayPal service 155 to interface, communicate with and provide payment transactions via the PayPal payment processing service. The payment processing module may include a mobile payment service that utilizes the Trusted Mobile Payment Framework to purchase credits, such as OWJO recognized credits, using a buyer's mobile device

The Client Content Packaging Service 210 includes a set of predetermined and/or pre-packaged content for OWJO Storefront, OWJO Dashboard, OWJO web feeds and OWJO Client(s). In some embodiments, the client content packaging service offloads any intensive processing to ensure scalability of OWJO Platform. This service can use pluggable adaptors to support different OWJO Clients supported by the platform or expected to be supported by the platform. In some embodiments, the client content packaging service transcodes, transforms, prepares, processes and/or provisions content in one format to content in one or more different formats. The client content packaging service may transform or transcode content into different formats in a predetermined manner, ad-hoc or otherwise on demand. For example, in one embodiment, the client content packaging service, upon receipt of content from a seller, provisions the content into a plurality of predetermined formats for a set of one or more target devices. In another embodiment, the client content packaging service provisions the content into one or more other formats based on buyer demand, request or purchase for the content. In yet another embodiment, the client content packaging service provisions the content into one or more other formats based on request by the seller.

### Section B—Universal Content Consumption, Distribution and Digital Right Management Features of the Platform.

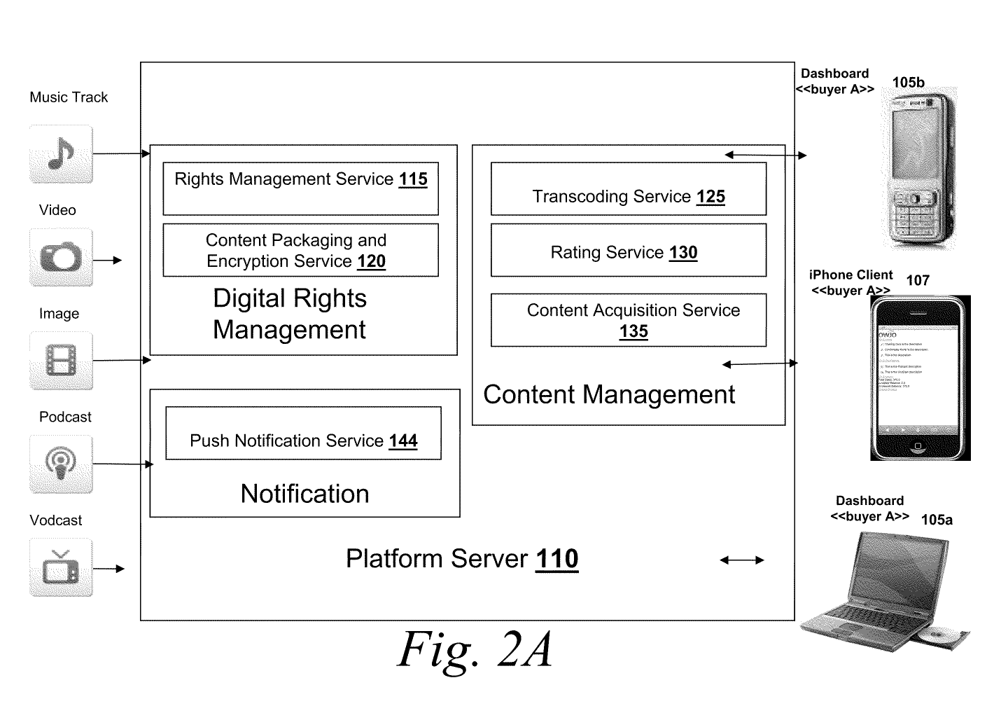

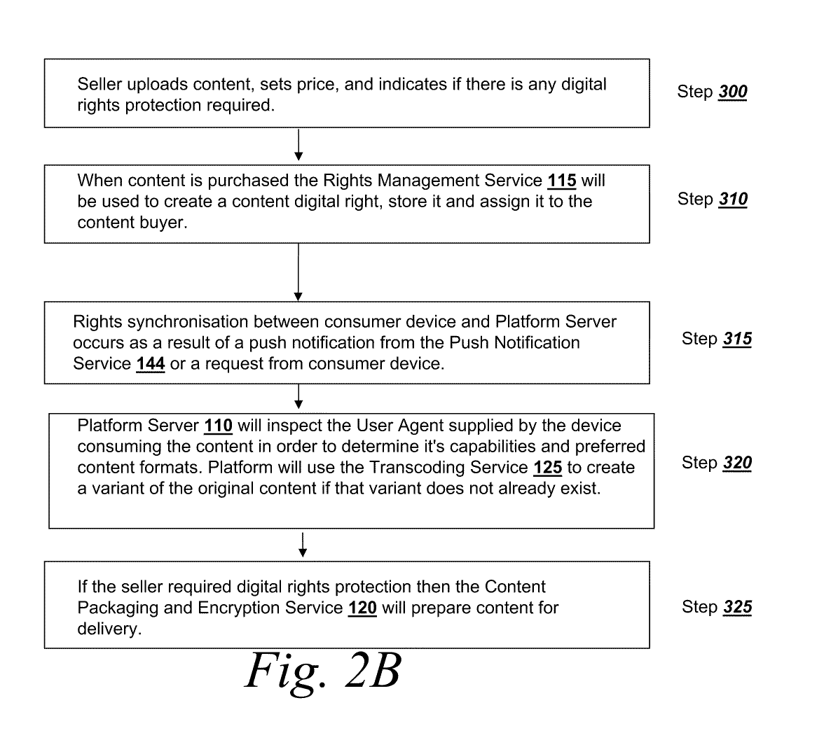

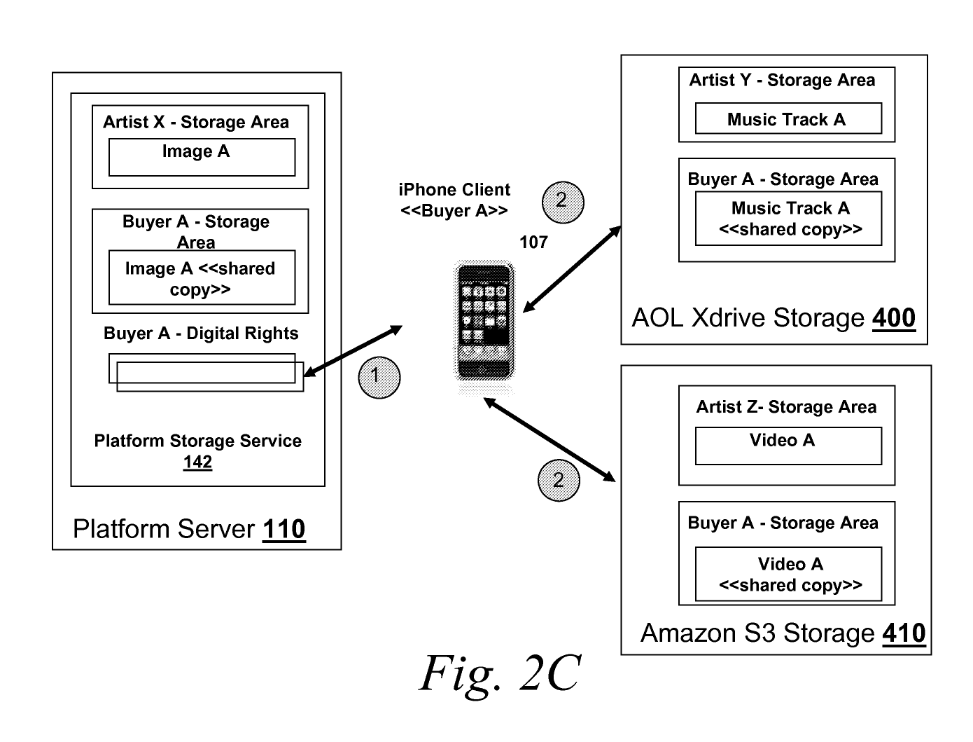

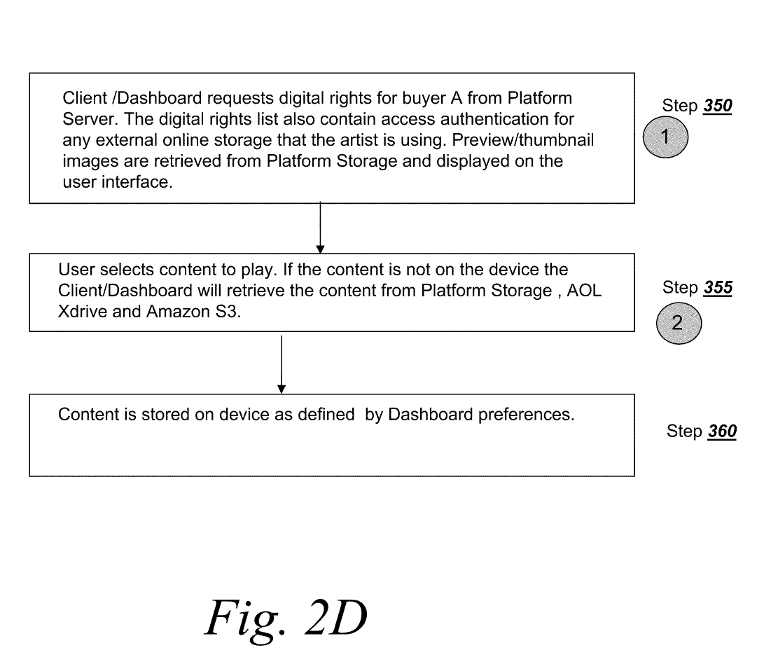

Referring now to FIG. 2A, a block diagram of an embodiment of the platform providing universal content consumption and digital rights management is depicted. In brief overview, the platform server 110 may include a digital rights management module, a content management module and a notification module. Via one or more of these modules, the platform 110 provides a system for universally ingesting content from sellers in a plurality of formats and distributing the content in one or more different formats based on the buyer's/client's environment while maintaining copyright protection and digital rights management of the content.

The Digital Rights Management (DRM) module provides creation, storage, management and tracking of any type and form of digital rights. In some embodiments, the digital rights management module performs authentication for and generation of any type and form of DRM wrappers for content on any type and form of platform. A DRM wrapper includes any mechanism, interface, encoding, watermarking, encryption, enclosing, wrapping or processing of content to control or attempt to control use of digital media by preventing access, copying or conversion to other formats by end users. In some embodiments, the DRM wrapper may be designed and constructed to restrict the user based on any temporal information, a number of uses or views, or number of devices. In one embodiment, the generated DRM wrapper may be based on the type of media player or reader used on the client to use, download, or otherwise consume content, although any characteristics of the user or the client device may used to determine the type of DRM for provisioning the content. In other embodiments, the DRM wrapper controls use of content based on a subscription model, payment and/or authentication and authorization. A number of different protection schemes are supported through the use of pluggable DRM adaptors.

The Rights Management Service 115 provides license (rights) issuing and content encryption keys used for the provisioning of DRM protected content. The rights management service may use any type and form of keys in accordance with any type or form of content protection or digital rights management schemes. In some embodiments, the rights management service 115 interfaces to or communicates with any external or third party service to issue or otherwise obtain any keys for provisioning DRM protected content.

The Rights Management Service 115 may synchronize acquired rights (from purchases and/or subscription) between OWJO Clients and the OWJO platform server. A User may be associated with a plurality of OWJO Clients, synchronized with the same acquired rights. Each OWJO client may access content from any or multiple storage locations corresponding to the acquired rights. The Rights Management Service 115 may also support content variants bounded or allowed by the acquired rights, where needed. For example, certain acquired rights may qualify a user to download a remixed or extended version of a recording, or a video embedded with additional commentary.

The Content Packaging and Encryption Service 120 provides a mechanism to protect content by applying any type and form of DRM protection scheme to any ingested, stored or distributed content. The content packaging and encryption service may apply DRM protection schemes such as Windows Media DRM or OMA DRM through the use of pluggable DRM adaptors. In some embodiments, the content owner or artist may select one or more DRM protection schemes to adopt or use in distribution of content. In other embodiments, the content packaging and encryption service may apply a plurality of DRM protection scheme to a content or media. In some embodiments, the content packaging and encryption service may apply a different DRM protection scheme to each separate copy of the content or media.

In some embodiments, the OWJO platform may provide support for an iTunes OWJO plugin. The OWJO web site may provide the iTunes OWJO plugin, for example, for download and installation on a user's computing device with an iTunes application. The OWJO iTunes plugin may be an executable file and may configure iTunes or add functionality to iTunes. The OWJO iTunes plugin may comprise any data files and program code written in any programming language or scripting code. The OWJO iTunes plugin can connect with the OWJO Server automatically or upon login to the OWJO website (e.g., when a an order is processed and fulfilled, or when a user is ready to access a purchased content). The OWJO iTunes plugin retrieve the user's digital rights and download content to the user's iTunes library. The iTunes library can then be synchronized with the user's iPod/iTouch/iPhone device. In other embodiments, in place of an iTunes OWJO plugin, a user may use a different plugin or a link to start iTunes and receive OWJO purchased content as a Podcast. Although generally described above using iTune and Apple devices, the above systems and methods may be implemented in other vendor or non-proprietary applications and devices.

The Content Management module or content manager provides content storage, content ingestion, and rating and transcoding functions, operations and logic. In some embodiments, the content manager stores content is in a secure, distributed and/or efficient manner. The content management module is designed and constructed to handle, process and cope with many current and future content types. Content may be automatically converted or transcoded—either at time of ingestion, upon user request, or buyer request and demand—to different versions for delivery to and support of different devices, environments, users and media players that will or may be used to consume the content. In some cases, the content management module provides syndicated feeds to external sites—for example the best rated videos from USA.

The content acquisition service 135 is used to ingest, acquire and/or register content from many different sources, such as any device or storage service used by the seller or content owner. In some embodiments, the content acquisition service uses or interfaces via the storage services to obtain content from any external storage service provider. The content acquisition service may be designed and constructed to ingest, receive, register or obtain any type and form of predetermined formats or content types, such any format used for any type and form of video, audio, documents, music, movies, etc.

The Transcoding Service 125 transcodes, processes, converts or otherwise transforms content from one codec, form or format to another codec, form or format. In some embodiments, this service supports the Open Mobile Alliance Standard Transcoding Interface specification, such as version 1.0. The transcoding service may transcode content from any one or more characteristics of the content to provision the content to have a different set of one or more characteristics. The Transcoding Service may provide automatic content transcoding or transcode content according to pre-defined or user-specified content formats, device types, security requirements, OS support, bandwidth availability and/or availability of applications for using/processing the content.

The transcoding service may transcode content provided or supported by one device to provision the content for a different device. The transcoding service may support any type or form of devices and can extend support to new devices. The transcoding service may transcode content provided or supported by one operating system to provision the content for a different operating system. The transcoding service may transcode content provided or supported by one media player to provision the content for a different media player. The transcoding service may transcode content provisioned for one form factor to provision the content for a different form factor. The transcoding service may transcode content in one language to provision the content for a different language. The transcoding service may transcode content from one DRM protection scheme to provision the content for a different protection scheme. The transcoding service may transcode content from one level of resolution to provision the content for a different level of resolution. The transcoding service may transcode content from one frame rate to provision the content for a different frame rate. Further, the transcoding service may transcode content based on encryption and/or compression.

The Rating Service 130 manages the content rating engine. In one embodiment, the rating service comprises a content rating engine. In some embodiments, only a buyer of content or someone who has purchased a right to use the content may rate the content. In other embodiments, users associated with or authorized by a buyer, such as family or friends, may rate the content. In yet another embodiment, any one or more users of the platform may rate the content. The rating service may use any type and form of rating scheme, such as numerical or textual rating schemes in ascending or descending order. The rating service may have a predetermined set of rating levels of any number and granularity. The rating service may allow user generated comments. The rating service may interface to, link to or obtain ratings from any external web site, rating service or rating system.

The notification module 144 provides a mechanism to notify content consumers using any type and form of communications that content is available for the content consumers to consume or any other events or updates associated with the content. The Notification module may include a number of pluggable adaptors used to communicate with existing communication services as well as prepare for future ones. In some embodiments, the following adaptors are available: 1)

SMSC Adaptor: This is used to send silent updates to Java MIDP2 devices (message to a specific port) and using WAP Push—Service Invocation and Service Loading to send messages to devices that support WAP Push (In addition, iPhone Push Notification is supported), 2) Email Adaptor: to send messages via email, 3) Yahoo IM Adaptor: To send messages to Yahoo! Messenger, 4) MSN IM Adaptor: To send messages to Windows Live Adaptor, 5) Windows Live Adaptor: to send messages to Windows Live Messenger, 6) XMPP Adaptor: to send messages to instant message clients such as Jabber, GTalk and iChat. Other adopters may be available and/or supported.

Referring now to FIG. 2B, an embodiment of steps of a method of universal content consumption, distribution and copyright protection is depicted. In brief overview, at step 300, the seller provides content available for purchase by a buyer via the Storefront. At step 310, the rights management service provides a content digital right for a buyer. At step 320, the characteristics of the buyer's device will be used to determine a variant of the content to deliver to the buyer. At step 325, the content is bundled in accordance with the appropriate variant for the buyer and the desired DRM protection scheme of the seller.

In further details, at step 300, the seller or artist establishes, via the OWJO web site 103, a Storefront and makes available content for purchase. The seller may create an item on their Storefront 102 by uploading content, setting the price and providing the content item description. The seller can also elect to use content they have previously stored with an online storage provider such as AOL Xdrive or Amazon S3. The seller also indicates if they desire content protection. The seller can choose from a list of protection schemes that will be applied to content, such as when the content is purchased.

At step 310, the Rights Management Service 115 may create a content digital right in accordance with the selected protection scheme. The rights management service may assign the digital right to the buyer. The content digital right may be composed of a unique identifier for the content, the buyer unique identifier and/or the play, execute, print and display constraints for the content. The content digital right may be stored using OWJO Storage Service 142.

At step 315, a synchronization request is initiated by OWJO Client 107 or OWJO Dashboard 105. The synchronization request could have been initiated by any polling mechanism on the client or as the result of a push message originating from the Push Notification Service 144.

In further details, the synchronization message synchronizes, communicates or transfers what the buyer has purchased, such as with any one or more devices of the buyer. The Push Notification Service 144 may transmit or communicate a message to the Client to initiate synchronization. For synchronization, the client reports the list of digital rights to the client has purchased or subscribed, the server reports the list of digital rights the client should have and instructions on where to download, stream, obtain or otherwise access the content. In one embodiment, the server can request that the client delete content that the user no longer has rights to access. In some embodiments, an indicator or representation of the content, such as a thumbnail, does not appear on either the Dashboard or Client unless synchronization occurs. In other embodiments, an indicator or representation of the content does not appear on either the Dashboard or Client if the digital rights have expired or is revoked.

At step 320, the OWJO Client provides a user agent and a manifest listing the digital right unique indicators of content that have been stored on the device. The OWJO Client may be available on a number of different platforms. In one embodiment, the OWJO Client could be executing on an Apple iPhone. In another embodiment, the OWJO Client could be executing on a Java MIDP2 device. In yet another embodiment the OWJO Client could be executing in a widget environment on a desktop PC. In some of these embodiments, the OWJO Client has a special string, referred to a user agent that is unique to each instance of the OWJO client. Although referred to as a string, this user agent identifier may be any type and form of information, including numerals, letters and alpha-numeric or other types of characters. The Client or user agent may inject this user agent identifier into any portion of a network communication, such any portion of the header or body of an HTTP message. In some embodiments, the client or user agent injects the user agent identifier in the HTTP standard header “HTTP_USER_AGENT” when the OWJO Client is communicating with the OWJO Server. The OWJO Server determines the content rendering capability of the device executing the OWJO Client and the device's capabilities by inspecting these user agents.

The user agent supplied by the device may be checked in order to determine the device's capabilities and preferred content formats. If the client identified by the user agent is not capable of viewing the purchased content then the Transcoding Service 125 may be used to create a variant of the content for that device. The new variant may be associated with the original content and stored via the storage services.

At step 325, if the seller requires digital right protection, then the Content Packaging and Encryption Service 120 may create a protected content bundle for that specific device and client. In some embodiments, the content packaging encryption service creates the protected content bundle at the time of purchase or delivery of content to the device. In other embodiments, the content packaging encryption service created the protected content bundle at the time of ingestion or at a time prior to the purchase. In these embodiments, the desired variant of protected or encrypted content may be available and stored via the storage services in any storage location.

FIG. 2C is a block diagram providing a depiction of an embodiment of universal content distribution and digital rights management. The method of FIG. 2C depicts a scenario where content that buyer A has purchased is stored on three online storage locations 1) OWJO Storage, 2) AOL Xdrive and 3) Amazon S3. The OWJO Client may be an OWJO iPhone Client. The OWJO iPhone Client initially obtains the digital rights for Buyer A.

In one embodiment, OWJO creates proxy accounts with third party online storage providers such as AOL Xdrive and Amazon S3 in order to efficiently manage access to stored content. For example, the image A is retrieved from the OWJO Storage area that is owned by buyer A. Read-only access to a shared copy of the image is provided to buyer A by the OWJO platform on behalf of artist X. The music track A, owned by artist Y is retrieved from AOL Xdrive storage area that is owned by a proxy buyer A that was created by the OWJO platform. Read-only access to a shared copy of the music track A is provided to buyer A by the OWJO platform on behalf of artist Y. The video A, owned by artist Z is retrieved from an Amazon S3 storage area that is owned by a proxy buyer A that was created by the OWJO platform. Read-only access to a shared copy of the video A is provided to the buyer A by the OWJO platform on behalf of artist Z. At any time, artist X, artist Y and artist Z can revoke the read-only privileges that have been granted to buyer A and the proxy buyer A.

In another embodiment, content is copied into the OWJO Storage area from the artist's third party AOL Xdrive, Amazon S3 or Nirvanix area when a buyer purchases content. The image A is retrieved from the OWJO Storage area that is owned by buyer A. Read-only access to a shared copy of the image is provided to buyer A by OWJO on behalf of artist X. The music track A is retrieved from the OWJO Storage area that is owned by buyer A. Read-only access to a shared copy of the music track A is provided to buyer A by OWJO on behalf of artist Y. The video A is retrieved from the OWJO Storage area that is owned by buyer A. Read-only access to a shared copy of the video A is provided to buyer A by OWJO on behalf of artist Z.

FIG. 2D is a flow diagram of an embodiment of another method of universal content distribution and digital rights management. In brief overview, at step 350, a request for the content of the buyer is received by the platform. A list of the buyer's content may be displayed on the OWJO client or Dashboard. At step 355, the buyer may select a media from the list of content to play. At step 360, the content may be stored on the buyer's device.

At step 350, the OWJO Client/OWJO Dashboard requests the Client Content Parcel for buyer A from the OWJO Server. The Client Content Packaging Service 210 creates the Client Content Parcel. The Client Content Parcel may be unique for a buyer and can include the 1) digital rights assigned to that buyer, 2) the Uniform Resource Identifier and optional authentication details for thumbnail content, and 3) the Uniform Resource Identifier and optional authentication details for multimedia preview content. The Client Content Packaging Service 210 is aware of what content is on each OWJO Client that a buyer owns as this is reported during synchronization. In one embodiment, the Client Content Parcel may be unique for a buyer and an OWJO Client. The OWJO Client/OWJO Dashboard can display thumbnails representing the content that buyer A has rights to access or has otherwise purchased.

At step 355, buyer A selects content to play. If the content is on the device then it can be played, displayed, opened or otherwise used. If the content is not on the device then the OWJO Client attempts to retrieve or retrieves the content from OWJO Storage or a third party storage. The OWJO platform may use the supplied user agent to determine if there is an appropriate content variant for that OWJO Client. If there is no appropriate content variant then the OWJO platform may use the Transcoding Service 125 to request the creation, generation or provisioning of an appropriate content variant. In some cases, the OWJO Client may be notified that content is being prepared and to request the content later or within a predetermined amount of time. In one embodiment, the Push Notification Service 144 notifies the OWJO Client when the content variant is ready for consumption.

At step 360, the selected content may be stored on the device as defined by the OWJO Client/OWJO Dashboard preferences. These preferences may identify where to store the content, such a OWJO storage or a third-party service providers. These preferences may identify the location with any level of granularity, including directory paths and/or folder and/or sub-folder names. In one embodiment, the preferences identify a naming convention for the file having the content to be stored. In some embodiments of the OWJO Client, the user may have the option to store played content on the device. After content is played, the content may then be stored on the device so that it can be played again later. Other user preferences include, but are not limited to: 1) schedule on how often to check for new content and 2) User name and password for access to the buyer's OWJO account.

### Section C—The OWJO Storefront for A Seller.

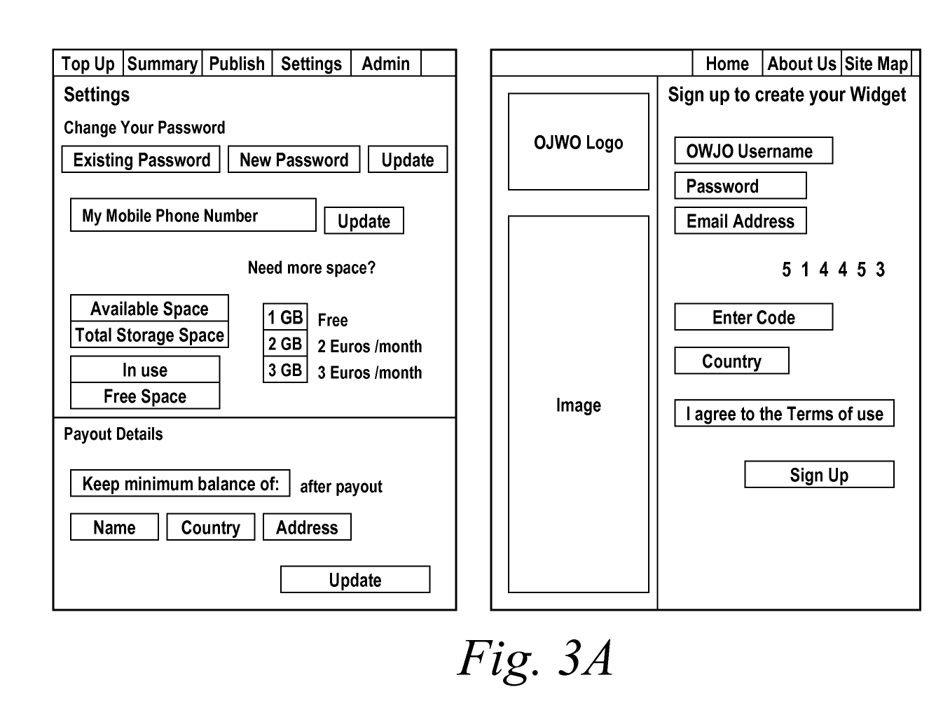

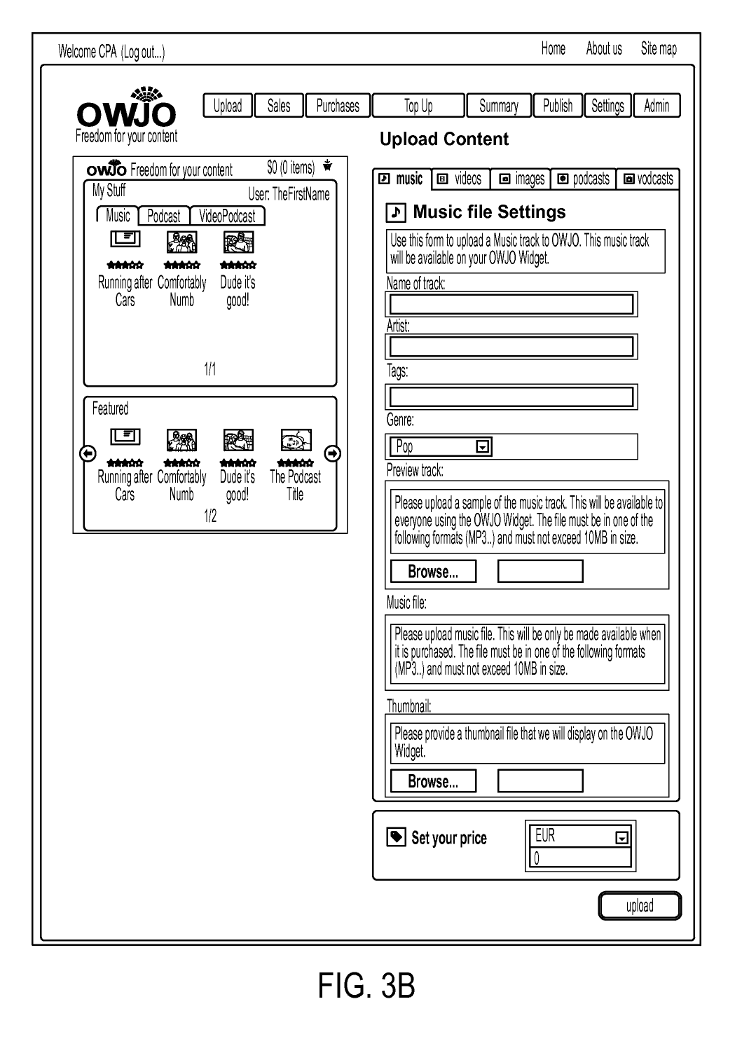

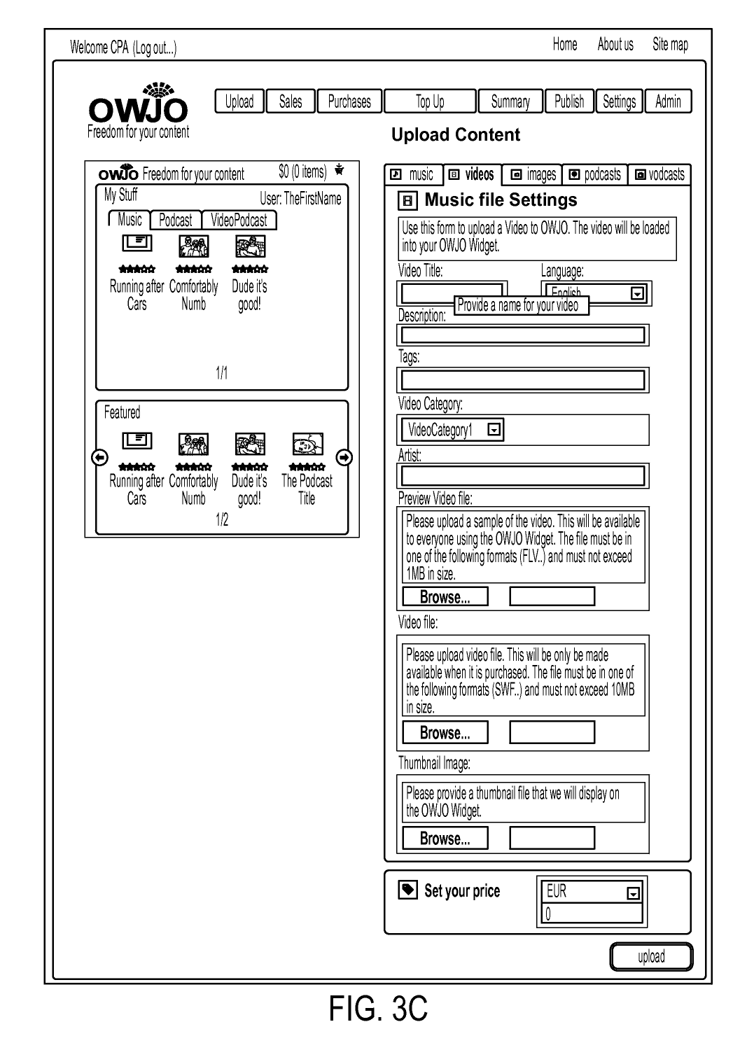

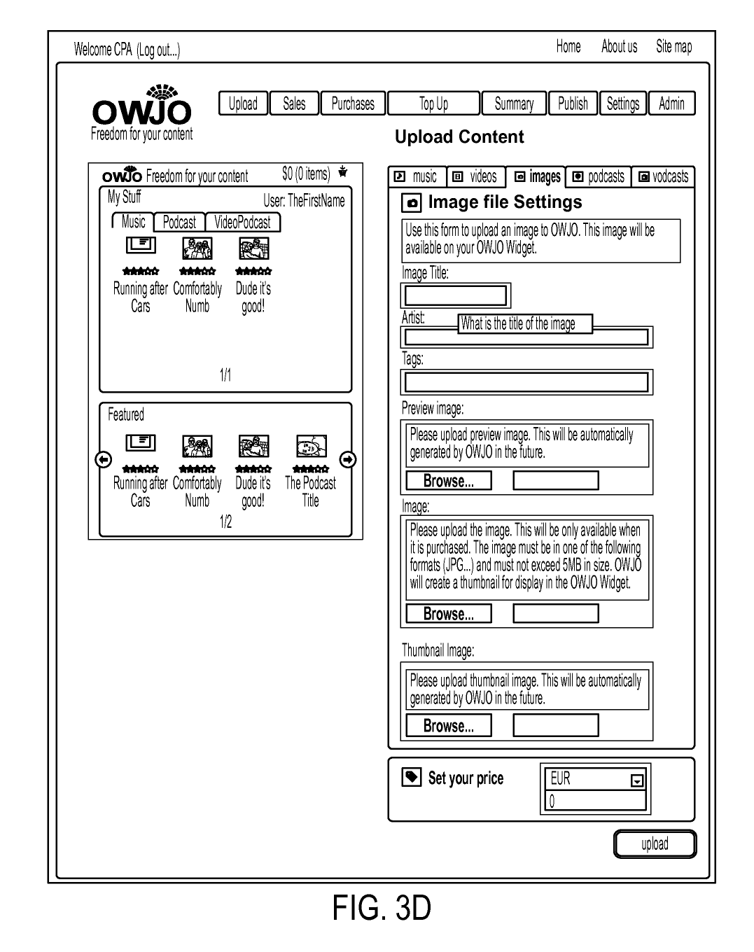

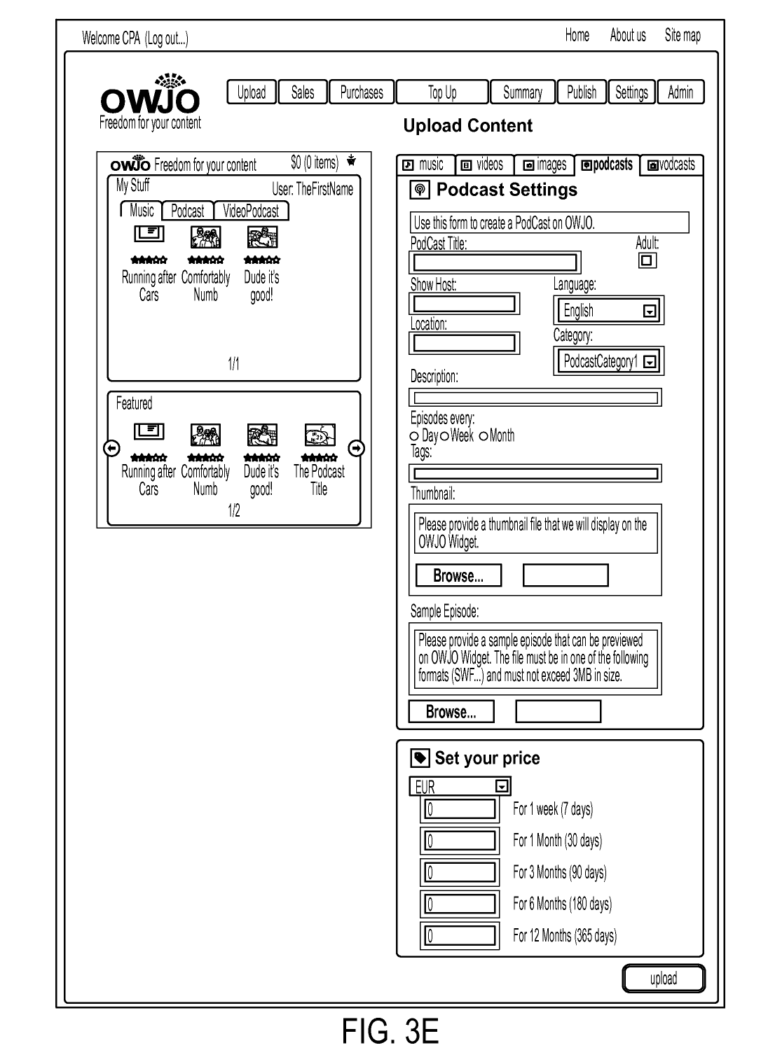

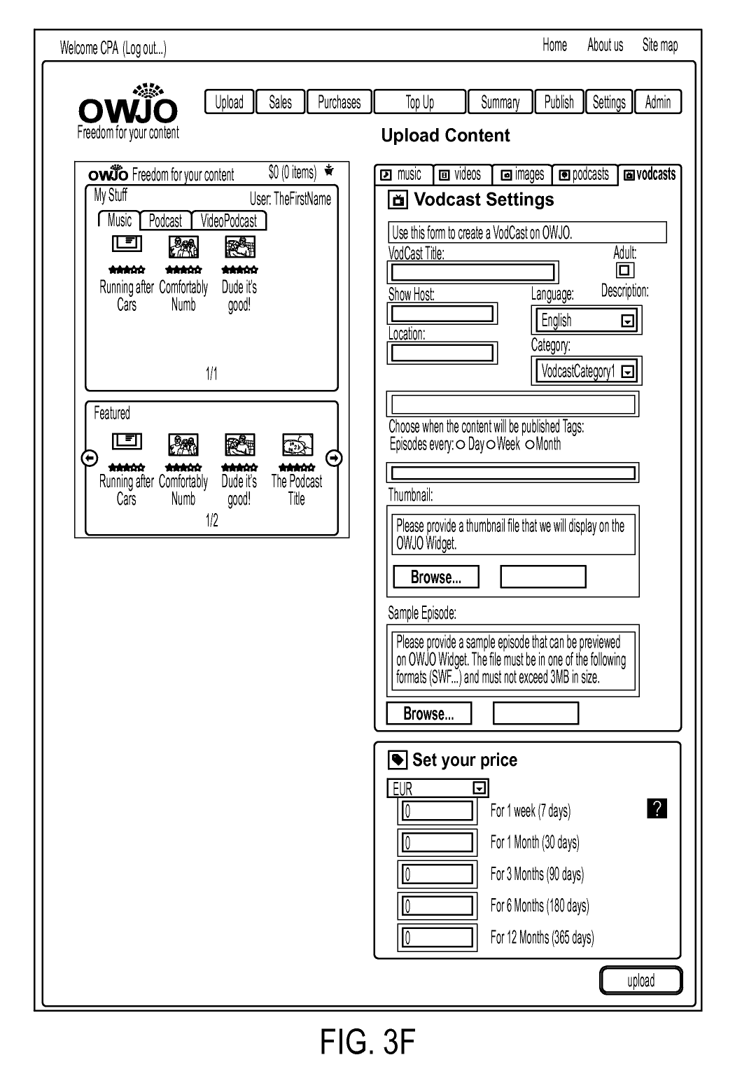

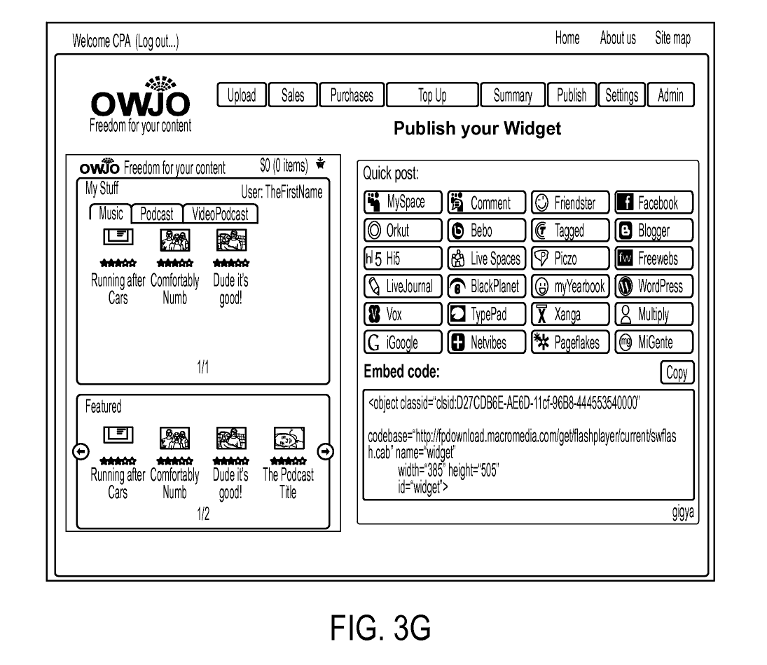

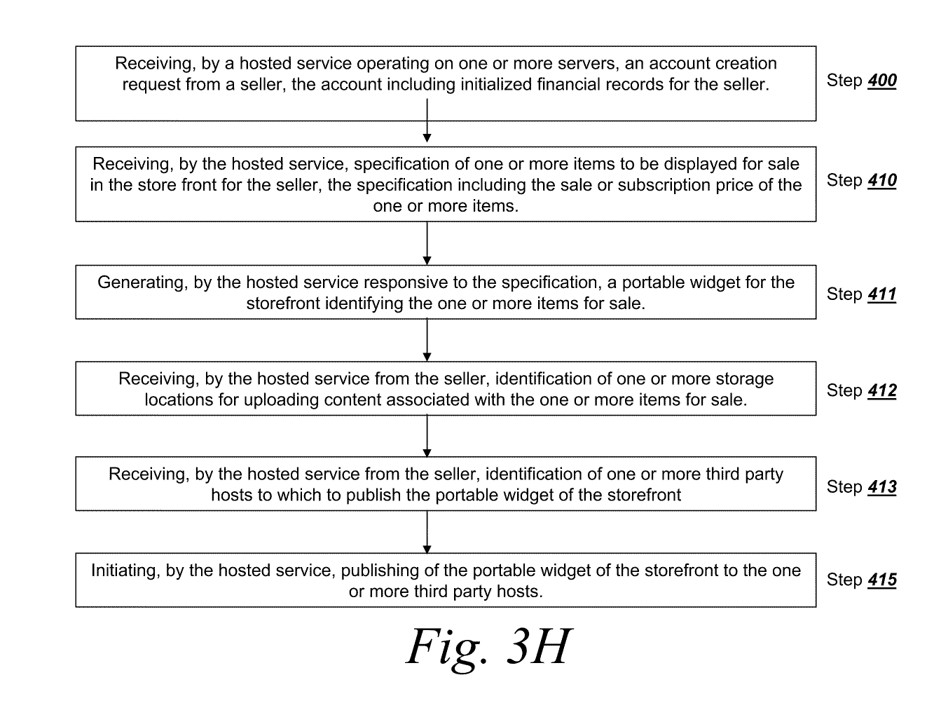

In FIG. 3A, the seller is depicted creating an OWJO Storefront via a user interface of the OWJO platform. The user interface provides a means of self-service by a seller to establish one or more online storefronts on one or more websites or third party hosted services. Using a web browser such as Internet Explorer, Mozilla Firefox or Apache Safari, a user can create an OWJO account that can be used to generate an OWJO Storefront. The following information may be required in order to create an OWJO account, 1) OWJO username—this can be a well known email address 2) A password for access to the account, 3) an email address that OWJO uses to communicate with the user, 4) a random security code and 5) the country the user is currently in. FIG. 3A also depicts the settings page where the seller can maintain the seller's OWJO account by 1) changing the seller's password, 2) updating their mobile number, 3) requesting more storage space and 4) providing the seller's postal address. Payout checks may be posted to the seller's postal address, or in some cases, payments may be electronically transmitted or provided to the seller.

In FIG. 3B the seller is depicted adding a music track to their OWJO Storefront. Using a web browser such as Internet Explorer, Mozilla Firefox or Apache Safari, a seller can create a music track by specifying 1) the name of the track, 2) the name of the artist, 3) one or more tags in the form of a keyword or term associated with the music track, 4) the music genre, 5) a preview of the music track, 6) the actual music track that is for sale, 7) a thumbnail image that can be displayed in the OWJO Storefront and 8) the price that the user would like to sell his or her music track for. The music track preview, actual music track and thumbnail can either be uploaded from the machine that is executing the web browser they are using or loaded from a Uniform Resource Identifier anywhere on the internet. The seller has an option of indicating that the track is advertiser supported and may be free to the buyer. When the buyer receives an advertiser supported track, an advertisement may be embedded in the music track or otherwise delivered along or in conjunction with the music track.

In FIG. 3C the seller is depicted adding a video to the seller's OWJO Storefront. Using a web browser such as Internet Explorer, Mozilla Firefox or Apache Safari, a seller can create video track by specifying one or more of: 1) the title of the video, 2) the language the video is recorded in, 3) a description of the video content, 4) one or more tags in the form of a keyword or term associated the video, 5) the video category, 6) the name of the artist, 7) a preview of the video, 8) the actual video that is for sale, 9) a thumbnail image that will be displayed in the OWJO Storefront and 10) the price that the seller would like to sell the seller's video for. The video preview, actual video and thumbnail can either be uploaded from the machine that is executing the web browser they are using, or loaded from a Uniform Resource Identifier anywhere on the internet. The seller has an option of indicating that the video is advertiser supported and free to the buyer. When the buyer receives an advertiser supported video there may be an advertisement embedded into the video file or otherwise delivered along with or in conjunction with the video.

In FIG. 3D, the seller is depicted adding an image to the seller's OWJO Storefront. Using a web browser such as Internet Explorer, Mozilla Firefox or Apache Safari, a seller can identify, upload or create an image to sell by specifying one or more of: 1) the title of the image, 2) the name of the artist, 3) one or more tags in the form of a keyword or term associated with the image, 4) a preview of the image, 5) the actual image file that is for sale, 6) a thumbnail image that can be displayed in the OWJO Storefront and 7) the price that the user would like to sell their image for. The image preview, actual image and thumbnail can either be uploaded from the machine that is executing the web browser the seller is using or loaded from Uniform Resource Identifier, a ftp site, via email, or from anywhere on the internet.

In FIG. 3E, the seller is depicted adding a podcast to the seller's OWJO Storefront. A podcast is a series of digital-media files distributed over the Internet using syndication feeds for playback on portable media players and computers. Using a web browser such as Internet Explorer, Mozilla Firefox or Apache Safari, a seller can create a podcast by specifying one or more of: 1) the podcast title, 2) an indication of whether the podcast contains adult content, 3) the name of the show/podcast's host, 4) the language that the podcast is recorded in, 5) the location where the podcast is recorded from, 6) the podcast category/genre, 7) the description of the podcast, 8) an indicator that episodes are added daily, weekly, monthly or otherwise, 9) one or more tags in the form of a keyword or term associated with the podcast, 10) a thumbnail image that will be displayed in the OWJO Storefront, 11) a sample episode that will be previewed on OWO Storefront, 12) the price of having access to the podcast for one week, one month, three months, six months and twelve months. The sample episode and/or thumbnail can either be uploaded from the machine that is executing the web browser operated by the seller, or loaded from a Uniform Resource Identifier, a ftp site, via email, or from anywhere on the internet. Similarly the seller has an option of indicating that the podcast is advertiser supported and free to the buyer. When the buyer receives an advertiser-supported episode, there may be an advertisement embedded into the audio file or delivered along with or in conjunction with the audio file.

In FIG. 3F, the seller is depicted adding a vodcast to the seller's OWJO Storefront. A vodcast is similar to a podcast except that the content is video instead of audio. Using a web browser such as Internet Explorer, Mozilla Firefox or Apache Safari, a seller can create a vodcast by specifying one or more of: 1) the vodcast title, 2) an indication of whether the vodcast contains adult content, 3) the name of the show/podcast's host, 4) the language that the vodcast is recorded in, 5) the location where the vodcast is recorded from, 6) the vodcast category/genre, 7) the description of the vodcast, 8) an indicator to say episodes are added daily, weekly or monthly, 9) one or more tags in the form of a keyword or term associated with the vodcast, 10) a thumbnail image that may be displayed in the OWJO Storefront, 11) a sample episode, preview or trailer that will be previewed on OWO Storefront, 12) the price of having access to the vodcast for one week, one month, three months, six months, twelve months or any other duration. The sample episode and/or thumbnail can either be uploaded from the machine that is executing the web browser the seller is operating or loaded from a Uniform Resource Identifier, a ftp site, via email, or from anywhere on the internet. Similarly the seller has an option of indicating that the vodcast is advertiser supported and free to the buyer. When the buyer receives an advertiser supported episode there may be an advertisement embedded into the video file or otherwise played or delivered along with or in conjunction with the video.

In FIG. 3G, using a web browser such as Internet Explorer, Mozilla Firefox or Apache Safari a seller can publish the seller's OWJO Storefront to their social networking profile webpage on Bebo, MySpace, Facebook and many other social networking sites. The seller can also publish the seller's OWJO Storefront to the seller's blog hosted on Blogger or WordPress and many other blogging sites. The seller can also publish the OWJO Storefront to any HTML web site. The seller may be asked to input authentication details such as username and password when publishing the OWJO Storefront.

Referring now to FIG. 3H, an embodiment of steps of a method for a seller to establish a selling presence via the platform is depicted. In brief overview, the steps describes a method of self-service by a seller to establish at a hosted service a store front that is distributable across a plurality of third party hosts. At step 400, a hosted service operating on one or more servers, receives an account creation request from a seller. The account includes initialized financial records for the seller. At step 410, the hosted service receives specification of one or more items to be displayed for sale in a store front for a seller. The specification may include the sale or subscription price of the one or more items. At step 411, responsive to the specification, the hosted service generates a portable widget for the store front identifying the one or more items for sale. At step 412, the hosted service may receive from the seller identification of one or more storage locations for uploading content associated with the one or more items for sale. At step 413, the hosted service receives from the seller identification of one or more third party hosts to which to publish the portable widget of the storefront. At step 415, the hosted service may initiate publishing of the portable widget of the store front to the one or more third party hosts.

At step 400, The seller may register at the OWJO website and create an account with the platform 110. Creation of an account enables a seller to establishes a Storefront. The account creation may be initialized or process by any form or type of request or a series of requests. For example and in one embodiment, a user (seller) may send an email with account creation information, send a HTTP form with field information, or create an account via automated phone service provided by the hosted service.

In further details, at step 400, a hosted service operating on one or more servers, receives an account creation request from a seller. The account includes initialized financial records for the seller. In one embodiment, the hosted service is the OWJO platform. The seller may create an account via the platform web site. The web-site may provide any type and form of user interface to obtain account information from a user/seller or otherwise register the user/seller. Creation of an account enables a seller to establishes a Storefront. The account creation may be initialized or process by any form or type of request or a series of requests. For example and in one embodiment, a user (seller) may send an email with account creation information, send a HTTP form with field information, or create an account via automated phone service provided by the hosted service.

In some embodiments, the web-site provides a wizard for the user/seller to create a Storefront. In some embodiments, the web-site allows the user/seller to customize or personalize the design, construction and/or look and feel of the Storefront. In one embodiment, the web-site provides a user interface for the user/seller to set pricing and establish all financial accounts. In response to the user input, the web-site and/or platform may create the user specified Storefront and initializes financial accounts for the user/seller. Each user, in the capacity as seller or buyer, can have multiple accounts, including financial accounts and storage accounts. Each account may be associated with the same or different information and/or features in connection with the user (e.g., password, subscribed services, and preferences).

Each OWJO user may have one or more financial accounts to track the monetary relationship of a user, seller and/or buyer. In one embodiment, each user has one or more of the following three financial accounts: 1) available account, 2) royalty account and 3) un-cleared account. The available account may comprise the balance of OWJO Credits that the user can use to purchase content. The royalty account may comprise the accumulative balance of royalties generated by the user from content sales. The un-cleared account may comprise funds that are assigned to the user, but 1) have not been received by OWJO Billing or 2) the content refund period has not passed. When a user is created or established in the platform, the one or more financial accounts may be established, the accounts associated and the values initialized for the account. In one embodiment, the financial accounts are initialized without any predetermined initial value, such as zero values. In some embodiments, the available account balance may have a non-zero balance for promotional purposes.

At step 410, the seller populates the Storefront with any type and form of content the seller would like to make available to buyers. In some embodiments, the seller creates items for sale/subscription in the Storefront by uploading content from storage. In other embodiments, the seller identifies or registers items for sale/subscription in the Storefront by pointing to an online storage account of the seller. In other embodiments, the seller identifies or registers products and/or services for sale in the Storefront by adding some combination of descriptors, images and other representations of the products and/or services. In configuring or setting up any of these items for sale/subscription, in some embodiments, the seller indicates the terms and conditions of the sale/subscription, by establishing one or more of: the price they want to sell their content, whether or not to have subscriptions, which content protection method to use, whether or not to have the content DRM protected, and what type and form of DRM protection to use.

In further details of step 410, the hosted service receives specification of one or more items to be displayed for sale in a store front for a seller. The specification may include the sale or subscription price of the one or more items. The hosted service may receive the specification by the seller of digital content for the one or more items to be displayed for sale in the storefront. The hosted service may receive the specification by the seller of physical items for the one or more items to be displayed for sale in the storefront. The hosted service may also receive the specification by the seller of one of different prices or different currencies for the one or more items.

The seller may provide the specification including the number, type, description, size, format and other information of the one or more items for sale. The seller may provide specification of one or more services required to support the display, promotion and/or sale of the one or more items. For example and in one embodiment, the seller may specify that credit card and giftcard payment methods are needed. In another embodiment, the seller may specify that items for sale include one or more of: physical products, digital content and services. The specification may affect the type and form of storefront for the seller, which may in turn affect the type, form and available selection of portable widgets and/of storefront templates. The host service may request (e.g., with detailed instructions, or via a HTTP/HTTPS form) the seller to send the specification responsive to the account setup.

At step 411, responsive to the specification, the hosted service generates a portable widget for the store front identifying the one or more items for sale. In one embodiment, the hosted service assembles, generates or otherwise provides one or more storefront templates to the seller. If more than one template is available, the seller may select at least one template to use as a storefront. In some embodiments, the seller may customize or populate the selected template. The hosted service may generate a widget for the storefront or the storefront template. In one embodiment, the storefront template may be part of the widget. In another embodiment, the widget may be part of the template. In still another embodiment, the widget and template is a single component. The widget may be populated, configured and/or customized before publishing to a website or other web component. The template and/or widget may be generated or provided based on features and/or items specified in the specification. The hosted service may generate the widget to the seller for preview and selection or customization.

At step 412, the hosted service may receive from the seller identification of one or more storage locations for uploading content associated with the one or more items for sale. The hosted service may request (e.g., with detailed instructions, or via a HTTP/HTTPS form) the seller to send the identification responsive to one or more of: the account setup, generation of the widget, and provision of the one or more storefront templates and/or widgets. In some embodiments, the seller may provide and send an identification of the one or more storage locations by accessing or logging into the storage locations via the hosted service. The one or more storage locations or services may include any of the storage locations or services described above in connection with FIGS. 1A and 1C.

The seller may identify one or more storage locations or services with information represented in any type or form of list, table or document. The seller may provide any type or form of identification for the one or more storage locations or services, including domain name, URL, username, security keys/codes/certificates, and authorization/authentication information, for example to access a storage site associated with the seller. The seller may provide the identification via any type or form of communications with the OWJO platform or hosted service, that may be the same or substantially the same as the methods of communicating the specification to the hosted service described above in connection with step 410.

In some embodiments, the seller identifies the one or more storage locations or services from which files and/or information other than content can be uploaded. For example, these storage locations may include access information for accessing the third party hosted services (e.g., for publishing the storefront widget.). In another embodiment, these storage locations may store and provide customization skins and images for a seller's storefront widget. Any form or type of files and/or information may be uploaded, including detailed descriptions of items for sale, trailers and preview segments of content.

At step 413, the hosted service receives from the seller identification of one or more third party hosts to which to publish the portable widget of the storefront. In some embodiments, a publishing user interface of the hosted service receives from the seller identification of the one or more third party hosts to which to publish the portable widget of the store front. The seller may identify one or more web sites or web pages to publish the widget. The seller may identify one or more web sites or web pages with information represented in any type or form of list, table or document. Third party hosts may include any of the web sites and web pages described above in connection with FIGS. 1A, 3G and 8B. The host service may request (e.g., with detailed instructions, or via a HTTP/HTTPS form) the seller to send the identification responsive to one or more of: the account setup, generation of the widget, and provision of the one or more storefront templates and/or widgets.

A partially functional version of the widget may be published at a web page associated with the seller for preview and or testing. The seller may provide any type or form of identification of the one or more third party hosts, including domain name, URL, username, security keys/codes/certificates, and authorization/authentication information, for example to access web pages associated with the seller. In some embodiments, the seller may provide and send an identification of the one or more third party hosts by accessing or logging into these third party hosts via the hosted service. The seller may provide the identification via any type or form of communications with the OWJO platform or hosted service, that may be the same or substantially the same as the methods of communicating the specification to the hosted service described above in connection with steps 410 and 412.

At step 415, the hosted service may initiate publishing of the portable widget of the store front to the one or more third party hosts. A seller may initiate publishing of the portable widget via a publishing user interface of the OWJO hosted service or platform. Any of the operations related to publishing a storefront widget may be perform by or via the publishing user interface. In one embodiment, the seller publishes the seller's populated Storefront (i.e., Storefront widget) to one or more web-sites to have the content available and viewable by buyers. Responsive to receiving the identification of the one or more third party hosts, the host service may publish the portable widget to the identified one or more third party hosts. The host service may transmit, publish, install, or otherwise generate a presence on the identified third party hosts. This presence may include one or more storefront widgets and/or links to the OWJO website. In some embodiments, a storefront widget or component may be downloaded to a user device, such as a mobile device or a blu ray player. The storefront widget or component may execute on the device. In one embodiment, the Storefront executing on a blu ray player may be referred as a Blu-Ray Store. The functionalities and features provided by storefront widget/component executing on a device may be the same or substantially similar to published storefront widgets and/or storefronts provided at the OWJO web site.

The host service may publish the portable widget to any of the identified web sites and web pages described above in connection with FIGS. 1A, 3G and 8B. In some embodiments, the seller publishes the seller's Storefront to a choice of a plurality of social networking sites. In other embodiments, the seller publishes the seller's Storefront to a blogging site. In another embodiment, the seller publishes the seller's Storefront to their own web site or web-sites owned or operated by the seller. In other embodiments, the Storefront may be published in any type and form of website. The Storefront widget may be embedded in any component of a website or webpage. In some embodiments, the seller publishes the seller's Storefront to a plurality of different web-sites to increase the availability and access to their content for sale.

In some embodiments, the host service installs or attaches the widget into a section or component of an identified website or webpage. For example and in one embodiment, the widget may be installed in the profile page of an artist who is selling the artist's work. In another embodiment, the widget may be installed in an advertising space or widget on the identified website or webpage. In some embodiments, the widget may be published in conjunction with advertisements in the identified website or webpage. The host service may automatically publish the widget, and may periodically update the widget, for example, when new features are added.

The hosted service may automatically generate and/or automatically update the store front responsive to a feed from a third party system. In some embodiments, a widget is published only upon an event, for example, when a potential consumer clicks on an advertisement, hyperlink or related item/product/topic, or performs a search. The hosted service may also communicate or publish the portable widget of the store front to a third party host of the one or more third party hosts. In some embodiments, the hosted service may notify the seller and a buyer of a status of fulfillment of physical items, content and services purchased by the buyer from the store front.

In one embodiment, the hosted service receives from the portable widget of the store front published on a third party host information from a buyer to complete a purchase of one or more items selected from the storefront. The portable widget, in communication with the hosted service, may complete the purchase of the selected one or more items without the buyer traversing away from the store front displayed on the third party host. The hosted service can determine a share of revenue from sales of the one or more items from the storefront between the hosted service, the seller and the one or more third party hosts.

Although described generally in terms of interactions between the seller and the hosted service (OWJO platform), a seller may communicate any type or form of information, files or data to the hosted service via one or both of a user interface of the hosted service and a publishing user interface of the hosted service. Both interfaces may be provided by one or more webpages and/or application windows provided by the hosted service. In some embodiments, the publishing user interface handles operations related to publication of a storefront widget. In some embodiments, the user interface may handle account setup and/or operations related to configuring the storefront widget.

### Section D—Using the Storefront by a Buyer.

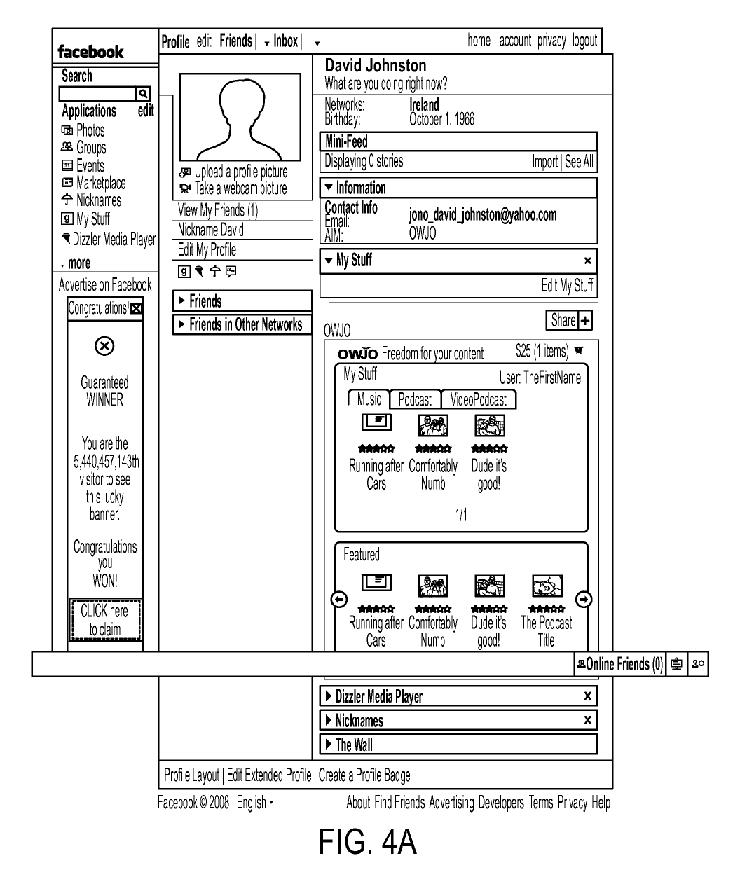

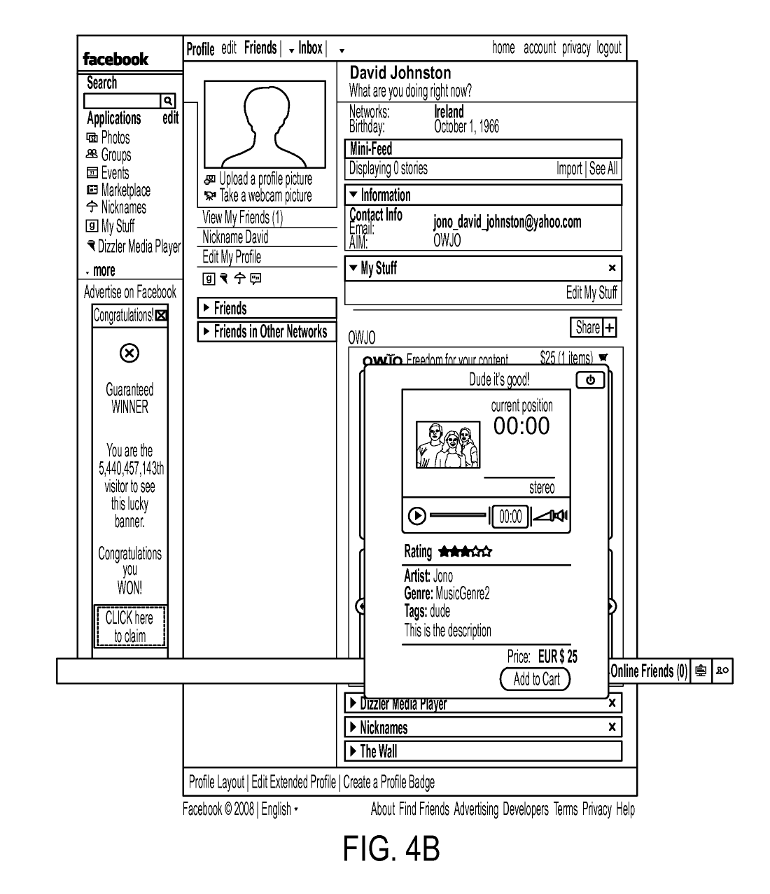

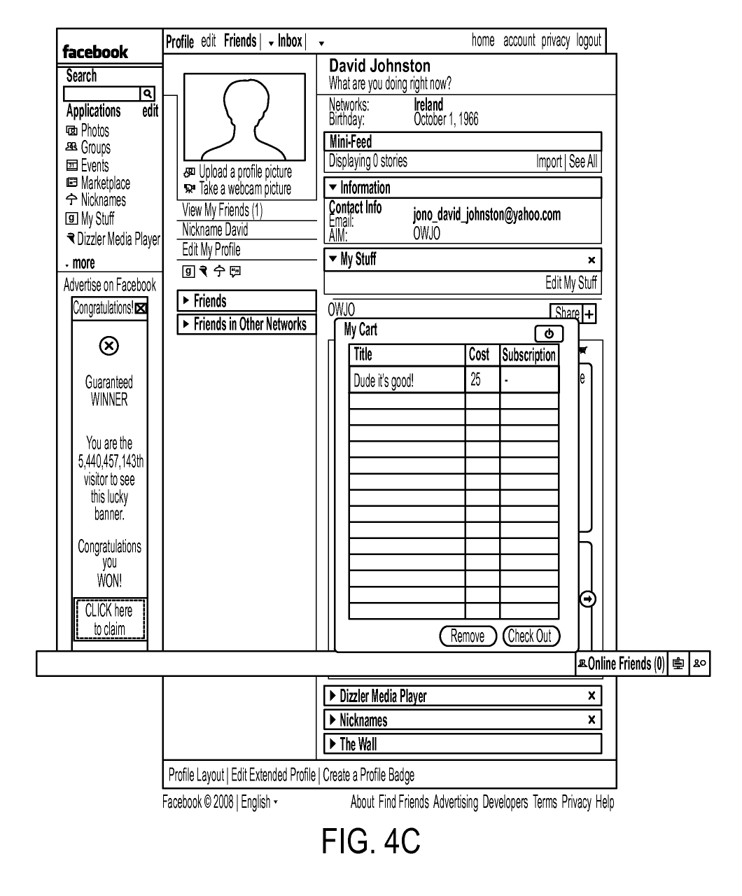

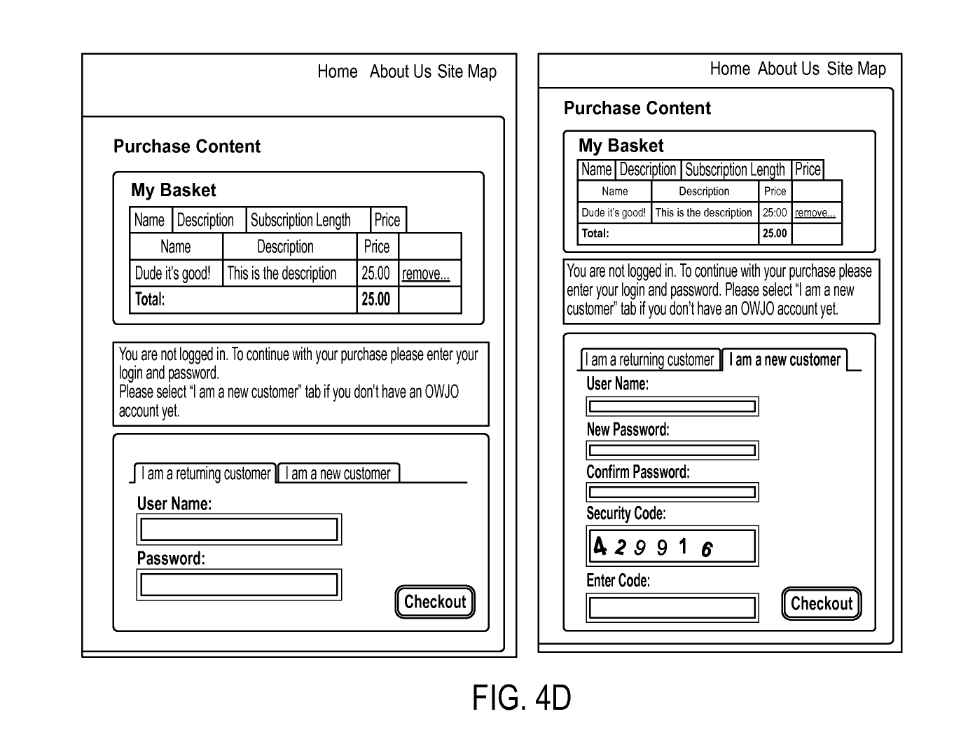

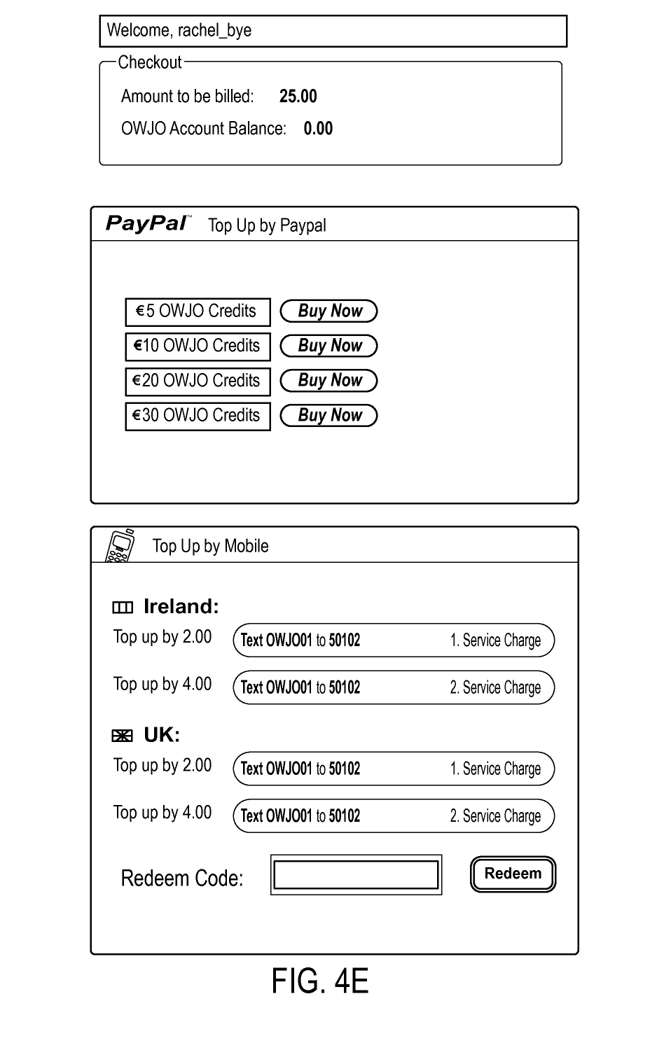

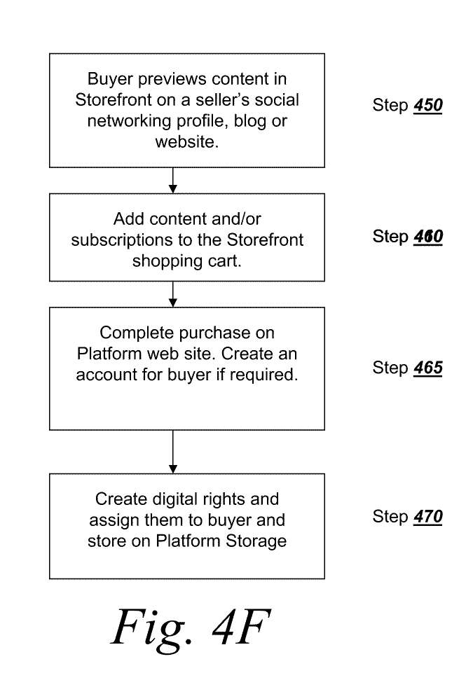

FIG. 4A is an embodiment of the user interface of the OWJO Storefront running in Facebook on the social networking profile webpage of the seller. Even though we are showing Facebook in the diagram, the OWJO Storefront can be published to any social networking site, blogging sites and/or any HTML based web site. A buyer can see the OWJO Storefront of the seller by visiting the seller's social networking page or otherwise to any site to which the Storefront is published.

FIG. 4B is an embodiment of the user interface of the OWJO Storefront to preview content. In FIG. 4B, the buyer has selected a music track to preview. If the buyer likes the music track, then the buyer can place the music track in the buyer's shopping cart for purchase.

FIG. 4C is an embodiment of the user interface of the OWJO Storefront to add content to a shopping cart. The buyer can view the buyer's shopping cart and decide to remove items, or purchase items by proceeding to a checkout.

FIG. 4D, in some embodiments, depicts an user interface of the OWJO web site to purchase content. The buyer may decide to purchase content and may be transferred by the web browser to the OWJO web site. In one embodiment, the buyer clicks on a link (e.g., hyperlinked text, button, image or other component of the Storefront widget, the link redirecting the buyer to the OWJO web site. In other embodiments, FIG. 4D depicts an user interface of the OWJO Storefront to purchase content. In one of these embodiments, the buyer activates the Storefront widget (via a mouse click or otherwise) to display the user interface of the Storefront on the webpage in which the Storefront is published/embedded.

In the above embodiments, the buyer can view the contents of their shopping cart (My Basket) and/or remove previously added items. In addition, FIG. 4D shows what happens if the seller clicks the “I am a returning customer” tab and also what happens if the seller clicks the “I am a new customer” tab. If the seller is a returning customer and already has an existing OWJO account, they may be prompted to sign in and/or provide additional information. For example, the buyer can supply their OWJO User Name and Password. If the buyer is a new customer, the buyer can create a new OWJO account by providing one or more of the buyer's 1) user name, 2) password, 3) password verification and 4) security code.

FIG. 4E is an embodiment of the user interface of the OWJO web site or Storefront to purchase content using PayPal and/or Mobile payment methods. A buyer can use PayPal by clicking on one of the PayPal buttons, icons or links displayed on this user interface. A buyer can also use the buyer's mobile phone/device to make a payment by sending a text message using the Short Messaging Service and/or Multimedia Messaging Service of their mobile phone or device. The buyer may receive a redeem code after sending a message to the specified OWJO short code that may be displayed for their country. Each of the redeem code and the short code may include any string of alphanumeric and/or non-alphanumeric characters. After entering the redeem code and clicking the redeem button the buyer may be credited with the appropriate number of OWJO Credits. In some embodiments, the buyer's mobile phone bill is charged for the OWJO Credits purchased. In other embodiments, the buyer's mobile phone is linked to a source of fund, such as a credit card or a bank account. A purchase via the buyer's mobile phone may be transacted using this linked source of fund.

OWJO Credits may be utilized via a Storefront or the OWJO web site to purchase an item or subscription. A number of OWJO Credits may be purchased using any currency. OWJO Credits may be set at a fixed price with respect to any one currency, or may be cheaper when purchased in larger amounts. OWJO Credits may also be issued as a bonus to certain buyers, for example, in relation to customer loyalty programs or special promotion events. OWJO credits in a buyer's account may be replenished automatically (e.g., via credit card to maintain a minimum threshold in the account), or as directed by the buyer.

FIG. 4F is a flow diagram of an embodiment of a method of using the OWJO Storefront by a buyer. In brief overview, at step 450, the buyer visits a web-site having the Storefront and previews content for sale. At step 460, the buyer selects one or more items of content of the seller desired for purchase. At step 465, the buyer purchases the content via the Storefront. At step 470, the platform generates digital rights for the purchased content of the buyer.

In further details, at step 450, the buyer previews content on the seller's Storefront, which may be published on a seller's social networking site, blog or any HTML web site. The buyer can use media controls, for example as displayed on FIG. 4B, on the OWJO Storefront to play, rewind, fast-forward, pause and stop media content. The buyer can navigate through the OWJO Storefront by clicking on the left and right arrow buttons that appear in the OWJO Storefront. The buyer can change the volume of the audio playback by adjusting the volume control as displayed on FIG. 4B. The previews may include any type or form of trailer, teaser, portion of the content, commentary, endorsements, and/or reviews related to the content and/or artist. The buyer may preview the content in connection with checking comments and/or ratings left by other buyers of the content. In some embodiments, the preview is streamed to the Storefront. In other embodiments, the preview can be downloaded to a potential buyer's device.

At step 460, the buyer can decide to purchase content by clicking on the “Add to Cart” button on FIG. 4B. The item displayed in the OWJO Storefront may be added to the user's shopping cart, for example, responsive to clicking on the “Add to Cart” button. The buyer can view the contents of the buyer's shopping cart at any time by clicking the shopping cart icon or link displayed, for example, on the top right of the OWJO Storefront.

At step 465, the buyer is directed to the OWJO web site to complete payment after they click on the “Check Out” button on the OWJO Storefront. The buyer can use any one of a multiple payment forms, such as PayPal or use their mobile phone to purchase OWJO Credits. The available (purchased) OWJO Credits are deducted based on the payment for the item(s) in the shopping cart. If there are insufficient OWJO Credits, the buyer may be alerted (e.g., provided the option to purchased additional OWJO credits) and the transaction put on hold. In some embodiments where the transaction or purchase was not completed, the item(s) may remain persistent in the buyer's shopping cart for a specified duration of time.

At step 470, digital rights are created for the buyer and assigned to the buyer by the seller via the platform. Digital Rights to purchases/subscribed content are granted, generated, issued, or otherwise provided upon completion of a purchase/subscription for the content. The platform may create the digital rights in accordance with the type and form of DRM management identified or selected by the seller. The digital rights may be identified, created or provisioned using or based on any type and form of DRM scheme. The platform stores the digital rights of the buyer in association with the seller and the seller's content in any location available via OWJO Storage. The buyer may access the buyer's digital rights via access to the OWJO Storage or web site through authorization/authentication. The buyer may also receive and store a copy of the digital rights in a device operated by the buyer. The buyer may use the digital rights to stream, download, or otherwise access the purchased/subscribed content.

### Section E—The OWJO Dashboard for Both Buyers and Sellers.

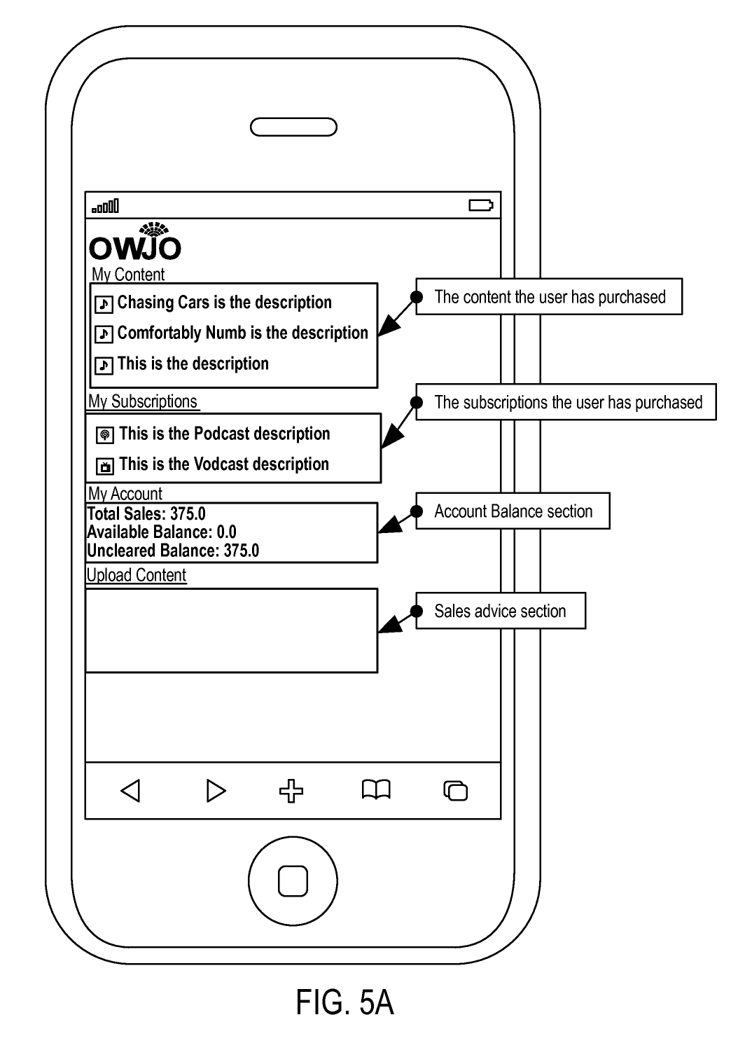

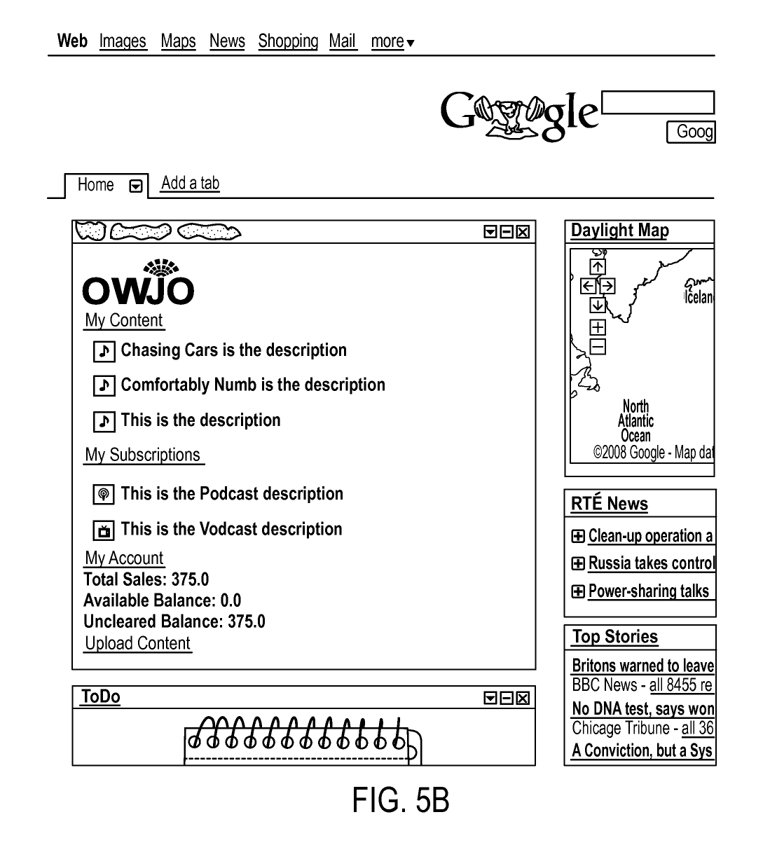

FIG. 5A is a block diagram of an embodiment of an OWJO Dashboard executing on a client device, for example, an iPhone. As illustrated in FIG. 5A, the OWJO Dashboard can have a number of sections for the buyer to access and interact with the platform:
Inbox of user's content. The OWJO Dashboard displays content that the user has purchased or subscribed to. In some embodiments, the OWJO Dashboard displays content that has not been played or downloaded by the user.
My Content section: This section shows the content that the user has digital rights to.
My Subscriptions section: This section displays the subscriptions that the user has subscribed to. By way of illustration and in one embodiment, the user can drag subscription icons to an iTunes desktop PC application to play purchased/subscribed content on iTunes and synchronize to an iPod.
Account section: This section can show the user's current OWJO credit balance. If the OWJO user is also selling content then the user's accumulated royalty balance can be shown upon request by the user.

FIG. 5B is a block diagram of an embodiment of an OWJO Dashboard executing on iGoogle. Although the illustrative embodiment is shown with iGoogle, the Dashboard, as well as the Storefront or client agent may be deployed in one or more of a plurality of environments, applications, web-sites, devices and operating systems.

### Section F—Using the OWJO Web Site by a Seller.

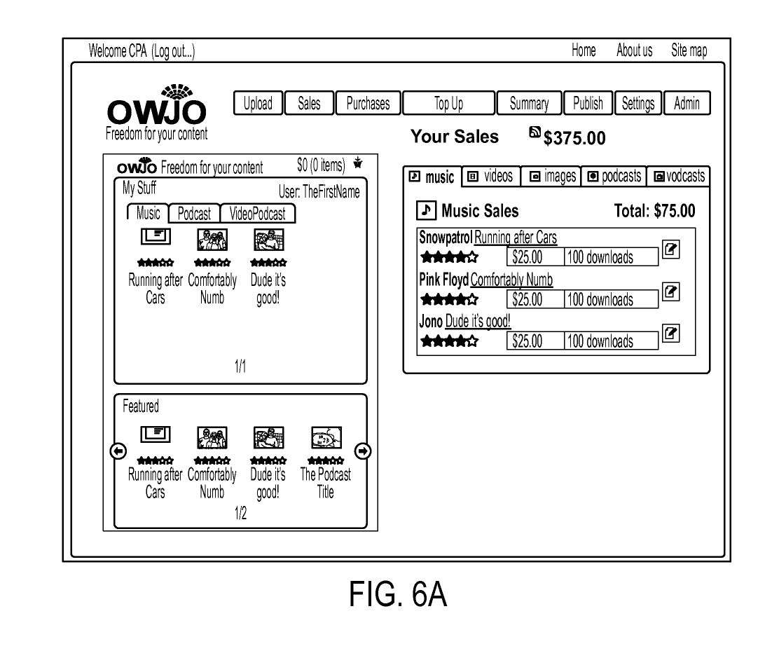

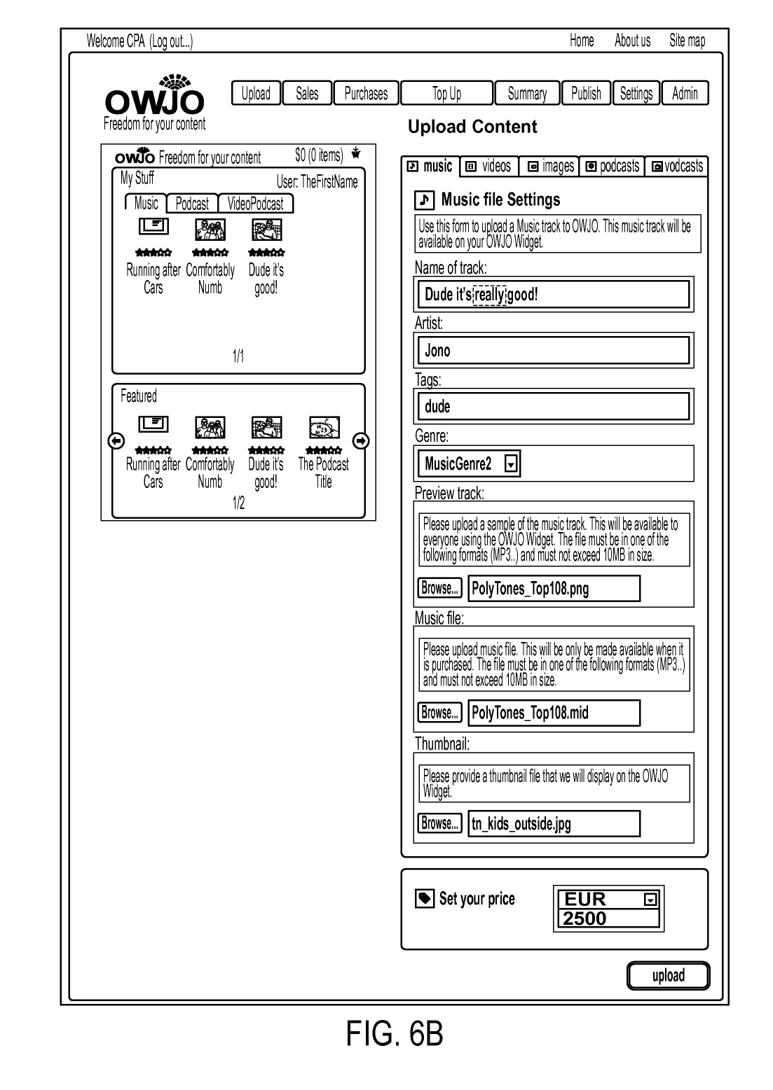

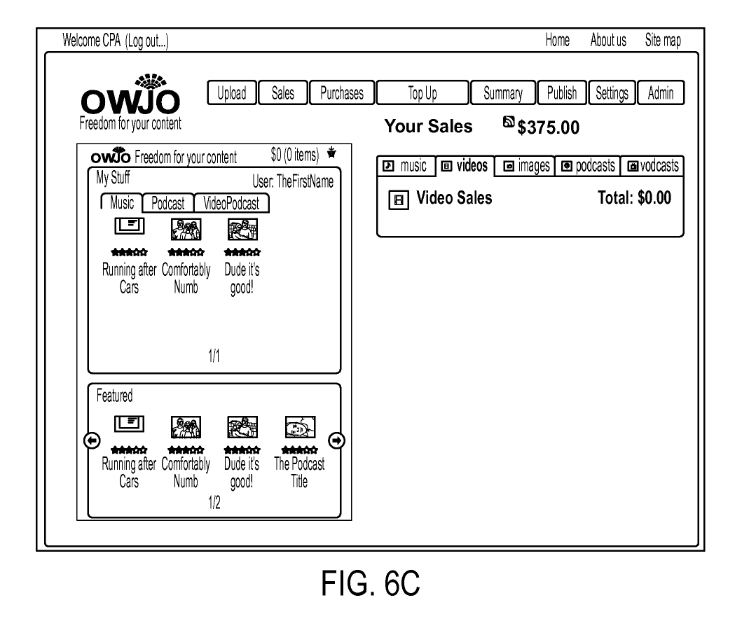

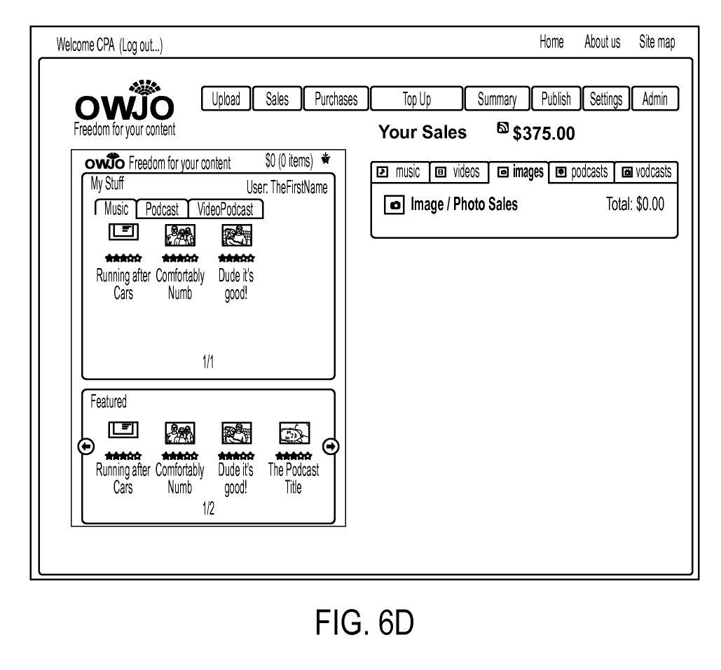

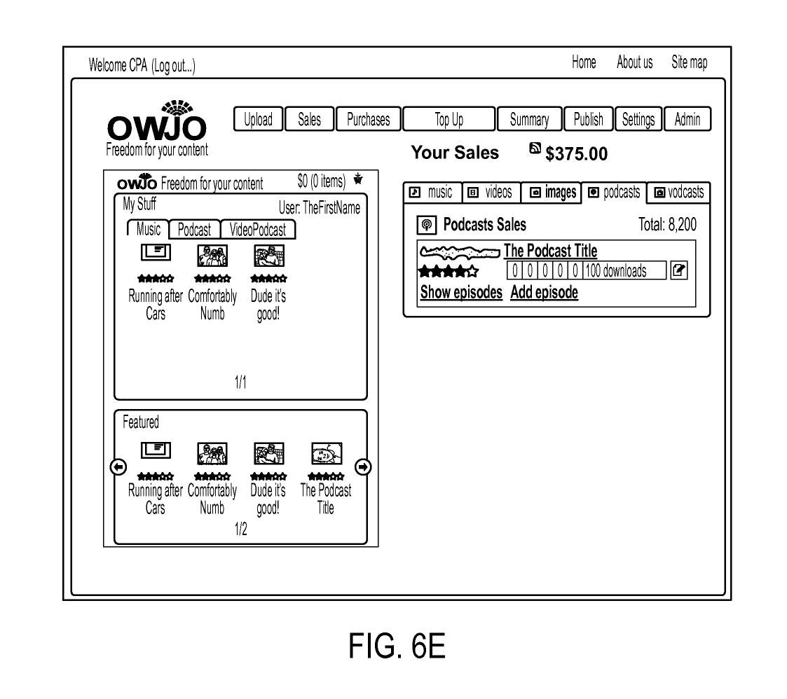

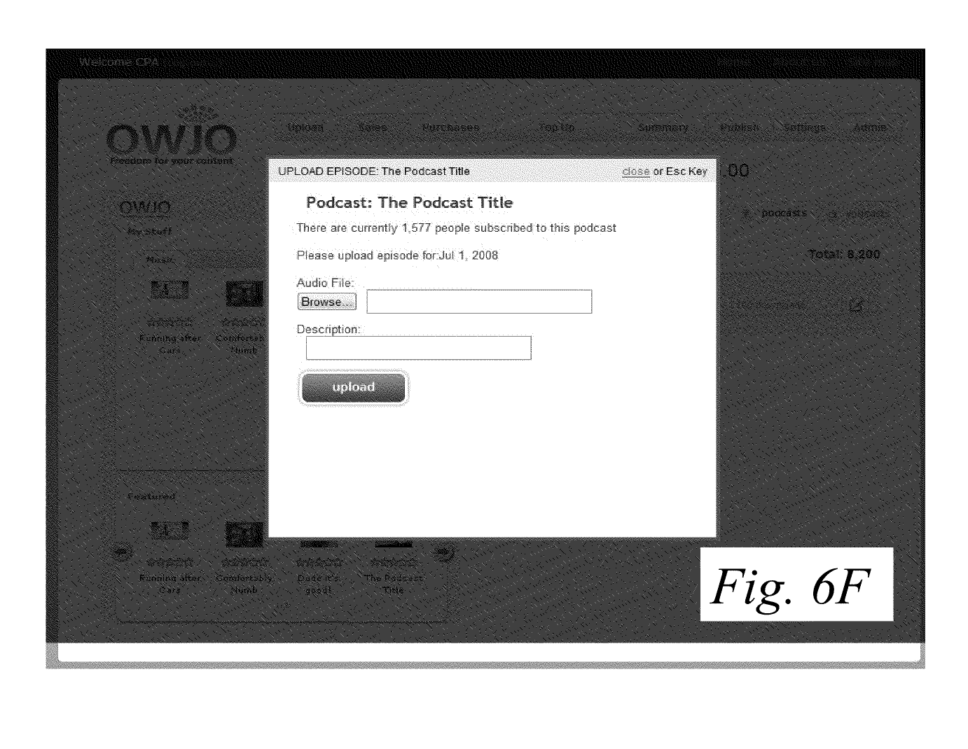

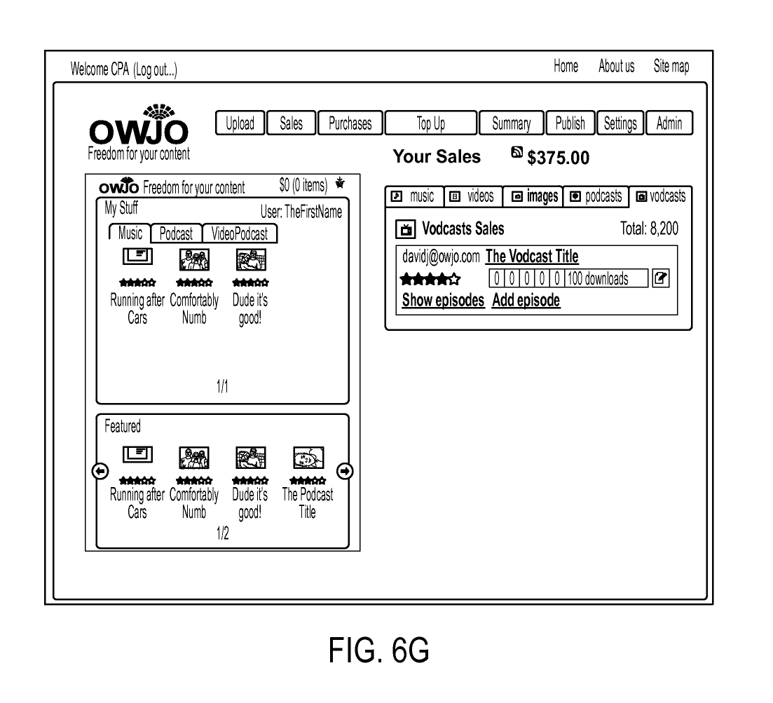

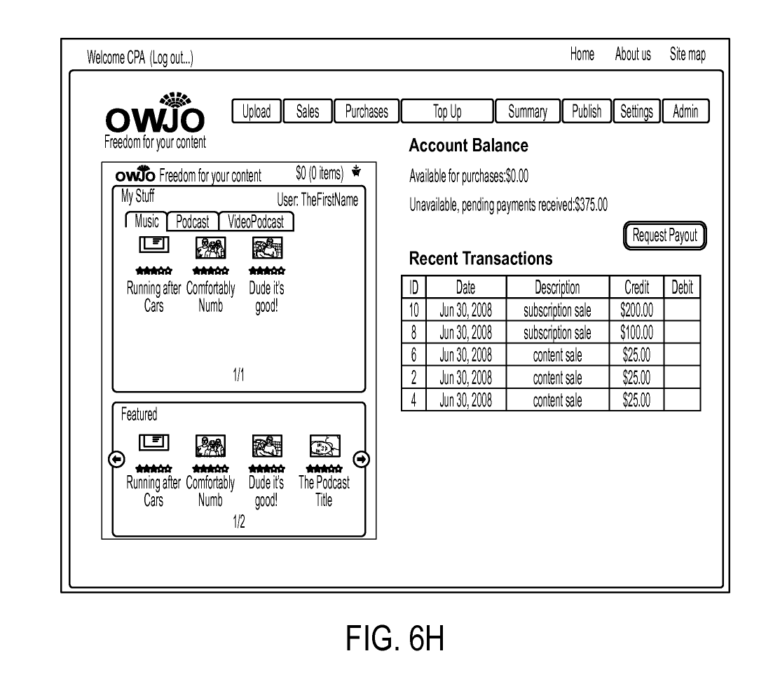

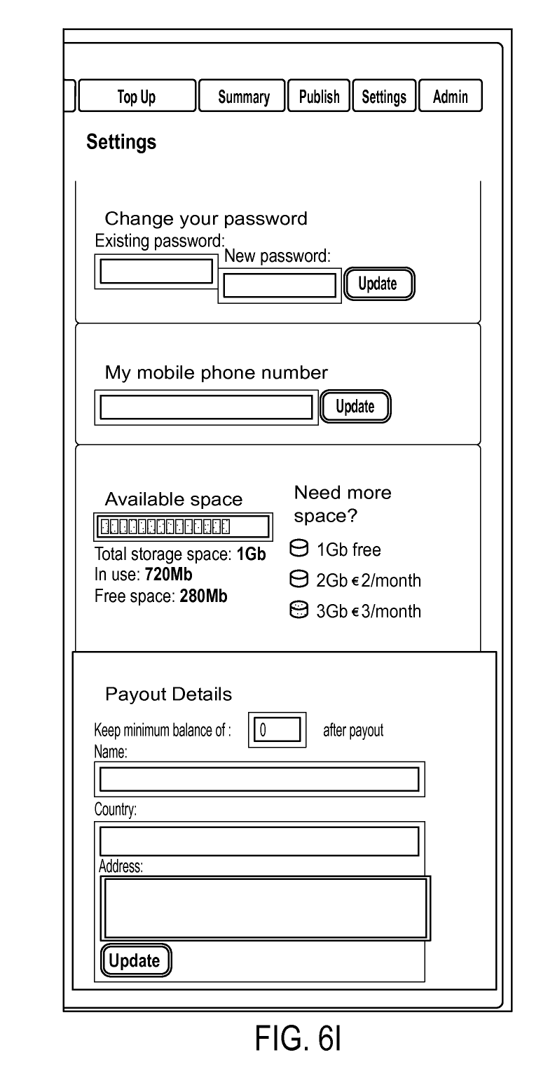

FIG. 6A depicts an embodiment of the OWJO web site to view sales of content (e.g., music tracks) by a seller. The OWJO platform provides a user interface via the OWJO web site. In some embodiments, the user interface provides a means of self-service by a user to establish an online storefront in one or more third-party hosted services. Using a web browser such as Internet Explorer, Mozilla Firefox or Apache Safari, a seller can also access the OWJO web site to view how the sales of a music track provided by the seller are progressing.

In one embodiment, the OWJO website can (as depicted in FIG. 6A) show the total sales that have been generated by music track sales. The sales generated by individual music tracks can also be displayed. videos, images, podcasts and vodcasts are progressing. The seller can also view how the sales of products and/or services are progressing. The OWJO Storefront is displayed, for example on the left side of the screen, so that the seller knows what their OWJO Storefront looks like when published in a website. In some embodiments, the Storefront is the same or substantially the same when published in different web sites. In other embodiments, the Storefront is adapted to the characteristics and/or restrictions of particular web sites. In one embodiment, a buyer activates Storefront functions (e.g., for purchasing content) without leaving the web site in which the Storefront is published. In another embodiment, the buyer is redirected to the OWJO web site when the buyer activates or selects the Storefront widget.

FIG. 6B is a block diagram of an embodiment of the OWJO web site to edit a music track by a seller. In FIG. 6A, a seller can select a music track and modify the music track as displayed in FIG. 6B. The seller can modify one or more of: 1) the name of the track, 2) the artist, 3) one or more tags in the form of a keyword or term associated with the music track, 4) the music genre, 5) a preview of the music track, 6) the actual music track that is for sale, 7) a thumbnail image that may be displayed in the OWJO Storefront and 8) the price that the user would like to sell the user's music track for. The music track preview, actual music track and/or thumbnail can either be uploaded from the machine that is executing the web browser the seller is operating, or loaded from a Uniform Resource Identifier, a ftp site, via email, or from anywhere on the internet. The seller has an option of indicating that the track is advertiser supported and free to the buyer. When the buyer receives an advertiser-supported track an advertisement may be pre-pended, appended, or otherwise embedded in the music track.

Although FIGS. 6A and 6B are generally directed to interactions with the platform regarding content in the form of music, the seller, the web-site and any user interfaces of the client, Storefront or Dashboard may be designed and constructed for any type and form of content or media, including but not limited to products, services, video, podcasts, and images, for example as depicted in FIGS. 6C, 6D and 6E.

FIG. 6F shows an embodiment of a user interface that the seller can use when adding an episode to an existing Podcast. Using a web browser such as Internet Explorer, Mozilla Firefox or Apache Safari, a seller can access the OWJO web site and upload an episode for an existing Podcast. The seller can use content from the machine executing the web browser, or load the content from a Uniform Resource Identifier, a ftp site, via email, or from anywhere on the Internet. Any episodes uploaded are immediately made available to some or all the subscribers of this Podcast.

In FIG. 6H, using a web browser such as Internet Explorer, Mozilla Firefox or Apache Safari, a seller can access the OWJO web site and view the financial transactions that have been executed on the seller's account. The seller can view the seller's current accumulated royalty balance in terms of available and unavailable funds. Available funds are funds that are available to the seller immediately, for example, for transfer to a bank account or may be redeemed in a check generated/processed by the OWJO platform. Unavailable funds are royalty payments that have been assigned to the seller, but, have not been fully cleared by OWJO Billing 158 system. In some embodiments, some royalty payments may not have been cleared pending processing by Paypal. The seller can click the “Request Payout” button in order to indicate to the Payout processing Service 150 that the seller would like to receive a check for the value of their accumulated available royalty balance. FIG. 6I shows the destination postal address specified by the seller where the royalty payment check will be posted.

In some embodiments, the seller's accumulated royalty payments may be presented in terms of OWJO credits, one or more currencies, or a preferred currency (after currency conversion). In one embodiment, some uncleared payments (royalty payment and/or revenue sharing proceeds) may be presented as OWJO credits. Payments may be uncleared, i.e., pending completion of payment processing by OWJO Billing and/or third-party payment services. Once such a payment is cleared (either by OWJO Billing and/or third-party payment service), the associated OWJO Credits may be converted and the value presented in one or more currencies.

In FIG. 6I, using a web browser such as Internet Explorer, Mozilla Firefox or Apache Safari, a seller can access the OWJO web site and modify the seller's account settings. The seller can change one or more of: the seller's 1) access password, 2) mobile number, 3) storage requirements and 4) payout details.

### Section G—Using the OWJO Web Site by a Buyer

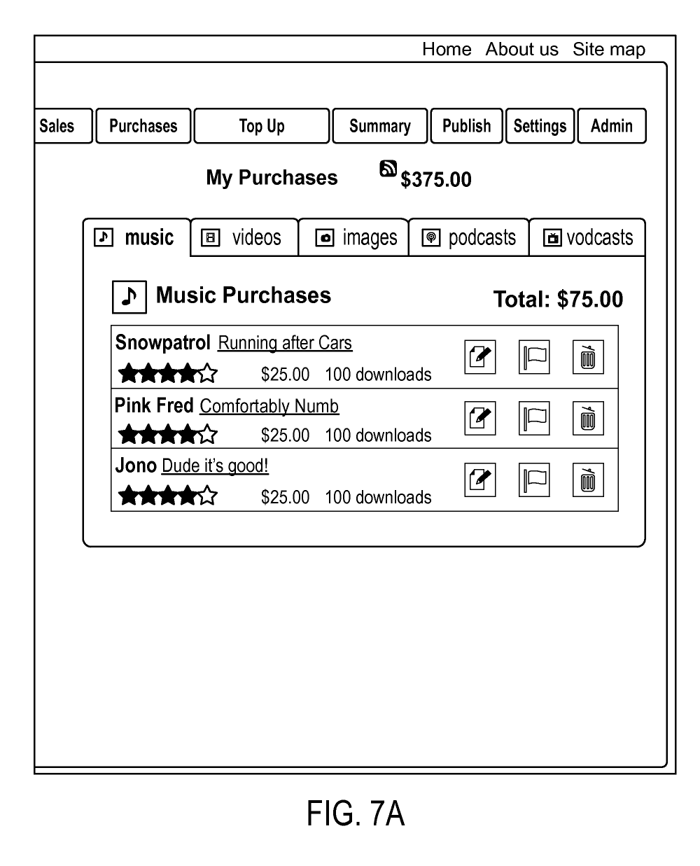

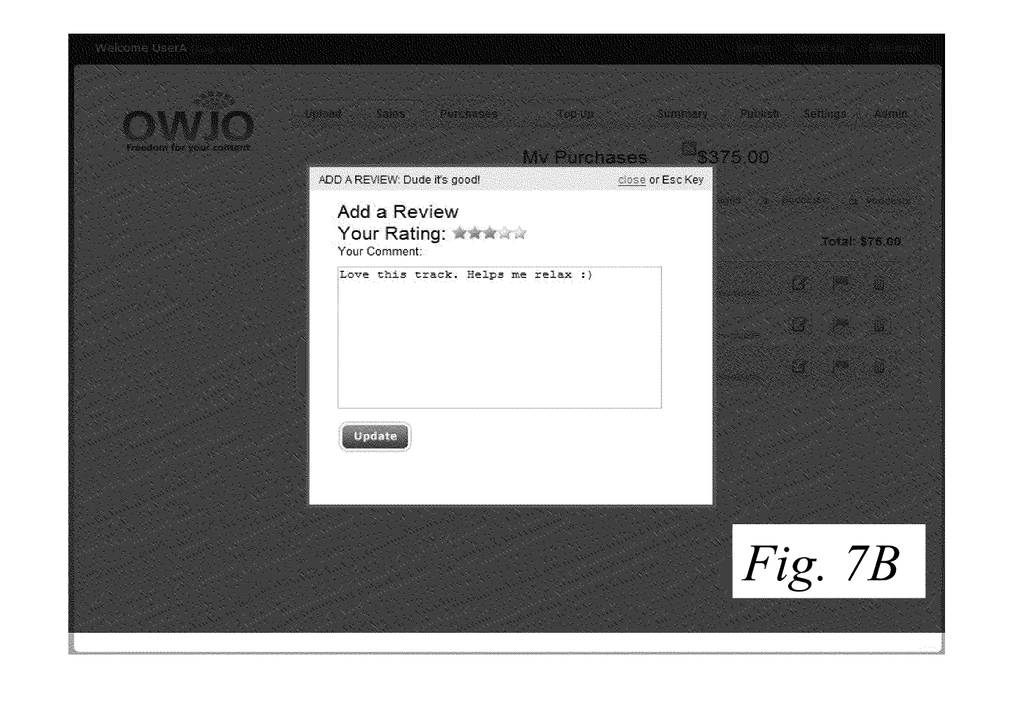

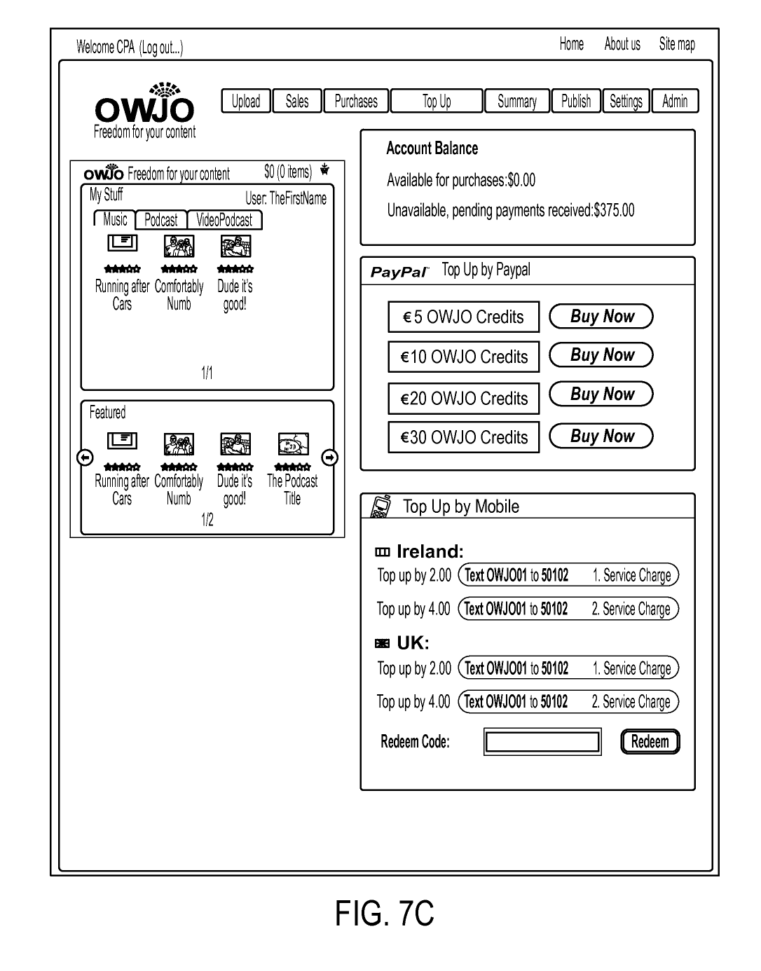

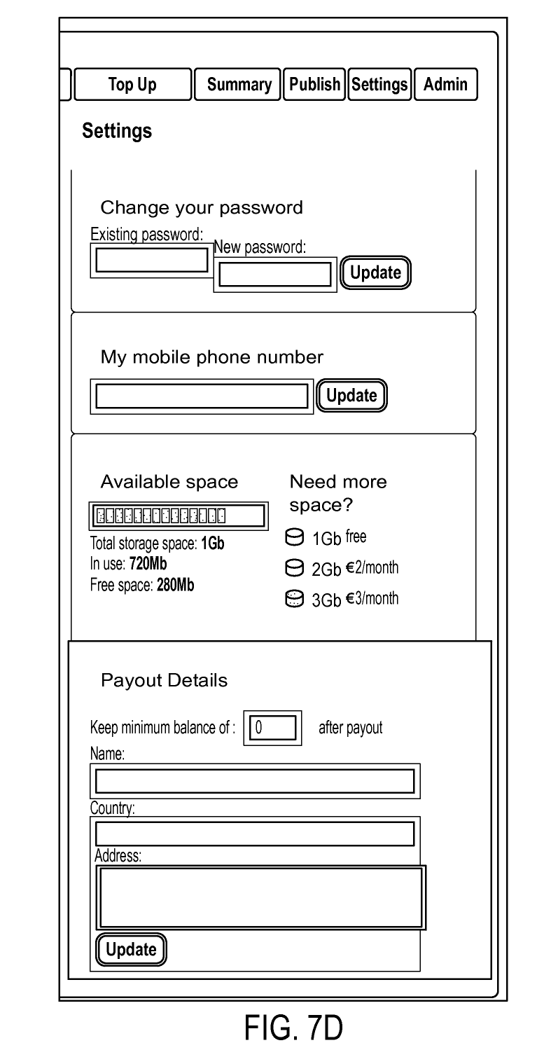

In FIG. 7A, using a web browser such as Internet Explorer, Mozilla Firefox or Apache Safari, a buyer can access the OWJO web site and view the music purchases that the buyer have made. The total amount of OWJO credits and/or money (in any specified currency) spent on music purchases may be presented to the buyer/user on request. A buyer may play, stream or download any purchased content. A buyer can also remove or delete content, or cancel a subscription to content they have purchased.

In FIG. 7B, using a web browser such as Internet Explorer, Mozilla Firefox or Apache Safari a buyer can access the OWJO web site and rate content. In some embodiments, the buyer indicates the quality of content by choosing from, for example, 1 to 5 stars although any type and form of rating scale may be used. In one embodiment, the higher the number of stars (or any other representations of ratings) associated with the rating of the content, the better the quality of the content. The buyer can also enter one or more comments and/or reviews that can be viewed (e.g., as feedback) by other buyers and the content seller.

In FIG. 7C, using a web browser such as Internet Explorer, Mozilla Firefox or Apache Safari, a buyer can access the OWJO web site to view the buyer's current OWJO Credit balance. The buyer can use the web page (an embodiment displayed in FIG. 7C) to modify or increase the buyer's OWJO Credit balance. A buyer can use any type and form of payments to purchase credits. For example, the buyer may use PayPal to purchase additional OWJO Credits by clicking on one of the PayPal buttons or links on the OWJO web site. In some embodiments, a buyer can also use the buyer's mobile phone to purchase additional OWJO Credits, for example by sending a text message using the Short Messaging Service or Multimedia Messaging Service of the buyer's mobile phone. The buyer may receive a redeem code after sending a message to the specified OWJO short code that will be displayed for their country. After entering the redeem code and clicking the redeem button the buyer can be credited with the appropriate number of OWJO Credits. The buyer's mobile phone bill can be charged for the OWJO Credits purchased.

In FIG. 7C, using a web browser such as Internet Explorer, Mozilla Firefox or Apache Safari, a buyer can access the OWJO web site to input or change one or more of the buyer's: 1) access password, 2) mobile number, 3) storage requirements and 4) payout details.

Section H—Sales and Marketing Integration with Other Web-Sites.

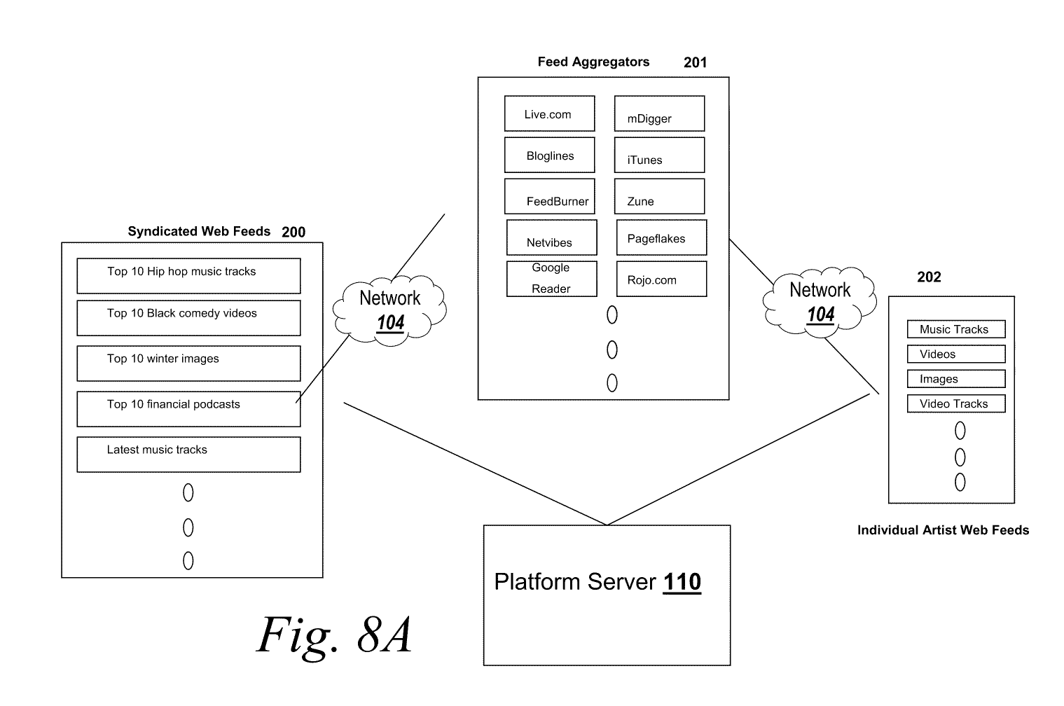

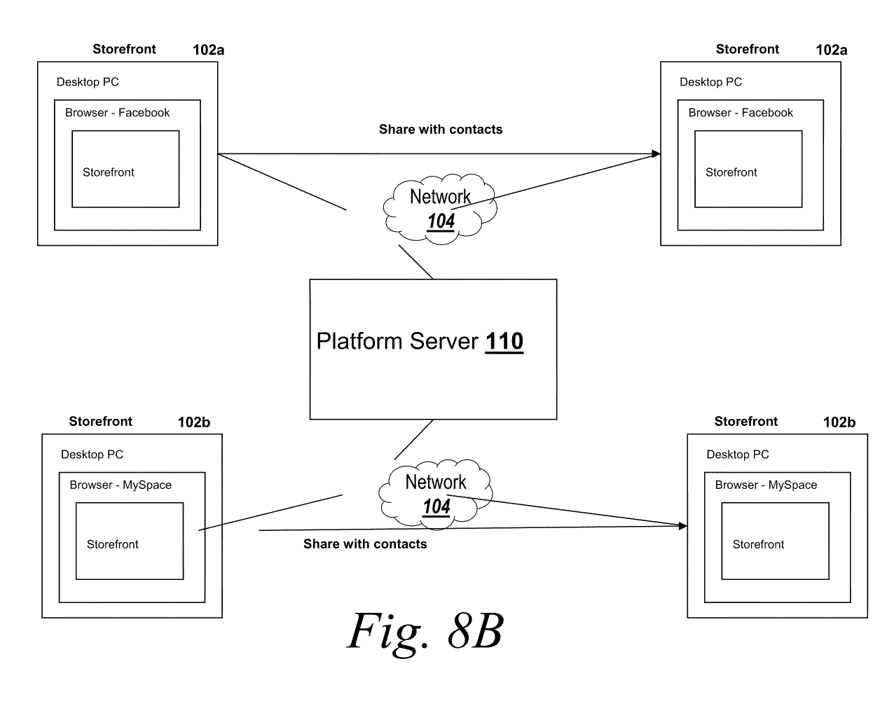

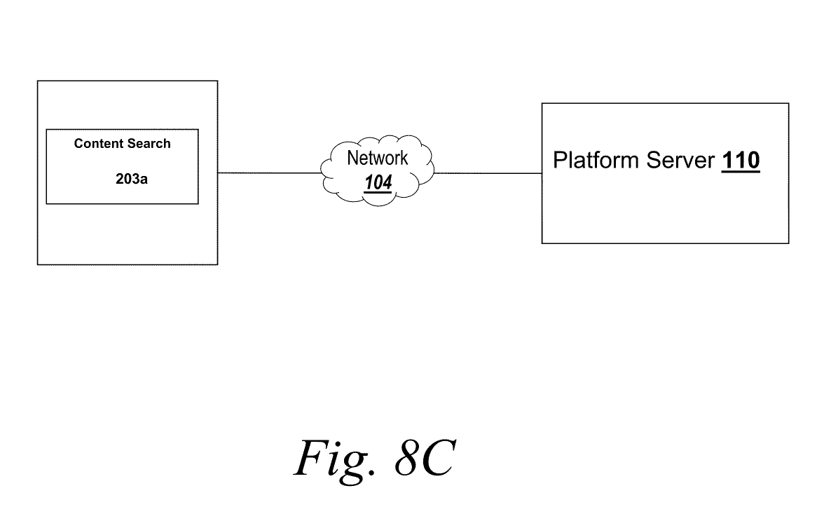

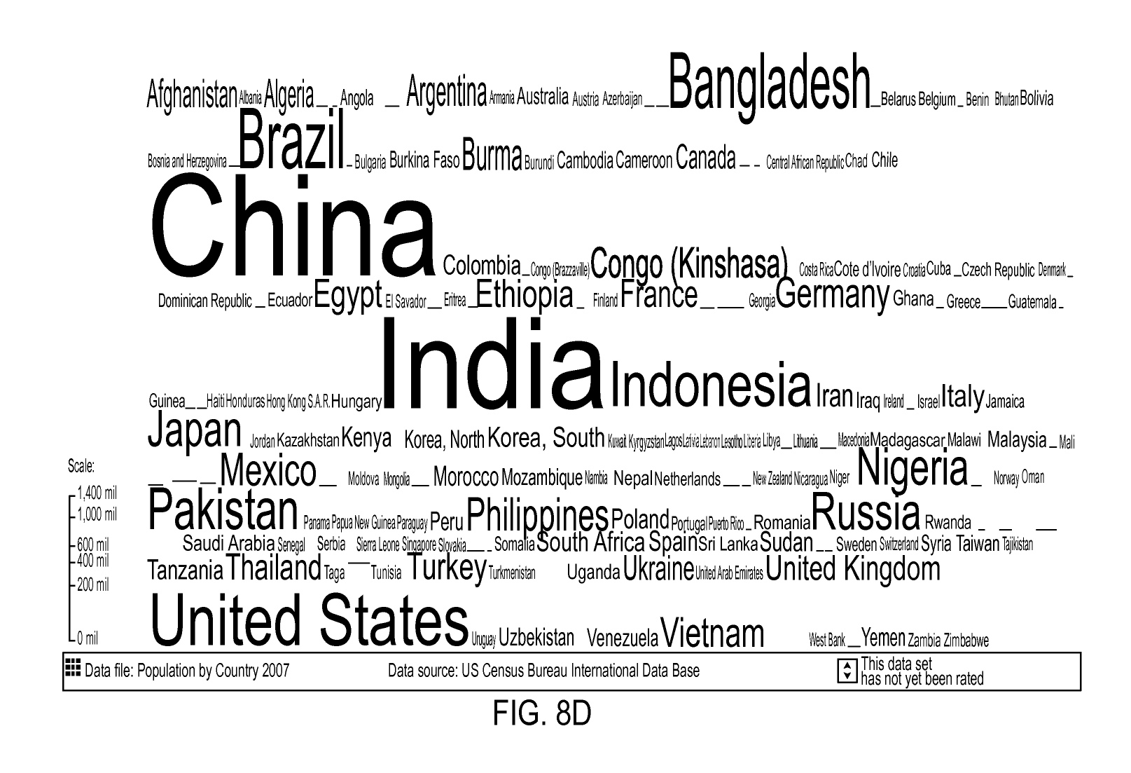

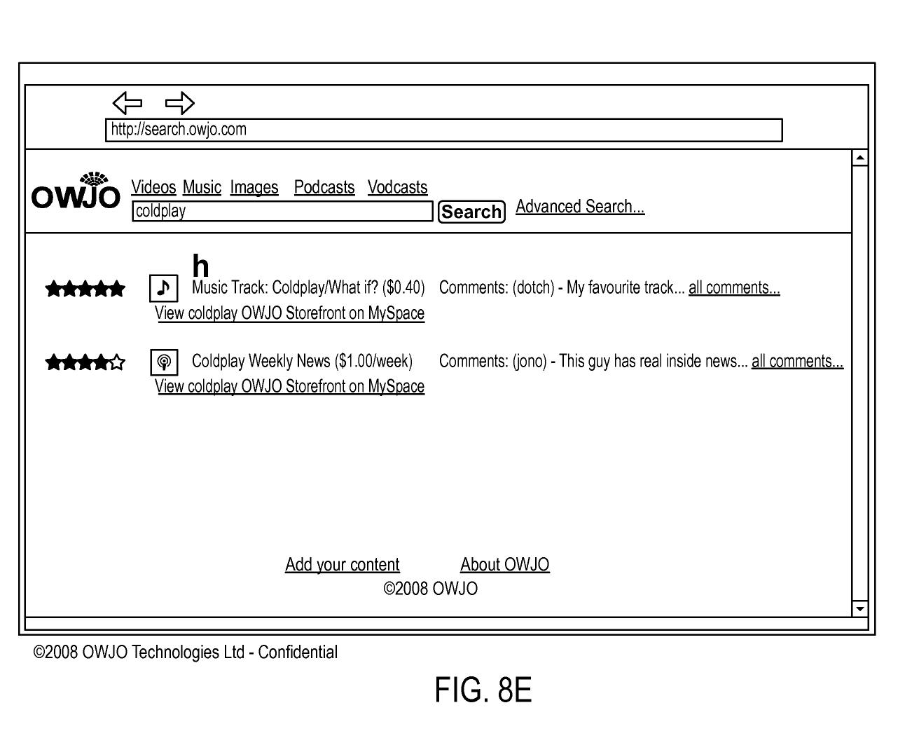

FIG. 8A is a block diagram that depicts an embodiment of system integration between the platform and one or more feed aggregators. A Web feed is a document that contains content items with web links to longer versions of the document. In some embodiments, the document is XML-based although other types and forms of documents and/or protocols may be used. News websites and blogs are common sources for web feeds, but feeds are also used to deliver structured information ranging from weather data to “top ten” lists of hit tunes to search results. In some embodiments, the platform supports and delivers web feeds in RSS format. In other embodiments, the platform supports and delivers web feeds in Atom format. In some embodiments, the OWJO Platform publishes the following “top ten” type web feeds in both Atom and RSS formats.

Top 10<music genre> music tracks
Top 10<video genre> video tracks
Top 10 <10 most popular tags> images
Top 10<podcast category> podcasts
Top 10<vodcast category> vodcasts
Latest 10 music tracks
Latest 10 video tracks
Latest 10 images

The above web feeds are illustrative examples, and not intended to be limiting. The platform can publish any type and form of lists, ratings, aggregation, statistics and information regarding any information, data, content and transactions occurring via or related to the platform.

These web feeds may be promoted to any type and form of feed aggregators, such as the top feed aggregators, for example, FeedBurner. These web feeds may be submitted to search engines and RSS directories. These syndicated web feeds can then be consumed by potential buyers using feed readers like iTunes, BlogLines, and Google Reader. The embedded content may be preview content that is made available by the sellers. In some embodiments, embedded links from the preview content or associated with the preview content may direct or take a feed consumer to the OWJO Storefront of the seller at the OWJO web site. In other embodiments, embedded functionality associated with the preview content may activate the OWJO Storefront in the present web page of the consumer without leaving the present web page.

A OWJO seller can also promote/market the seller's own content feeds directly to search engines and RSS directories. In some embodiments, the OWJO platform submits these feeds to search engines and RSS directories automatically for the seller. In one embodiment, the OWJO platform automatically creates web feeds for each type of content that a seller is promoting. In FIG. 8A, by way of illustration, the OWJO platform may create a web feed for a seller's music. The seller can promote this web feed by submitting it to one or more of: RSS directories, search engines and feed aggregators such as FeedBurner.

FIG. 8B is a block diagram that depicts an embodiment of the OWJO platform's integration with Facebook and MySpace web sites, although integration with any other web site can be supported. A seller can decide to promote the seller's OWJO Storefront to some or all of their contacts on Facebook or MySpace by clicking on the “share” link. The seller can also post or publish the seller's OWJO Storefront to other social networking sites from within Facebook or MySpace.

FIG. 8C is a block diagram that depicts an embodiment of an OWJO Search performed at a web site in connection with the OWJO platform's content search functionality. Via the content search functionality available at the OWJO website or published at a different website (for example, via content search functionality available within a seller's Storefront published at any web site), a user can search any content, data, and metadata accessible via the platform, such as internal or external storage accessed via OWJO storage. The content search engine may use any type and form of searching function, algorithm, operations or service and may be based on Google search technology or a search service provided by another service provider. In some embodiments, the OWJO search provides a user with a free text interface to search content provided via the platform, using any type and form of search terms the user may input.

In other embodiments, as in FIG. 8D, a user can use a tag cloud to search for content registered with the OWJO platform. A tag is a keyword or term associated with content. In some embodiments, a tag cloud is a graphical representation of tags that are indexed within the OWJO content search engine. The importance, significance or relevance of a tag may be shown with any type and form of visual indicators, such as for example, using a larger font size or color. FIG. 8D is an example of an embodiment of a tag cloud that graphically represents the world population in 2007. Using a web browser such as Internet Explorer, Mozilla Firefox or Apache Safari, a visitor can select a tag from the tag cloud. Responsive to the selection, the OWJO search engine can display content that matches the selected tag.

The search engine may use any type and form of priority, enumeration or ordering scheme to present search results to the user. In some embodiments, highest rated content may be displayed with a higher priority in the search results. The ordering or displaying of search results may be based on any information available to the platform, such as ratings, comments, user generated content and buyer and seller transaction histories and profiles. In some embodiments, content may be displayed with thumbnails, links or some other type or form of representation of the content. In another embodiment, visitors searching for content can view ratings and comments associated with the content.

FIG. 8E is one embodiment of a web site showing search results using OWJO search. The content returned by the search engine may be shown prioritized or ranked according to content rating. In some embodiments, the last content review may be displayed for each selected/identified content item, accompanied by or in place of a navigation link to view all the comments. The price of the content and content type (music, video, image, podcast and vodcast) may also be displayed. In some embodiments, content can be purchased by navigating to the seller's OWJO Storefront at the OWJO website or at a web site associated with the OWJO platform. In other embodiments, content can be purchased through the OWJO Storefront widget published with the search results. The content search provides a way for a buyer to search and obtain access to a variety of content available from the sellers and to quickly navigate to or access the seller's Storefront to purchase content.

### Section I—User Interface Provided by Storefront Widget for Previewing and Purchasing Digital and Physical Items

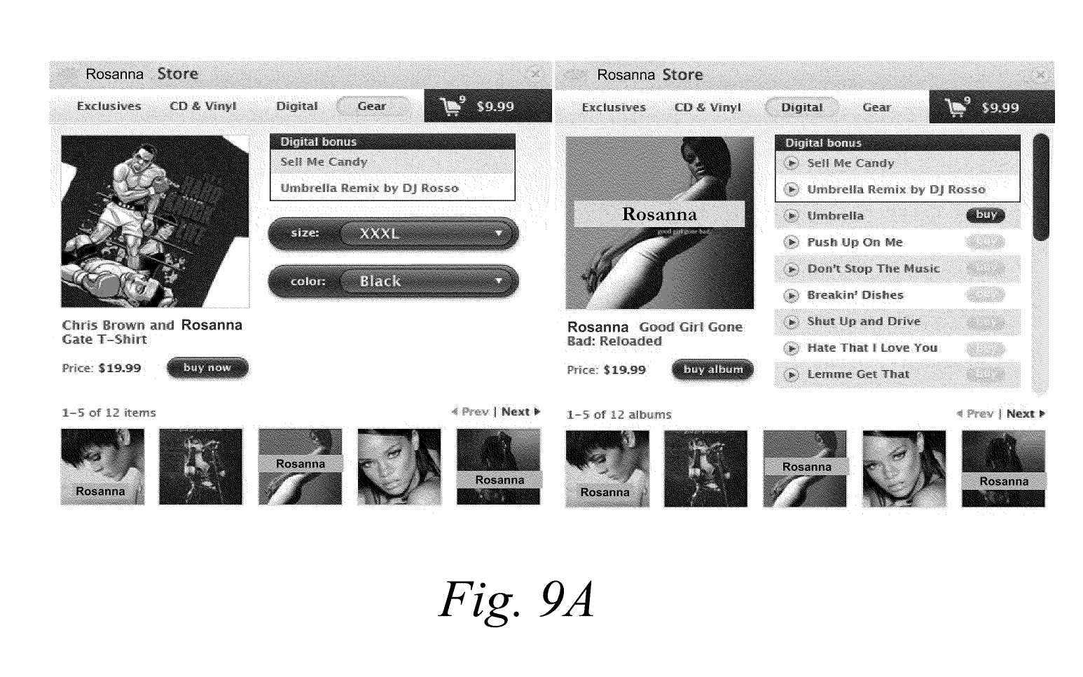

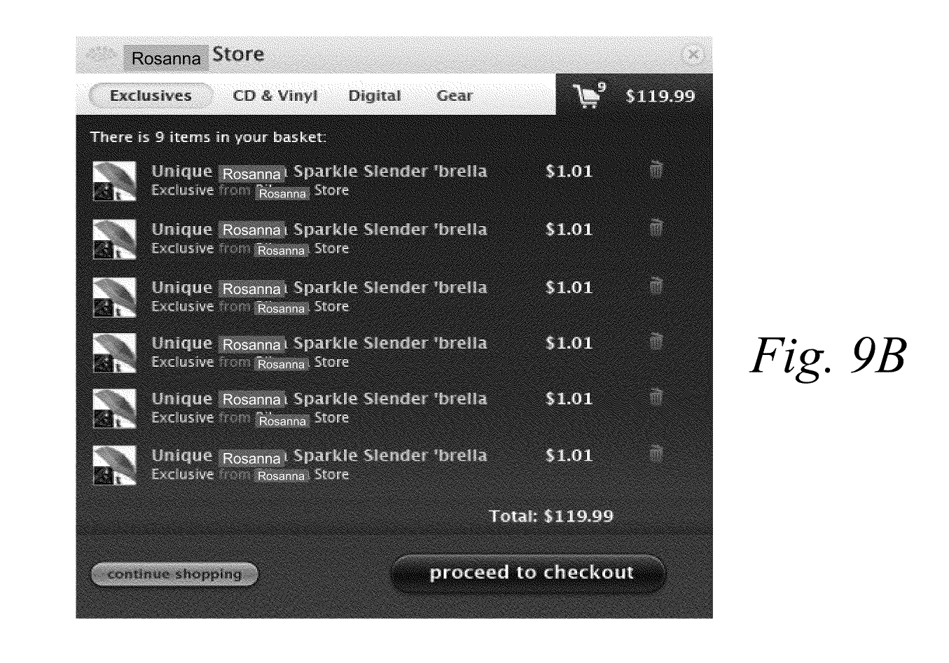

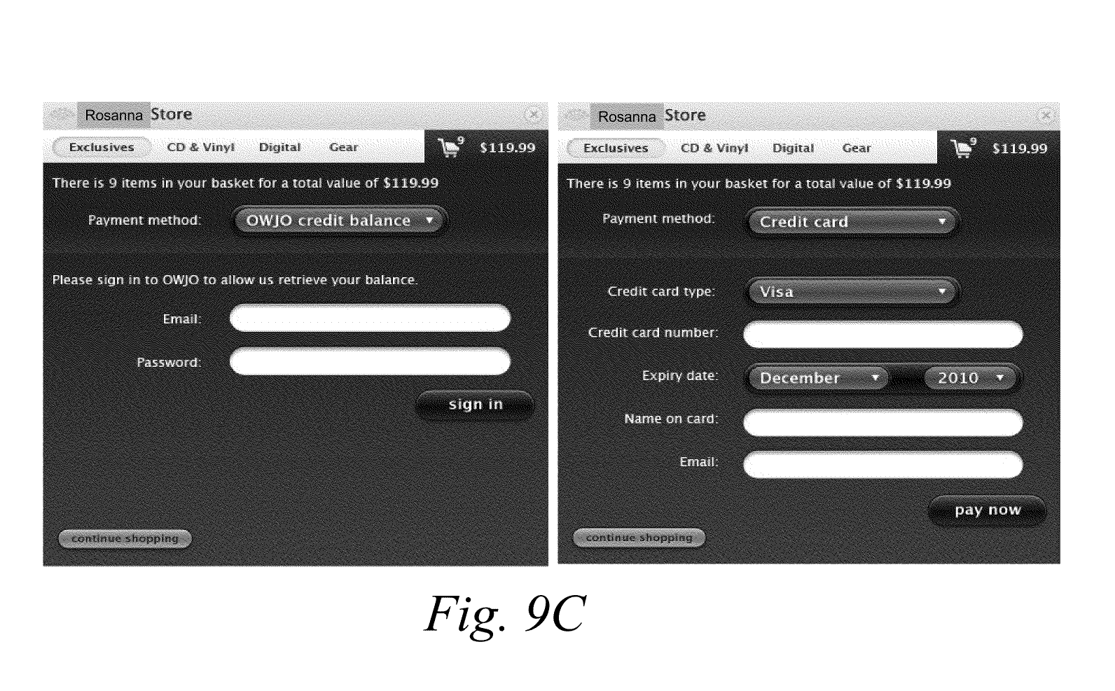

Referring now to FIG. 9A and in one embodiment, a storefront widget 102 executes within a hosted environment upon publication in the hosted environment. The hosted environment may be any type or form of web site/page such as artist's own web site, social network site or internet portal. The customer can preview both physical items (i.e., products) and digital items (e.g., digital content), as well as services (e.g., subscription services). In some embodiments, physical items include products such as CDs and vinyl records, gear, and exclusive items such as calendars, posters and collector's items. In one of these embodiments, some of these products may be associated with the artist and/or the digital content. In another embodiment, some of these products may be presented, for example, based on preferences and/or past transaction/search/viewing history of the buyer/user. Available variants and/or options for each item may be provided, for example, the size and color of a shirt for sale, or the file format of a music recording. Items can be added to a shopping cart by clicking the “buy now” button. In some embodiments, the shopping cart may be persistent, as discussed further in section J below.Referring now to FIG. 9B, one embodiment of the user interface of a persistent shopping cart is shown. In further details, the user interface displays a list of items selected by the user/customer/buyer. Any number of transaction-related features and functionalities may be supported in the persistent shopping cart. For example, the user/customer/buyer can remove items from the list, proceed to checkout and purchase content, or continue shopping.

Referring now to FIG. 9C, one embodiment of a user interface for specifying payment method for items in a shopping cart is shown. The customer may choose to purchase their chosen items by using a credit card, OWJO Credits, Paypal (not shown), giftcard, or any other payment methods. The customer may enter the customer's OWJO account information (e.g., username and password) and retrieve the customer's account balance (e.g., for purchases and/or OWJO Credits). The customer may also specify one or more payment methods, such as a preferred payment method, in the customer's account. The customer can also enter details of the one or more payment methods (e.g., billing address, credit card number, expiration date, etc). In some embodiments, the details of the one or more payment methods can be made available via simplified payment processing, for example, by entering login information.

In some embodiments, a customer may choose to use OWJO Credits for purchases if the customer's OWJO credit balance is greater than the total cost of the items selected for purchase. Otherwise, the customer can choose another payment method, such as the customer's credit card, to complete the purchase. Although shopping cart check-out or payment processing can be performed in whole or in part at the OWJO website, a customer can also perform this within the user interface provided by the Storefront. In particular, a customer can perform shopping cart check-out or payment processing within the user interface provided by any Storefront published at any single website without leaving that website,

### Section J—Persistent Shopping Cart and OWJO Account Across Artist Storefronts.

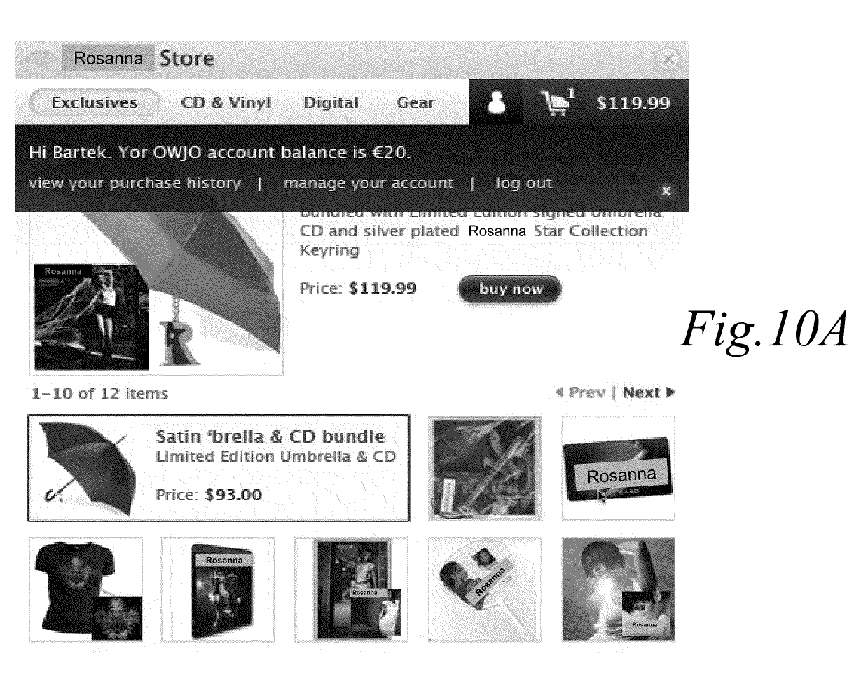

Referring now to FIG. 10A, a screenshot of one embodiment of a user interface provided by a Storefront is shown. The user interface may display persistent data related to a user's activities across one or more Storefronts, such as items added to the user's shopping cart. The OWJO platform can track a user's activities across OWJO Storefronts (for example, update and store user history in OWJO storage) to maintain persistence in the user's shopping cart. For example and in one embodiment, a user who adds items to a shopping cart from an OWJO Storefront can leave that OWJO Storefront and have the same items remain in the shopping cart when the user returns to the same Storefront.

In some embodiments, each Storefront provides a mechanism to store persistent information on the machine executing the Storefront. In other embodiments, each Storefront provides a mechanism to store persistent information on a storage device, such as a memory module in the OWJO platform or the OWJO storage. In some embodiments, the mechanism uses the Flash Local Shared Object to store cookie-like data on the customer's computer. In other embodiments, HTTP Cookies process and maintain persistent data on the customer's computer. The mechanism may recognize the user and associate persistent data with the user while the user traverses Storefronts at various websites, for example, using one or more of: a machine identifier, network address and port number.

When a cookie is detected, the Storefront may display a cookie indication, such as an icon of a person in the top bar as shown in FIG. 10A. The customer may review the customer's purchase history, manage the customer's account or logout. In some embodiments, logging out removes the persistent information from the customer's computer. In other embodiments, information created or modified while a customer is logged in is made persistent. In one of these embodiments, information from a first login session may be made persistent and retrievable from a second login session.

One advantage of having this persistent data is that a customer may purchase items from more than one storefront. The OWJO platform will create one (purchase) order that is shared for fulfillment with one or more sellers. In one embodiment, the shopping cart is persistent across web sites for the user/customer/buyer. For example, a user can add items from various Storefronts published in different websites into a common shopping cart. The persistent shopping cart may consolidate all added items, indicate the total purchase price, and/or indicate the total number of items. The shopping cart may be persistent within a browser session, a login session, for the entire duration of a connection, or for any specified or pre-configured period of time. The shopping cart may be persistent if cookies and/or other tracking mechanisms are enabled for the user/customer/buyer.

Section K—Revenue Sharing with Portals, Social Networking Services and Other Web Distributors

In some embodiments, when a user is approved as a seller in the OWJO platform and sells items from the OWJO website, revenue share percentages are specified between the seller and OWJO. The OWJO platform can specify, determine and/or receive a revenue share of items the seller sells. In some embodiments, the OWJO Billing 158 module handles revenue sharing between OWJO, the artist, and where appropriate, third parties (e.g., service providers like MySpace, Bebo, Facebook, Yahoo! Artist Pages, and suppliers). The revenue share may be determined, for example, based on a membership plan registered with the OWJO platform, sales volume, the type of item (e.g., product, content, services) sold, or the specific item sold. In one embodiment, the revenue share is determined based on the services and/or features provided by the OWJO platform and/or used in the promotion/sale of an item sold. In some embodiments, the OWJO platform may not initiate revenue sharing until after a trial period or until a level of sales volume is achieved.

In other embodiments, when a user is approved as a seller in the OWJO platform with Storefront widgets published or installed in a third party host environment or website, revenue share percentages are specified for items sold from a Storefront widget at the third party host environment or website. As discussed above, OWJO can specify, determine and/or receives a revenue share of items the seller sells. In addition, the portals, social network site or other web distributors may also receive a revenue share. The revenue share for the third party host environment or website may be determined, for example, based on a membership plan registered with the third party host environment or website, sales volume, the type of item (e.g., product, content, services) sold, or the specific item sold. In one embodiment, the revenue share is determined based on the services and/or features provided by the third party host environment or website and/or used in the promotion/sale of an item sold. In some embodiments, the third party host environment or website may not initiate revenue sharing until after a trial period or until a level of sales volume is achieved. In other embodiments, where a sale of an item is directed to the OWJO web site or the seller's website, the third party host environment or website may receive no revenue sharing or may receive a smaller revenue share.

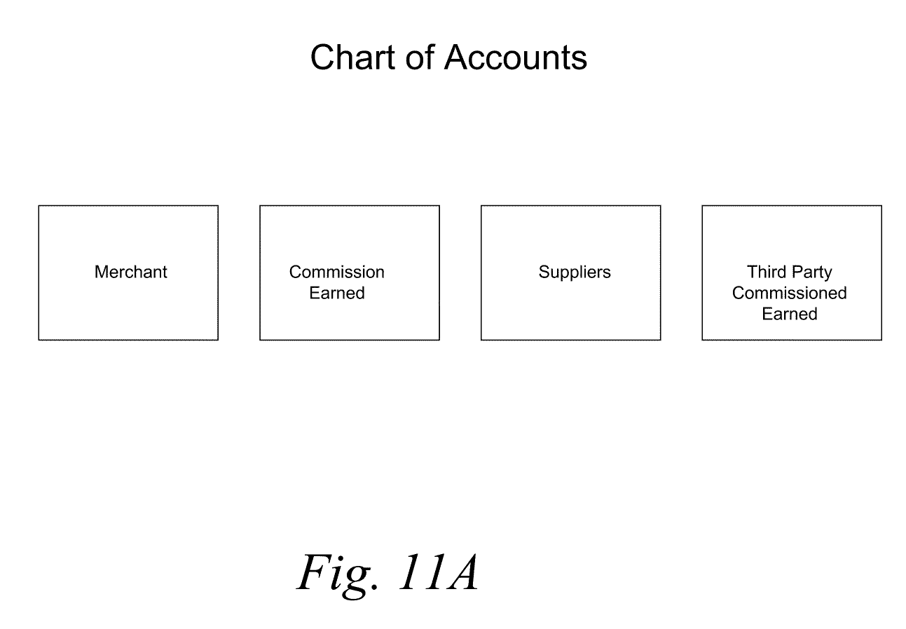

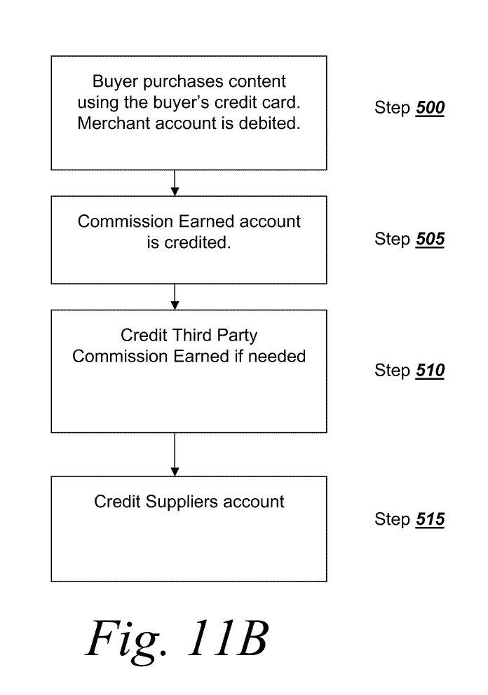

Referring now to FIG. 11A, one embodiment of a representation of a listing for revenue sharing is depicted. In order to manage the complexities of calculating the revenue share percentages and managing refunds, the OWJO platform maintains a chart of accounts. For example and in one embodiment, for each merchant or seller and an associated list of suppliers (e.g., OWJO and third party host environments or websites) is stored. The revenue share may be expressed in terms of sales commission in any currency or expressed as a percentage of the sales price and/or profit. Suppliers may include other service providers, for example Pay Pal and credit card vendors. Revenue sharing for the other service providers may be the same or similar to the revenue structures identified for OWJO and/or the third party host environments or websites. In one embodiment, a service provider may be a supplier or manufacturer of a sale item (product). For example, an artist may create a shirt design and a portion of proceeds from the sale of shirts having the design is shared or directly credited to the manufacturer of these shirts. In some embodiments, revenue sharing for service providers (including OWJO and/or the third party host environments or websites) may involve a fixed fee or a portion of the proceeds (e.g., based on sale price and/or profit). A portion of the revenue sharing accounts are shown in FIG. 11A.

In FIG. 11B, an embodiment of process steps for processing revenue sharing between a seller, OWJO and service providers is shown. In brief overview, at step 500, a buyer purchases an item via the OWJO platform using any supported payment method. Revenue apportionment is determined by the OWJO platform in accordance with the revenue sharing structures discussed above in connection with FIG. 11A and according to the service providers involved. The merchant account is debited with the amount of payment that is approved by the payment method (e.g., credit card transaction), based on the revenue apportionment. At step 505, the commissioned earned account (i.e., of OWJO) is credited with an amount, based on the revenue apportionment, as agreed with the specific seller. At step 510, if a third party such as a portal, social networking site or other web distributor provided a service or facilitated the transaction, then a Third Party Commission earned account of each third party may be credited based on the revenue apportionment, for example with the previously agreed revenue percentage. At step 515, if a supplier/manufacturer is involved, each of the suppliers' accounts may be credited based on the revenue apportionment.

### Section L—Features Available to Sellers to Facilitate Physical Fulfillment

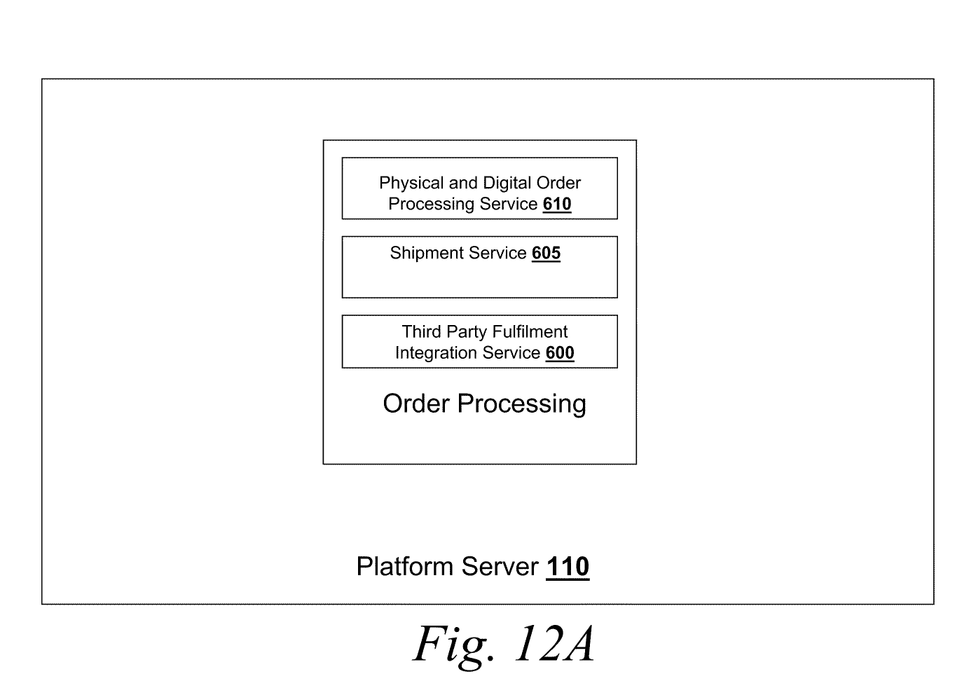

Referring now to FIG. 12A, a block diagram representing one embodiment of an order processing module for fulfilling an order is shown. The Order Processing module can process physical fulfillment (such as a purchase for a physical product) as well as digital fulfillment (such as digital content via sale or subscription). The Order Processing module may include a Physical and Digital Order Processing Service 610 and a Shipment Service 605. The Order Processing module and its individual components may comprise any combination of hardware and software, including any logic, function, program, process and rule for processing physical/digital fulfillment. Each of these components may be logically combined or subdivided but are in communication with each other (e.g., over one or more networks) for processing an order.

The Physical and Digital Order Processing Service 610 generates, receives, processes or manages orders that are created when items are purchased via the OWJO Platform 110. The Physical and Digital Order Processing Service 610 provides the seller or their approved agent with functionality and a user interface (e.g., via the Storefront widget or dedicated webpages) to manage physical fulfillment. For example, webpages may be assembled, generated and provided to show pending orders for a seller. The Physical and Digital Order Processing Service 610 may notify the buyer and seller of the purchasing transaction and communicate with the Billing Module 158 to create the appropriate sales, accounting or ledger (e.g., credit, debit) entries for the transaction. The Physical and Digital Order Processing Service 610 may notify the seller and/or buyer if the status of an order changes. The Physical and Digital Order Processing Service 610 may provide an order processing state engine that notifies related parties when the status of an order changes.

Status changes include but are not limited to CANCELLED, PAYMENT REQUESTED, PAYMENT REFUSED, PAYMENT RECEIVED, PARTLY SHIPPED, FULLY SHIPPED and EXECUTED. In one embodiment, an order is fulfilled when payment is received. In another embodiment, an order is fulfilled when the purchased item is shipped (e.g., digital rights are delivered to the buyer). The seller can view any unfulfilled orders and may follow up as appropriate, for example, cancel an order or initiate a shipments or partial shipment of items in any order.

The Shipment Service 605 may manage the state of shipments and notify the buyer and seller of changes to the shipping state. In one embodiment, the shipping state may include but are not limited to: shipped, received at destination, delayed, cancelled, re-shipped, returned, damaged and lost.

The Third Party Integration Service, 600 facilitates the integration with external services such as Amazon Fulfillment or Shipwire. When orders are processed by the Order Processing module the orders may be dispatched to one or more external service providers. The Order Processing module may query the external services for any change in status. In some embodiments, this can provide the seller and/or buyer with a complete audit trail of an order from payment to shipment.

### Section M—Digital Watermarking Features

The OWJO platform may create a digital fingerprint for content processed or sold via the OWJO platform. This digital fingerprint may include digital right details associated with the content. In some embodiments, when content is sold via the OWJO platform on a seller's behalf, the OWJO platform creates a digital right. In one of these embodiments, the digital right is a representation of, or access pass for the content that a buyer buys. The digital right may include details such as who purchased what and when. By encrypting a digital right and digitally fingerprinting the purchased content with the encrypted digital right, one can retrieve, inspect or monitor the purchase history of that content by using a corresponding decryption system.

In some embodiments, the Content Packaging and Encryption Service 120 may take a generated digital right that has been created at step 310 in FIG. 2B and encode the digital right by applying software stenography or other encryption/translation/encoding methods on an actual purchased digital content. The encoded digital right embedded in a purchased content may be referred to as digital watermarking. Instead of the digital right, other types or forms of encoding data, such as an artist's name, registered copyright information, company name, or security signature may be embedded into content for digital watermarking.

In one embodiment and by way of illustration, a digital right, including information associated with the digital right, can be encoded along with content metadata into the PRIV ID3 tag of an MP3 file. The Rights Management Service 115, may provide one or more mechanisms to inspect, determine and/or query specific content for the existence of digital watermarking In one embodiment, these services can be made available to external entities by way of Web Services to allow third parties determine who has the rights to use a specific piece of content. This can be a convenient way of tracking where content originated from on peer to peer networks when determining copyright infringements.

It should be understood that the systems described above may provide multiple ones of any or each of those components and these components may be provided on either a standalone device or, in some embodiments, on multiple devices in a distributed system. In addition, the systems and methods described above may be provided as one or more computer-readable programs or executable instructions embodied on or in one or more articles of manufacture. The article of manufacture may be a floppy disk, a hard disk, a CD-ROM, a flash memory card, a PROM, a RAM, a ROM, or a magnetic tape. In general, the computer-readable programs may be implemented in any programming language, such as LISP, PERL, C, C++, C#, PROLOG, or in any byte code language such as JAVA. The software programs or executable instructions may be stored on or in one or more articles of manufacture as object code.

While the invention has been particularly shown and described with reference to specific embodiments, it should be understood by those skilled in the art that various changes in form and detail may be made therein without departing from the spirit and scope of the invention as defined by the following claims.

What is claimed is:

1. A method of self-service by a seller to establish at a hosted service a store front that is distributable across a plurality of third party hosts, the method comprising:
a) receiving, by a hosted service operating on one or more servers, specification of one or more items to be displayed for sale in a store front for a seller;
b) generating, by the hosted service responsive to the specification, a portable widget for the store front identifying the one or more items for sale;
c) receiving, by the hosted service from the seller, identification of one or more third party hosts to which to publish the portable widget of the store front; and
d) initiating, by the hosted service, publishing of the portable widget of the store front to the one or more third party hosts.

2. The method of claim 1, further comprising receiving, by the hosted service, from the portable widget of the store front published on a third party host information from a buyer to complete a purchase of one or more items selected from the storefront.

3. The method of claim 1, further comprising completing, by the portable widget in communication with the hosted service, the purchase of the selected one or more items without the buyer traversing away from the store front displayed on the third party host.

4. The method of claim 1, further comprising determining, by the hosted service, a share of revenue from sales of the one or more items from the storefront between the hosted service, the seller and the one or more third party hosts.

5. The method of claim 1, wherein step (a) further comprises receiving, by the hosted service, the specification by the seller of digital content for the one or more items to be displayed for sale in the storefront.

6. The method of claim 1, wherein step (a) further comprises receiving, by the hosted service, the specification by the seller of physical items for the one or more items to be displayed for sale in the storefront.

7. The method of claim 1, wherein step (a) further comprises receiving, by the hosted service, the specification by the seller of one of different prices or different currencies for the one or more items.

8. The method of claim 1, wherein step (b) further comprises one of automatically generating or automatically updating, by the hosted service, the store front responsive to a feed from a third party system.

9. The method of claim 1, wherein step (d) further comprises communicating, by the hosted service, the portable widget of the store front to a third party host of the one or more third party hosts.

10. The method of claim 1, further comprising notifying, by the hosted service, to the seller and a buyer a status of fulfillment of physical items purchased by the buyer from the store front.

11. A system of providing self-service to a seller to establish at a hosted service a store front that is distributable across a plurality of third party hosts, the system comprising:
a user interface of a hosted service operating on one or more servers receiving specification of one or more items to be displayed for sale in a store front for a seller;
a portable widget for the store front generated by the hosted service responsive to the specification, the portable widget for the store front identifying the one or more items for sale; and
a publishing user interface of the hosted service receiving from the seller identification of one or more third party hosts to which to publish the portable widget of the store front;
wherein the hosted service initiates publishing of the portable widget of the store front to the one or more third party hosts.

12. The system of claim 11, wherein the hosted service receives from the portable widget of the store front published on a third party host information from a buyer to complete a purchase of one or more items selected from the store front.

13. The system of claim 11, wherein the hosted service in communication with the portable widget, completed the purchase of the selected one or more items without the buyer traversing away from the store front displayed on the third party host.

14. The system of claim 11, wherein the hosted service determines a share of revenue from sales of the one or more items from the store front between the hosted service, the seller and the one or more third party hosts.

15. The system of claim 11, wherein the hosted service receives the specification by the seller of digital content for the one or more items to be displayed for sale in the store front.

16. The system of claim 11, wherein the hosted service receives the specification by the seller of physical items for the one or more items to be displayed for sale in the store front.

17. The system of claim 11, wherein the hosted service receives the specification by the seller of one of different prices or different currencies for the one or more items.

18. The system of claim 11, wherein the hosted service automatically generates or automatically updates the store front responsive to a feed from a third party system.

19. The system of claim 11, wherein the hosted service communicates the portable widget of the store front to a third party host of the one or more third party hosts.

20. The system of claim 11, wherein the hosted service notifies the seller and a buyer a status of fulfillment of physical items purchased by the buyer from the store front.
